(19) United States
(12) Patent Application Publication
(10) Pub. No.: US 2024/0395203 A1
(43) Pub. Date: Nov. 28, 2024

(54) PIXEL CIRCUIT, DISPLAY PANEL, AND DISPLAY DEVICE

(71) Applicant: KYOCERA Corporation, Kyoto-shi, Kyoto (JP)

(72) Inventor: Yohei SATO, Muko-shi, Kyoto (JP)

(21) Appl. No.: 18/685,456

(22) PCT Filed: Aug. 17, 2022
(86) PCT No.: PCT/JP2022/031053

§ 371 Date: Feb. 21, 2024

(30) Foreign Application Priority Data
Aug. 23, 2021 (JP) 2021-135713

(51) Int. Cl. G09G 3/3233

(52) U.S. Cl. CPC G09G 3/3233; G09G 2300/0814; G09G 2300/0842; G09G 2300/0861; G09G 2310/08; G09G 2320/0233; G09G 2330/02; G09G 2330/08; G09G 2330/10

(57) ABSTRACT

A pixel circuit includes a first power potential input section, a second power potential input section, and multiple elements. The first power potential input section provides a first power potential. The second power potential input section provides a second power potential lower than the first power potential. The elements are connected in series or in cascade between the first and second power potential input sections. The elements include a light emitter, a first transistor connected in series to the light emitter to control a current flowing through the light emitter, and a second transistor connected in cascade to the first transistor to switch the light emitter between an emissive state and a non-emissive state. The second transistor includes a gate electrode to selectively receive a first potential to set the second transistor to a nonconductive state or a second potential between the first power potential and the second power potential.

### CROSS-REFERENCE TO RELATED APPLICATION

This application claims priority to Japanese Patent Application No. 2021-135713 filed on Aug. 23, 2021, the entire disclosure of which is incorporated herein by reference.

### TECHNICAL FIELD

The present disclosure relates to a pixel circuit, a display panel, and a display device.

### BACKGROUND OF INVENTION

A known display device includes multiple scanning signal lines and multiple image signal lines in a grid and includes an image display unit including a matrix of multiple pixel units at the intersections between the scanning signal lines and the image signal lines (refer to Patent Literatures 1 and 2).

### CITATION LIST

### Patent Literature

Patent Literature 1: WO 2020/174879
Patent Literature 2: Japanese Unexamined Patent Application Publication No. 2005-181975

### SUMMARY

One or more aspects of the present disclosure are directed to a pixel circuit, a display panel, and a display device.

In an aspect, a pixel circuit includes a first power potential input section, a second power potential input section, and a plurality of elements. The first power potential input section provides a first power potential. The second power potential input section provides a second power potential lower than the first power potential. The plurality of elements is connected in series or in cascade between the first power potential input section and the second power potential input section. The plurality of elements includes a light emitter, a first transistor, and a second transistor. The first transistor is connected in series to the light emitter and controls a current flowing through the light emitter in response to a potential corresponding to an image signal received at a gate electrode. The second transistor is connected in cascade to the first transistor and switches the light emitter between an emissive state and a non-emissive state. The second transistor includes a gate electrode to selectively receive a first potential or a second potential. The first potential is higher than or equal to the first power potential or is lower than or equal to the second power potential to set the second transistor to a nonconductive state in which no current flows between a source electrode and a drain electrode. The second potential is between the first power potential and the second power potential to allow a current to flow between the source electrode and the drain electrode of the second transistor.

In an aspect, a display panel includes a plurality of the pixel circuits according to the above aspect and a controller that selectively outputs the first potential or the second potential to the gate electrode of the second transistor in each of the plurality of pixel circuits.

In an aspect, a pixel circuit includes a light emitter, a first transistor, a second transistor, and a controller. The first transistor is connected in series to the light emitter and controls a current flowing through the light emitter in response to a potential corresponding to an image signal received at a gate electrode. The second transistor is connected in cascade to the first transistor and switches the light emitter between an emissive state and a non-emissive state. The controller includes a plurality of switches that perform switch control over the second transistor. The controller selectively receives an on-signal or an off-signal for each of the plurality of switches. The controller outputs, in response to receiving an off-signal for at least one of the plurality of switches, a potential to a gate electrode of the second transistor to cause the light emitter to be in the non-emissive state. The controller outputs, in response to receiving an on-signal for each of the plurality of switches, a potential to the gate electrode of the second transistor to cause the light emitter to be in the emissive state.

In an aspect, a display panel includes a plurality of pixel circuits and a controller including a plurality of switches. Each of the plurality of pixel circuits includes a light emitter, a first transistor, and a second transistor. The first transistor is connected in series to the light emitter and controls a current flowing through the light emitter in response to a potential corresponding to an image signal received at a gate electrode. The second transistor is connected in cascade to the first transistor and switches the light emitter between an emissive state and a non-emissive state. The controller selectively receives an on-signal or an off-signal for each of the plurality of switches. The controller outputs, in response to receiving an off-signal for at least one of the plurality of switches, a potential to a gate electrode of the second transistor in each of the plurality of pixel circuits to cause the light emitter to be in the non-emissive state. The controller outputs, in response to receiving an on-signal for each of the plurality of switches, a potential to the gate electrode of the second transistor in each of the plurality of pixel circuits to cause the light emitter to be in the emissive state.

In an aspect, a display device includes the display panel according to any of the above aspects and a drive. The drive is on a non-display surface of the display panel opposite to a display surface and is electrically connected to the plurality of pixel circuits.

### BRIEF DESCRIPTION OF THE DRAWINGS

FIG. 1 is a schematic front view of an example display device according to one or more embodiments.

FIG. 2 is a schematic rear view of the display device according to one or more embodiments.

FIG. 3 is a schematic block circuit diagram of the display device with an example structure according to one or more embodiments.

FIG. 4 is a circuit diagram of an example first subpixel circuit in a first embodiment.

FIG. 5 is a schematic gate circuit diagram of a controller, illustrating example input and output gates.

FIG. 6 is a circuit diagram of an example controller.

FIG. 7 is a truth table showing an example relationship between the input into the controller, the output from the controller, and the state of the first subpixel circuit.

FIG. 8 is a block circuit diagram of the controller connected to multiple subpixel circuits in an example manner.

FIG. 9 is a block circuit diagram of the controller connected to multiple pixel circuits in an example manner.

FIG. 10 is a circuit diagram of another example first subpixel circuit in the first embodiment.

FIG. 11 is a circuit diagram of an example first subpixel circuit in a second embodiment.

FIG. 12 is a schematic gate circuit diagram of a controller, illustrating example input and output gates.

FIG. 13 is a circuit diagram of an example controller.

FIG. 14 is a truth table showing an example relationship between the input into the controller, the intermediate output signal in the controller, the output from the controller, and the state of the first subpixel circuit.

FIG. 15 is a block circuit diagram of an example signal output circuit that outputs a setting control signal to the controller.

FIG. 16 is a block circuit diagram of the controller connected to the signal output circuit and multiple subpixel circuits in an example manner.

FIG. 17 is a block circuit diagram of the controller connected to the signal output circuit and multiple pixel circuits in an example manner.

FIG. 18 is a circuit diagram of an example first subpixel circuit in a third embodiment.

FIG. 19 is a schematic gate circuit diagram of a controller, illustrating example input and output gates.

FIG. 20 is a circuit diagram of an example controller.

FIG. 21 is a truth table showing an example relationship between the input into the controller, the output from the controller, and the state of the first subpixel circuit.

FIG. 22 is a circuit diagram of an example first subpixel circuit in a fourth embodiment.

FIG. 23 is a truth table showing an example relationship between the input into the controller, the output from the controller, and the state of the first subpixel circuit.

FIG. 24 is a circuit diagram of an example first subpixel circuit in a fifth embodiment.

FIG. 25 is a truth table showing an example relationship between the input into the controller, the intermediate output signal in the controller, the output from the controller, and the state of the first subpixel circuit.

FIG. 26 is a circuit diagram of an example first subpixel circuit in a sixth embodiment.

FIG. 27 is a truth table showing an example relationship between the input into the controller, the output from the controller, and the state of the first subpixel circuit.

FIG. 28 is a circuit diagram of an example first subpixel circuit in a seventh embodiment.

FIG. 29 is a schematic gate circuit diagram of a controller, illustrating example input and output gates.

FIG. 30 is a truth table showing an example relationship between the input into the controller, the output from the controller, and the state of the first subpixel circuit.

FIG. 31 is a circuit diagram of another example first subpixel circuit in the seventh embodiment.

FIG. 32 is a truth table showing an example relationship between the input into the controller, the output from the controller, and the state of the first subpixel circuit.

FIG. 33 is a circuit diagram of an example first subpixel circuit in an eighth embodiment.

FIG. 34 is a truth table showing an example relationship between the input into the controller, the output from the controller, and the state of the first subpixel circuit.

FIG. 35 is a circuit diagram of an example first subpixel circuit in a ninth embodiment.

FIG. 36 is a truth table showing an example relationship between the input into the controller, the output from the controller, and the state of the first subpixel circuit.

FIG. 37 is a circuit diagram of an example first subpixel circuit including an n-channel transistor as a first transistor.

FIG. 38 is a circuit diagram of an example first subpixel circuit incorporating a threshold voltage correction circuit.

FIG. 39 is a timing chart of an example operation of the first subpixel circuit incorporating the threshold voltage correction circuit.

FIG. 40 is a schematic front view of an example tiled display.

FIG. 41 is a schematic circuit diagram of a subpixel in a first reference example.

FIG. 42 is a schematic circuit diagram of a subpixel in a second reference example.

FIG. 43 is a schematic circuit diagram of a subpixel in a third reference example.

FIG. 44 is a schematic circuit diagram of a subpixel in a fourth reference example.

### DESCRIPTION OF EMBODIMENTS

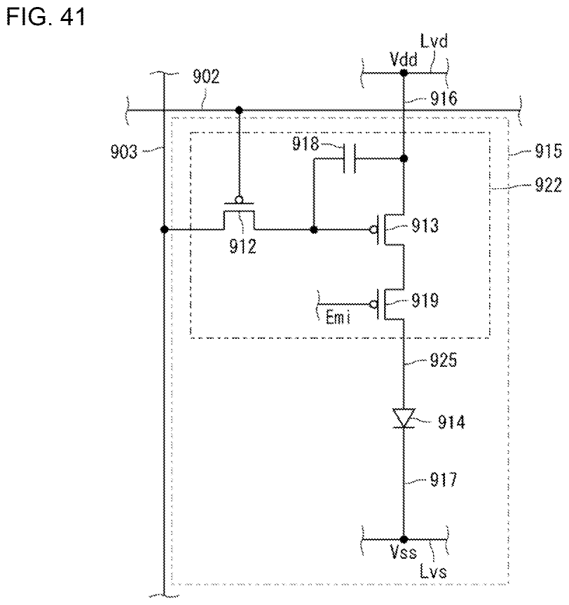

A pixel circuit, a display panel, and a display device according to various embodiments of the present disclosure will now be described. The structure that forms the basis of a pixel circuit according to one or more embodiments of the present disclosure will now be described with reference to first to fourth reference examples illustrated in FIGS. 41 to 44. A display device includes multiple scanning signal lines and multiple image signal lines in a grid and includes an image display unit including a matrix of multiple pixel units at the intersections between the scanning signal lines and the image signal lines.

This display device includes the pixel units each including a subpixel including a first light emitter that emits light of a first color, a subpixel including a second light emitter that emits light of a second color, and a subpixel including a third light emitter that emits light of a third color. The display device can thus display color images or other images. The first color, the second color, and the third color may be red, green, and blue.

FIG. 41 is a schematic circuit diagram of a subpixel 915 in a first reference example. The subpixel 915 includes a light emitter 914 and an emission controller 922 that controls the emission or non-emission and the light intensity of the light emitter 914.

The light emitter 914 may be a micro-light-emitting diode (LED) or an organic electroluminescent (EL) element. The light emitter 914 is located on an insulating layer on a first surface of a substrate such as a glass plate. The light emitter 914 is electrically connected to the emission controller 922 and a second power potential input section 917 with feedthrough conductors in, for example, through-holes extending through the insulating layer in the pixel unit. The light emitter 914 includes the positive electrode connected to a first power potential input section 916 through the emission controller 922 and the negative electrode connected to the second power potential input section 917. The first power potential input section 916 may be a first power potential terminal or a first power potential input line. The second power potential input section 917 may be a second power potential terminal or a second power potential input line.

The emission controller 922 includes a select transistor 912, a drive transistor 913, a capacitor 918, and an emission control transistor 919.

The select transistor 912 functions as a switch for inputting an image signal into the subpixel 915. The select transistor 912 may be a p-channel thin-film transistor (TFT), or a p-channel transistor. The select transistor 912 includes the gate electrode connected to a scanning signal line 902, the source electrode connected to an image signal line 903, and the drain electrode connected to the gate electrode of the drive transistor 913. The select transistor 912 enters a conductive state (or an on-state or a closed state of the switch) in which a current flows between the source electrode and the drain electrode when the select transistor 912 receives, at its gate electrode, an on-potential signal (low-level or L signal) as a scanning signal from the scanning signal line 902. This causes an image signal from the image signal line 903 to be provided to the gate electrode of the drive transistor 913 through the select transistor 912.

The drive transistor 913 (or a drive element) drives the light emitter 914 with a current based on the potential difference (Vdd−Vss) between a first power potential Vdd provided through the first power potential input section 916 and a second power potential Vss provided through the second power potential input section 917 and based on the level (potential) of the image signal transmitted from the image signal line 903. In other words, the drive transistor 913 can control a current flowing through the light emitter 914. The first power potential input section 916 is connected to a first power line Lvd as a power line on the positive power potential (or a first power potential) end. The first power potential Vdd provided from the first power line Lvd to the first power potential input section 916 is about 3 to 5 volts (V). The first power potential Vdd may be about 8 to 15 V. The second power potential input section 917 is connected to a second power line Lvs as a power line on the negative power potential (or a second power potential) end. The second power potential Vss provided from the second power line Lvs to the second power potential input section 917 is about −3 to 0 V. The second power line Lvs may be a ground line that is grounded. The drive transistor 913 may be a p-channel transistor. In this case, the drive transistor 913 includes the source electrode connected to the first power potential input section 916. The drive transistor 913 includes the drain electrode connected to the second power potential input section 917 through the emission control transistor 919 and the light emitter 914. The drive transistor 913 enters the conductive state when receiving an image signal from the image signal line 903 at its gate electrode.

The capacitor 918 is located on the connection line connecting the gate electrode and the source electrode of the drive transistor 913. The capacitor 918 retains the potential of an image signal input into the gate electrode of the drive transistor 913 for a period (or a period of one frame) until the next image signal is input (or until refreshing occurs).

The emission control transistor 919 is located on a drive line 925 connecting the drive transistor 913 and the light emitter 914 to control the emission or non-emission of the light emitter 914. The emission control transistor 919 may be a p-channel transistor. In this case, the emission control transistor 919 includes the source electrode connected to the drain electrode of the drive transistor 913. In other words, the emission control transistor 919 is connected in cascade to the drive transistor 913. The emission control transistor 919 includes the drain electrode connected to the positive electrode of the light emitter 914. The emission control transistor 919 enters the conductive state when receiving a L signal as an emission control signal (or an Emi signal) at its gate electrode. This allows a current (or a drive current) to flow from the first power potential input section 916 to the light emitter 914 through the drive transistor 913, the emission control transistor 919, and the drive line 925, thus causing the light emitter 914 to emit light. The light intensity (luminance) of the light emitter 914 can be controlled by controlling the level (potential) of the image signal. In this case, the L signal is an on-potential signal that causes the emission control transistor 919 to be in the conductive state (on-state). The L signal as the on-potential signal may have a potential (or a L potential) Vgl that is lower than the second power potential Vss provided from the second power line Lvs.

When one or more subpixels 915 have a connection failure between the light emitter 914 and the feedthrough conductors, the light emitter 914 may not emit light at an intended intensity, with a drive current flowing insufficiently. In another case, one or more subpixels 915 may include a defective light emitter 914 or a deteriorating or broken component. This may also cause the light emitter 914 to emit light at an unintended intensity and have an emission failure.

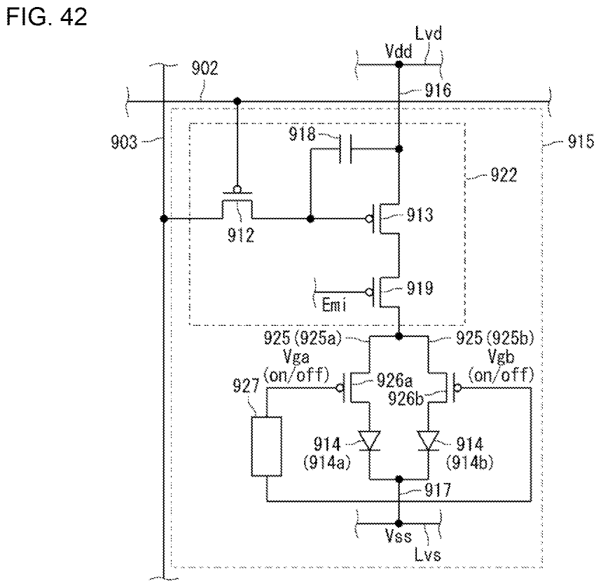

As illustrated in FIG. 42, the subpixel 915 may include two light emitters 914 connected in parallel and allow either of the two light emitters 914 that has no failure to emit light continuously.

FIG. 42 is a schematic circuit diagram of a subpixel 915 in a second reference example. The circuit of the subpixel 915 illustrated in FIG. 42 is altered from the circuit of the subpixel 915 illustrated in FIG. 41, with one or more components replaced and a component added. The components replaced in the circuit of the subpixel 915 illustrated in FIG. 41 are the drive line 925 and the light emitter 914. The components in the circuit of the subpixel 915 illustrated in FIG. 42 resulting from the replacement are a first drive line 925a and a second drive line 925b as two drive lines 925, a first light emitter 914a and a second light emitter 914b as two light emitters 914, a first switch 926a, and a second switch 926b. The component added to the circuit of the subpixel 915 illustrated in FIG. 42 is a switch controller 927.

As illustrated in FIG. 42, the first drive line 925a and the second drive line 925b are connected to the emission controller 922 and connected in parallel to each other. In this structure, one of the first drive line 925a or the second drive line 925b is a normal drive line, and the other is a backup drive line (or a redundant drive line). The first drive line 925a is connected to the positive electrode of the first light emitter 914a, and the negative electrode of the first light emitter 914a is connected to the second power potential input section 917. The second drive line 925b is connected to the positive electrode of the second light emitter 914b, and the negative electrode of the second light emitter 914b is connected to the second power potential input section 917. The first switch 926a is located on the first drive line 925a to set the first drive line 925a to an in-use state (or a driving state) or a non-use state (or a non-driving state). The second switch 926b is located on the second drive line 925b to set the second drive line 925b to the in-use state (driving state) or the non-use state (non-driving state). The switch controller 927 sets one of the first switch 926a or the second switch 926b to a nonconductive state (or an off-state or an open state of the switch) in which no current flows, and sets the other to the conductive state. This allows either of the two light emitters 914 that has no failure, or specifically the first light emitter 914a or the second light emitter 914b, to emit light continuously. The first switch 926a and the second switch 926b may be p-channel transistors. In this case, the p-channel transistor as the first switch 926a is connected in cascade to the emission control transistor 919. The p-channel transistor as the second switch 926b is connected in cascade to the emission control transistor 919. For the first light emitter 914a to continuously emit light, the switch controller 927 inputs an on-potential signal (Vga, a L signal) into the gate electrode of the first switch 926a and an off-potential signal (Vgb, a H signal) into the gate electrode of the second switch 926b. The H signal as the off-potential signal may have a potential (or a H potential) Vgh that is higher than the first power potential Vdd provided from the first power line Lvd. For the second light emitter 914b to continuously emit light, the switch controller 927 inputs an off-potential signal (Vga, a H signal) into the gate electrode of the first switch 926a and an on-potential signal (Vgb, a L signal) into the gate electrode of the second switch 926b.

A transistor included in a common-source amplifier typically has a low output resistance and, at a constant gate voltage Vgs, has a changeable drain current (or a source-drain current) Ids as an output current due to channel length modulation in response to a change in a voltage Vds between the source electrode and the drain electrode. In both the first reference example and the second reference example, the drive transistor 913 in the subpixel 915 can undergo a change in the voltage Vds between the source electrode and the drain electrode, and thus a change in the drain current Ids as an output current, in response to a change in at least one of the first power potential Vdd, the second power potential Vss, or a forward voltage applied to the light emitter 914. The first power potential Vdd can decrease depending on the distance between the power supply and the position on the first power line Lvd connected to the first power potential input section 916. The second power potential Vss can increase depending on the distance between the power supply and the position on the second power line Lvs connected to the second power potential input section 917. The forward voltage applied to the light emitter 914 can change with, for example, the characteristics of the light emitter 914 such as the light emission efficiency or the internal resistance or based on the setting values for the light emitter 914 such as the drive current, the forward voltage, or the luminance. For the drive transistor 913, ΔIds=ΔVds/Ro1 is satisfied, where Ro1 is the output resistance, ΔVds is a change in the voltage (or the drain-source voltage) Vds between the drain electrode and the source electrode, and ΔIds is a change in the drain current Ids as an output current. A lower output resistance Ro1 causes a greater change ΔIds in the drain current Ids in response to the change ΔVds in the drain-source voltage Vds. A change in the drain current Ids in the drive transistor 913 may cause the light emitter 914 to emit light with unintended luminance, thus causing uneven luminance and uneven color in a display device 100. Uneven luminance includes uneven brightness in a single color such as red (R), green (G), blue (B), or white (W). Uneven color includes uneven mixing ratio of RGB.

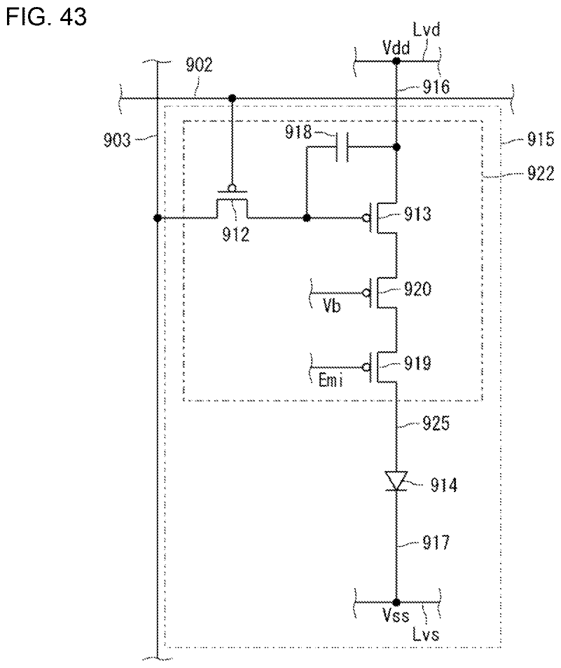

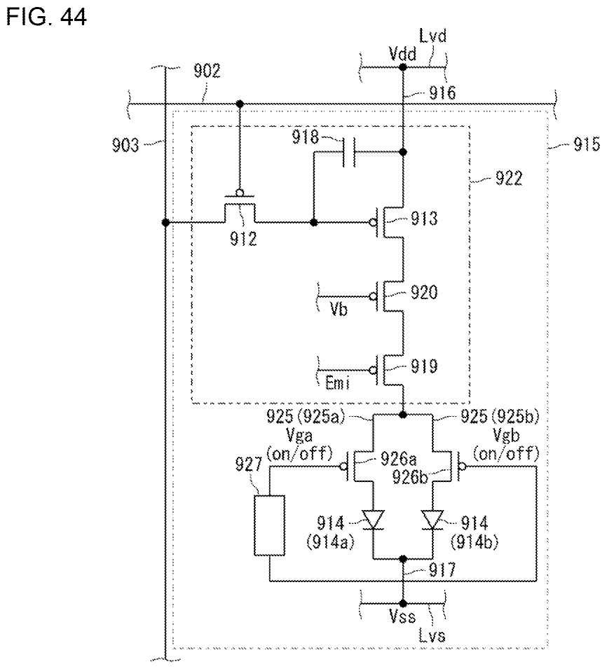

As illustrated in FIGS. 43 and 44, the circuit may include a transistor (or a cascode transistor) 920 connected in cascade to the drive transistor 913 with the drain electrode of the drive transistor 913 to form a cascode connection with the drive transistor 913. The cascode transistor 920 is of the same conductivity type as the drive transistor 913. The cascode transistor 920 receives, at its gate electrode, a predetermined potential (or an input potential) Vb between the first power potential Vdd and the second power potential Vss. In the examples in FIGS. 43 and 44, the p-channel transistor as the drive transistor 913 includes the drain electrode connected to the source electrode of the p-channel transistor as the cascode transistor 920. The p-channel transistor as the cascode transistor 920 includes the drain electrode connected to the source electrode of the p-channel transistor as the emission control transistor 919. The drive transistor 913 has the apparent output resistance Ro expressed as Ro˜ gm2×Ro2×Ro1, where Ro2 is the output resistance of the cascode transistor 920, and gm2 is the transconductance of the cascode transistor 920. In other words, the cascode transistor 920 in a cascode connection with the drive transistor 913 increases the output resistance of the drive transistor 913 by about (gm2×Ro2) times. More specifically, when (gm2×Ro2) is 10, the drive transistor 913 has the output resistance increased by about 10 times. In this case, the drive transistor 913 has the change ΔIds in the drain current Ids decreased by about one-tenth in response to the change ΔVds in the drain-source voltage Vds. The drive transistor 913 is thus less likely to undergo a change in the drain current Ids caused by channel length modulation in response to a change in at least one of the first power potential Vdd, the second power potential Vss, or the forward voltage applied to the light emitter 914.

The drive transistor 913 is connected in cascade to multiple transistors between the first power potential input section 916 and the second power potential input section 917, including the emission control transistor 919, the cascode transistor 920, and the first switch 926a or the second switch 926b. Thus, a larger portion of the potential difference (Vdd−Vss) is applied to the series resistance of the multiple transistors connected in cascade to the drive transistor 913, causing a lower drain-source voltage Vds of the drive transistor 913. When the potential difference (Vdd−Vss) decreases due to, for example, a decrease in the first power potential Vdd or an increase in the second power potential Vss, the conditions for the drive transistor 913 to operate in a saturation region are stricter. In other words, the drive transistor 913 cannot operate in the saturation region easily. This can easily cause gradations (or uneven luminance), or a gradual decrease in the luminance of the display device as viewed in plan. This can lower the image quality of the display device.

This can occur typically in a display device including pixel circuits in each of which the drive transistor 913 as a drive element for driving the light emitter 914 with a current is connected in cascade to multiple transistors between the first power potential input section 916 and the second power potential input section 917.

The image quality of the display device is thus to be improved.

The inventor of the present disclosure thus has developed a technique for improving the image quality of a display device. For example, a pixel circuit includes a first transistor and a second transistor. The first transistor is connected in series to a light emitter and controls a current flowing through the light emitter in response to a potential corresponding to an image signal received at a gate electrode. The second transistor is connected in cascade to the first transistor and switches the light emitter between an emissive state and a non-emissive state. The second transistor includes a gate electrode to selectively receive a first potential or a second potential. The first potential is higher than or equal to the first power potential or is lower than or equal to the second power potential to set the second transistor to a nonconductive state between a source electrode and a drain electrode. The second potential is between the first power potential and the second power potential to allow a current to flow between the source electrode and the drain electrode of the second transistor. When the second transistor is connected in cascade to the first transistor with the drain electrode of the first transistor, the second transistor forms a cascode connection with the first transistor in response to the second potential received at the gate electrode. When the first transistor and the second transistor are each a p-channel transistor, the second potential is, for example, lower than the drain potential of the first transistor to cause the first transistor to operate in the saturation region. When the first transistor and the second transistor are each an n-channel transistor, the second potential is, for example, higher than the drain potential of the first transistor to cause the first transistor to operate in the saturation region.

When the second transistor is connected in cascade to the first transistor with the source electrode of the first transistor, the second transistor serves as a degeneration resistance for the first transistor in response to the second potential received at the gate electrode. The second potential is a potential that is applied to the gate electrode of the second transistor to cause the light emitter to emit light. At the second potential, the second transistor causes the first transistor to operate in the saturation region, and functions as an analog device that allows a linear relationship between the gate voltage and the drain current in the first transistor. When the first transistor and the second transistor are each a p-channel transistor, the second potential is lower than the source potential of the first transistor. When the first transistor and the second transistor are each an n-channel transistor, the second potential is higher than the source potential of the first transistor.

The first transistor may be connected in cascade to the second transistor and may not be connected in cascade to an element other than the second transistor. This allows the first transistor as a drive transistor to operate in the saturation region easily. This reduces gradations or a gradual decrease in the luminance of the display device as viewed in plan.

When the first transistor and the second transistor are each a p-channel transistor and the second transistor is connected in cascade to the first transistor with the drain electrode of the first transistor, the second potential is lower than the drain potential of the first transistor. The second potential may be defined as, for example, the potential described below. The second potential is lower than or equal to the potential obtained by subtracting the sum of a negative voltage being an overdrive voltage of the first transistor and a negative voltage being the gate-source voltage (gate voltage) of the second transistor from the potential (source potential) at the source electrode of the first transistor. For example, the overdrive voltage is a value (e.g., about −0.5 V) obtained by subtracting a threshold voltage Vth1 (e.g., about −1 V) of the first transistor from a gate-source voltage (gate voltage) Vgs1 (e.g., about −1.5 V) of the first transistor. The second potential may be lower than the drain potential of the first transistor by about 0.5 to 2 V. When the first transistor and the second transistor are each an n-channel transistor, the second potential may be higher than the source potential of the first transistor by about 0.5 to 2 V.

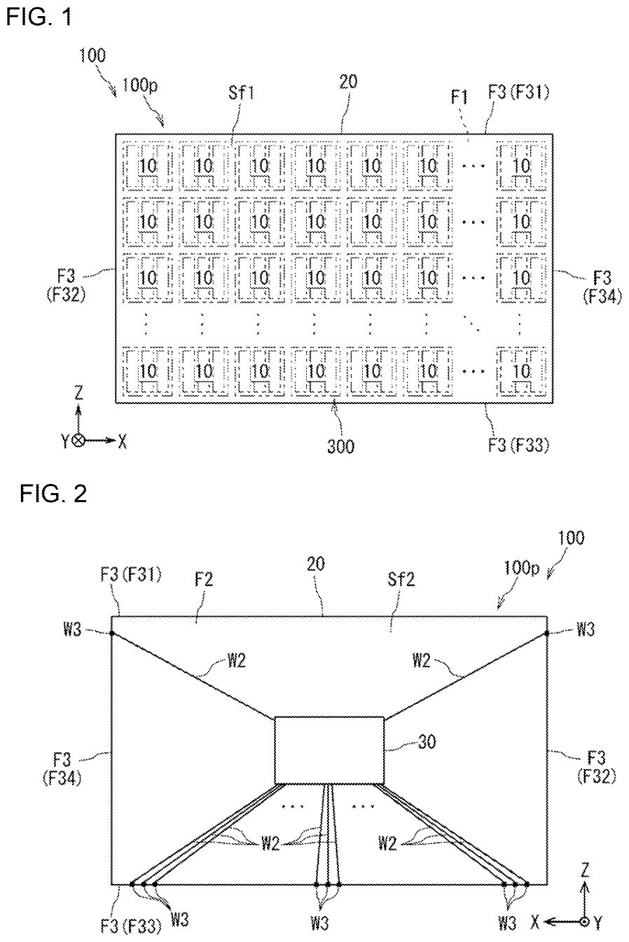

The above structures and functions in various embodiments will now be described with reference to the drawings. In the drawings, the same reference numerals denote the components with the same or similar structures and functions, and such components are not described repeatedly. The drawings are schematic. FIGS. 1, 2, and 40 illustrate the right-handed XYZ coordinate system. In this XYZ coordinate system, the positive X-direction refers to a first direction parallel to a first surface F1 of a substrate 20, the positive Z-direction refers to a second direction orthogonal to the positive X-direction parallel to the first surface F1, and the positive Y-direction refers to a third direction perpendicular to the first surface F1.

### 1. First Embodiment

### 1-1. Overview of Display Device Structure

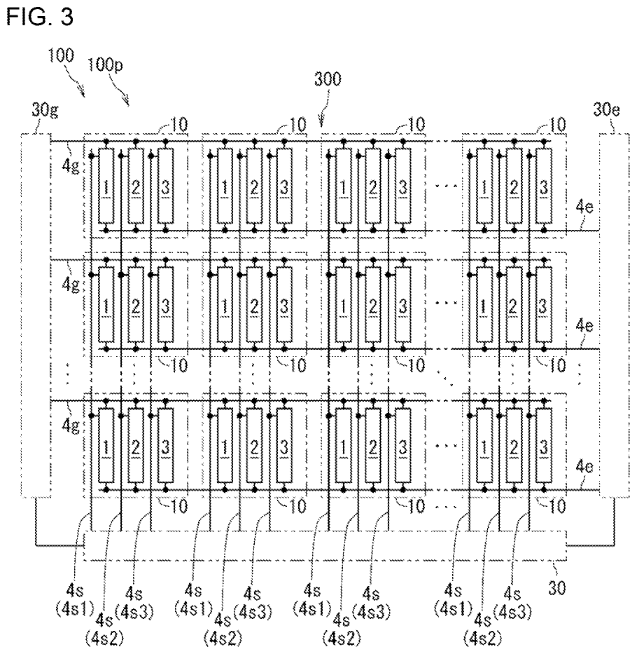

FIG. 1 is a schematic front view of an example display device 100 according to a first embodiment. FIG. 2 is a schematic rear view of the display device 100 according to the first embodiment. FIG. 3 is a schematic block circuit diagram of the display device 100 with an example structure according to the first embodiment. As illustrated in FIGS. 1 to 3, the display device 100 includes a display panel 100p and a drive 30. The display panel 100p includes multiple pixel circuits 10. The display panel 100p includes a surface (or a display surface) Sf1 for displaying an image and a surface (or a non-display surface) Sf2 opposite to the display surface Sf1. The display panel 100p is a flat plate that is rectangular, trapezoidal, or circular as viewed in plan. In the first embodiment, the display panel 100p includes the substrate 20 and the multiple pixel circuits 10.

The substrate 20 includes the first surface (or a first main surface) F1, a second surface (or a second main surface) F2, and multiple side surfaces F3. The second surface F2 is opposite to the first surface F1. Each side surface F3 connects the first surface F1 and the second surface F2. The substrate 20 is a flat plate. Each of the first surface F1 and the second surface F2 is a rectangular surface with four sides. In this case, the side surfaces F3 include a first side surface F31, a second side surface F32, a third side surface F33, and a fourth side surface F34. The first side surface F31 connects a first side of the first surface F1 and a first side of the second surface F2. In other words, the first side surface F31 includes the first side of the first surface F1 and the first side of the second surface F2 facing each other. The second side surface F32 connects a second side of the first surface F1 and a second side of the second surface F2. In other words, the second side surface F32 includes the second side of the first surface F1 and the second side of the second surface F2 facing each other. The third side surface F33 connects a third side of the first surface F1 and a third side of the second surface F2. In other words, the third side surface F33 includes the third side of the first surface F1 and the third side of the second surface F2 facing each other. The fourth side surface F34 connects a fourth side of the first surface F1 and a fourth side of the second surface F2. In other words, the fourth side surface F34 includes the fourth side of the first surface F1 and the fourth side of the second surface F2 facing each other. In the examples in FIGS. 1 and 2, the first surface F1 is flat along an XZ plane and faces in the negative Y-direction. The second surface F2 is flat along the XZ plane and faces in the positive Y-direction. The first side surface F31 faces in the positive Z-direction. The second side surface F32 faces in the negative X-direction. The third side surface F33 faces in the negative Z-direction. The fourth side surface F34 faces in the positive X-direction. The substrate 20 is a glass plate. The glass plate may be or may not be transparent. The substrate 20 may be a colored glass substrate, a frosted glass substrate, a plastic substrate, a ceramic substrate, a metal substrate, or a composite substrate including two or more of these substrates laminated together.

The pixel circuits 10 each serve as a pixel unit. The pixel circuits 10 are in a matrix. The pixel circuits 10 are in a matrix on the first surface F1 of the substrate 20. In this case, multiple pixel circuits 10 are included in each column, and multiple pixel circuits 10 are included in each row. More specifically, the pixel circuits 10 are in n rows×m columns (n and m are natural numbers). The pixel circuits 10 are included in a portion (or an image display) 300 that displays images. The image display 300 is located on the first surface F1 of the substrate 20. In the examples in FIGS. 1 and 2, the surface of the image display 300 facing in the negative Y-direction is the display surface Sf1 of the display panel 100p. The image display 300 may cover substantially the entire first surface F1. In this case, the display device 100 includes the image display 300 located on the entire first surface F1 of the substrate 20 (or a frameless structure) or includes the image display 300 with a minimum frame portion on its periphery (or a narrow frame structure).

Each pixel circuit 10 includes multiple subpixel circuits. The multiple subpixel circuits each serve as a subpixel included in a pixel unit. The multiple subpixel circuits include a first subpixel circuit 1, a second subpixel circuit 2, and a third subpixel circuit 3. The first subpixel circuit 1 emits light of a first color. The second subpixel circuit 2 emits light of a second color different from the first color. The third subpixel circuit 3 emits light of a third color different from the first color or the second color. The first color, the second color, and the third color may be red, green, and blue. When the first color is red, the second color may be green and the third color may be blue, or the second color may be blue and the third color may be green. When the first color is green, the second color may be red and the third color may be blue, or the second color may be blue and the third color may be red. When the first color is blue, the second color may be red and the third color may be green, or the second color may be green and the third color may be red. Each pixel circuit 10 includes the first subpixel circuit 1, the second subpixel circuit 2, and the third subpixel circuit 3 arranged in the row direction in this order. In this case, multiple first subpixel circuits 1 are included in a row, multiple second subpixel circuits 2 are included in a row, and multiple third subpixel circuits 3 are included in a row. Multiple first subpixel circuits 1 are included in a column, multiple second subpixel circuits 2 are included in a column, and multiple third subpixel circuits 3 are included in a column. Each pixel circuit 10 may include the first subpixel circuit 1, the second subpixel circuit 2, and the third subpixel circuit 3 arranged in any order.

The drive 30 is electrically connected to each pixel circuit 10. The drive 30 is located on the non-display surface Sf2 of the display panel 100p. In the first embodiment, the drive 30 is on the second surface F2 of the substrate 20. The drive 30 may include drive elements such as integrated circuits (ICs) or large-scale integration (LSI) circuits mounted on the second surface F2 of the substrate 20 by chip on glass (COG). The drive 30 may be a circuit board on which drive elements are mounted. The drive 30 may also be a thin-film circuit including a TFT including a low-temperature polysilicon (LTPS) semiconductor layer directly formed on the second surface F2 of the substrate 20 with a thin film formation method such as chemical vapor deposition (CVD). The drive 30 is electrically connected to the image display 300 on the first surface F1 of the substrate 20 with multiple wires including wires (or back wires) W2 located on the second surface F2 of the substrate 20 and wires (or side wires) W3 located on the side surfaces F3 of the substrate 20. The multiple wires are thus included in the display panel 100p.

As illustrated in FIG. 3, the display panel 100p includes multiple image signal lines 4s, multiple scanning signal lines (or gate signal lines) 4g, and multiple emission control signal lines 4e. The scanning signal lines 4g and the image signal lines 4s are in a grid. The display panel 100p also includes a scanning signal line drive 30g and an emission control signal line drive 30e.

The image signal lines 4s can transmit signals (or image signals) for controlling the level of light emission to the corresponding first subpixel circuits 1, second subpixel circuits 2, or third subpixel circuits 3. Image signal lines 4s extend along each column of pixel circuits 10. In the example in FIG. 3, three image signal lines 4s extend along each column of pixel circuits 10. The three image signal lines 4s include a first image signal line 4s1, a second image signal line 4s2, and a third image signal line 4s3. More specifically each column of pixel circuits 10 includes the first image signal line 4s1 along a column of first subpixel circuits 1, the second image signal line 4s2 along a column of second subpixel circuits 2, and the third image signal line 4s3 along a column of third subpixel circuits 3. In each column of pixel circuits 10, the first image signal line 4s1 is electrically connected to the first subpixel circuits 1 in a column. The second image signal line 4s2 is electrically connected to the second subpixel circuits 2 in a column. The third image signal line 4s3 is electrically connected to the third subpixel circuits 3 in a column. Each image signal line 4s may receive an image signal provided from the drive 30. The drive 30 may provide image signals to the image signal lines 4s in a time-shared manner through selector circuits with a time-sharing system. One selector circuit may be located for each column of pixel circuits 10. The selector circuit may provide image signals from the drive 30 to the first image signal line 4s1, the second image signal line 4s2, and the third image signal line 4s3 in time sequence (in line sequence). The selector circuit may include three transfer gates. The selector circuit may be located in an open area in the image display 300 or the frame portion outside the image display 300 on the first surface F1 of the substrate 20.

The scanning signal lines 4g can transmit signals (or scanning signals) for controlling the timing of input of image signals into the corresponding first subpixel circuits 1, second subpixel circuits 2, and third subpixel circuits 3. One scanning signal line 4g extends along each row of pixel circuits 10. In this case, an M-th scanning signal line 4g (M is a natural number) extends along an M-th row of pixel circuits 10. The M-th scanning signal line 4g is electrically connected to the first subpixel circuits 1, the second subpixel circuits 2, and the third subpixel circuits 3 included in the pixel circuits 10 in the M-th row. The multiple scanning signal lines 4g may receive scanning signals in time sequence (in line sequence) from the scanning signal line drive 30g. The scanning signal line drive 30g may include a circuit such as a shift register. The scanning signal line drive 30g is located on the first surface F1 of the substrate 20. In this case, the scanning signal line drive 30g may be located in an open area in the image display 300 or the frame portion outside the image display 300. The scanning signal line drive 30g can provide scanning signals in time sequence (in line sequence) to the multiple scanning signal lines 4g in response to signals from the drive 30.

The emission control signal lines 4e can transmit signals (or emission control signals) for controlling the timing of light emission to the corresponding first subpixel circuits 1, second subpixel circuits 2, and third subpixel circuits 3. One emission control signal line 4e extends along a row of pixel circuits 10. In this case, an M-th emission control signal line 4e (M is a natural number) extends along an M-th row of pixel circuits 10. The M-th emission control signal line 4e is electrically connected to the first subpixel circuits 1, the second subpixel circuits 2, and the third subpixel circuits 3 included in the pixel circuits 10 in the M-th row. The multiple emission control signal lines 4e may receive emission control signals in time sequence (in line sequence) from the emission control signal line drive 30e. The emission control signal line drive 30e may include a circuit such as a shift register. The emission control signal line drive 30e is located on the first surface F1 of the substrate 20. In this case, the emission control signal line drive 30e may be located in an open area in the image display 300 or the frame portion outside the image display 300. The emission control signal line drive 30e can provide emission control signals to the multiple emission control signal lines 4e in time sequence (in line sequence) in response to signals from the drive 30.

### 1-2. Structure of Subpixel Circuit

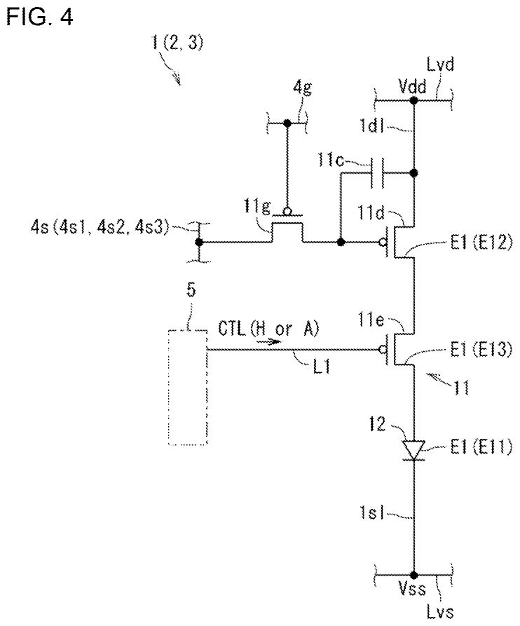

FIG. 4 is a circuit diagram of an example first subpixel circuit 1 in the first embodiment. Each pixel circuit 10 includes the first subpixel circuit 1 with the same or similar structure. In the first embodiment, each of the second subpixel circuit 2 and the third subpixel circuit 3 has the same or similar structure as the first subpixel circuit 1.

The first subpixel circuit 1 includes a first power potential input section 1d1, a second power potential input section 1s1, and multiple elements E1 connected in series or in cascade between the first power potential input section 1d1 and the second power potential input section 1s1.

The first power potential input section 1d1 can provide the first power potential Vdd. The first power potential input section 1d1 is connected to the first power line Lvd. The first power line Lvd is connected to a power supply that provides the first power potential Vdd to the first power line Lvd. The first power potential Vdd may be set to any positive potential. The first power potential Vdd may be set to about 8 V.

The second power potential input section 1s1 can provide the second power potential Vss lower than the first power potential Vdd. The second power potential input section 1s1 is connected to the second power line Lvs. The second power line Lvs is connected to a power supply that provides the second power potential Vss to the second power line Lvs. The second power potential Vss may be a positive potential or a negative potential that is lower than the first power potential Vdd. The second power potential Vss may be set to about 0 V. The second power line Lvs may be a ground line that is grounded.

The multiple elements E1 include a light emitter 12 as a first element E11, a first transistor 11d as a second element E12, and a second transistor 11e as a third element E13. In the example in FIG. 4, the first transistor 11d as the second element E12, the second transistor 11e as the third element E13, and the light emitter 12 as the first element E11 are connected in series or in cascade in this order between the first power potential input section 1d1 and the second power potential input section 1s1. In the first embodiment, the first subpixel circuit 1 includes a third transistor 11g and a capacitor 11c. The first transistor 11d, the second transistor 11e, the third transistor 11g, and the capacitor 11c are included in an emission controller 11 to control the light emission of the light emitter 12. More specifically, the emission controller 11 can control, for example, the emission or non-emission and the light intensity of the light emitter 12.

The light emitter 12 emits light of a predetermined color. The light emitter 12 in the first subpixel circuit 1 emits light of a first color. The light emitter 12 in the second subpixel circuit 2 emits light of a second color. The light emitter 12 in the third subpixel circuit 3 emits light of a third color. The light emitter 12 may be a micro-LED or an organic EL element. The light emitter 12 in the first subpixel circuit 1 may be a micro-LED or an organic EL element that emits light of the first color. The light emitter 12 in the second subpixel circuit 2 may be a micro-LED or an organic EL element that emits light of the second color. The light emitter 12 in the third subpixel circuit 3 may be a micro-LED or an organic EL element that emits light of the third color.

The first transistor 11d is connected in series to the light emitter 12. The first transistor 11d can control a current flowing through the light emitter 12 in response to a potential corresponding to an image signal received at the gate electrode. The first transistor 11d can control a current flowing through the light emitter 12 in response to a potential corresponding to an image signal received at the gate electrode from the first image signal line 4s1. In other words, the first transistor 11d functions as an element (or a drive element) for driving the light emitter 12 with a current based on the potential difference (Vdd−Vss) between the first power potential Vdd and the second power potential Vss and based on the level (potential) of the image signal transmitted from the first image signal line 4s1. The first transistor 11d may be a p-channel TFT (p-channel transistor). In this case, the first transistor 11d includes the source electrode connected to the first power potential input section 1d1. The first transistor 11d includes the drain electrode connected to the second power potential input section 1s1 through the second transistor 11e and the light emitter 12. In response to a potential corresponding to an image signal in a predetermined range lower than the first power potential Vdd received from the first image signal line 4s1 at the gate electrode, the first transistor 11d enters a state (or a conductive state or an on-state) in which a current flows between the source electrode and the drain electrode. This allows a drive current to flow from the first power potential input section 1d1 through the first transistor 11d and the second transistor 11e to the light emitter 12. The light intensity (luminance) of the light emitter 12 can be controlled based on the level (potential) of the image signal. In other words, the first transistor 11d can control the light intensity of the light emitter 12. In the second subpixel circuit 2, an image signal is input from the second image signal line 4s2, instead of the first image signal line 4s1. In the third subpixel circuit 3, an image signal is input from the third image signal line 4s3, instead of the first image signal line 4s1.

The third transistor 11g functions as an element for inputting an image signal into the emission controller 11. The third transistor 11g may be a p-channel transistor. In this case, the third transistor 11g includes the gate electrode connected to the scanning signal line 4g. The third transistor 11g includes the source electrode (drain electrode) connected to the first image signal line 4s1. The third transistor 11g includes the drain electrode (source electrode) connected to the gate electrode of the first transistor 11d. In response to an on-potential signal as a scanning signal from the scanning signal line 4g received at the gate electrode, the third transistor 11g enters the conductive state in which a current flows between the source electrode and the drain electrode. This allows an image signal from the first image signal line 4s1 to be input into the gate electrode of the first transistor 11d through the third transistor 11g. In this case, the on-potential signal is a L signal with a potential (or a low potential or a L potential) Vgl lower than or equal to the second power potential Vss. When the second power potential Vss is 0 V, the L potential Vgl is set to about −2 to 0 V. In the second subpixel circuit 2, the third transistor 11g includes the source electrode (drain electrode) connected to the second image signal line 4s2 to receive an image signal from the second image signal line 4s2, instead of the first image signal line 4s1. In the third subpixel circuit 3, the third transistor 11g includes the source electrode (drain electrode) connected to the third image signal line 4s3 to receive an image signal from the third image signal line 4s3, instead of the first image signal line 4s1.

The capacitor 11c is located on the connection line connecting the gate electrode and the source electrode of the first transistor 11d. The capacitor 11c retains a potential Vsig of the image signal input into the gate electrode of the first transistor 11d for a period (period of one frame) until the next image signal is input (or until refreshing occurs).

The second transistor 11e is connected in cascade to the first transistor 11d. The second transistor 11e can switch the light emitter 12 between a state with light emission (or an emissive state) and a state without light emission (or a non-emissive state). In the first embodiment, the second transistor 11e functions as an element (or an emission control element) for controlling the emission or non-emission of the light emitter 12. The second transistor 11e is located on the connection line (or a drive line) connecting the first transistor 11d and the light emitter 12. The second transistor 11e is of the same conductivity type as the first transistor 11d. The conductivity type includes a p-type with holes as carriers to generate a current between the source electrode and the drain electrode and an n-type with electrons as carriers to generate a current between the source electrode and the drain electrode. The second transistor 11e may be a p-channel transistor. In this case, the second transistor 11e is connected in cascade to the first transistor 11d with the drain electrode of the first transistor 11d. More specifically, the first transistor 11d includes the drain electrode connected to the source electrode of the second transistor 11e. The second transistor 11e includes the drain electrode connected to the light emitter 12. More specifically, the second transistor 11e includes the drain electrode connected to the anode electrode (positive electrode) of the light emitter 12. The cathode electrode (negative electrode) of the light emitter 12 is connected to the second power potential input section 1s1.

The second transistor 11e includes the gate electrode to selectively receive a first potential V1 or a second potential V2. The first potential V1 is a potential (or an off-potential) to set the second transistor 11e to a state (or a nonconductive state or an off-state) in which no current flows between the source electrode and the drain electrode. In the first embodiment, the second transistor 11e may be a p-channel transistor. In this case, the first potential V1 is set to a potential higher than or equal to the first power potential Vdd. More specifically, the first potential V1 is a H potential Vgh of a high (H) signal being an off-potential signal to cause the second transistor 11e to be in the nonconductive state (off-state). In this case, when the first power potential Vdd is 8 V, the first potential V1 is set to 8 to about 10 V. The second potential V2 is a potential to allow a current to flow between the source electrode and the drain electrode of the second transistor 11e. The second potential V2 is set to a potential between the first power potential Vdd and the second power potential Vss. In other words, the second potential V2 is set to a potential lower than the first power potential Vdd and higher than the second power potential Vss. The second potential V2 may have any analog value between the L potential and the H potential, rather than a digital discrete value such as the L potential or the H potential. When the first power potential Vdd is 8 V and the second power potential Vss is 0 V, the second potential V2 is set to a potential higher than 0 V and lower than 8 V. The signal with the second potential V2 is also referred to as an analog (A) signal as appropriate.

In response to the first potential V1 received at the gate electrode, the second transistor 11e enters the nonconductive state (off-state) to allow no current to flow through the light emitter 12 when the first transistor 11d is in the conductive state (on-state). This causes the light emitter 12 to be in a state without light emission (non-emissive state). In response to the second potential V2 received at the gate electrode of the second transistor 11e, a current flows between the source electrode and the gate electrode of the second transistor 11e when the first transistor 11d is in the conductive state (on-state). This causes the light emitter 12 to be in a state with light emission (emissive state). In this case, the second potential V2 between the first power potential Vdd and the second power potential Vss is input into the gate electrode of the second transistor 11e, which is of the same conductivity type as the first transistor 11d and connected in cascade to the first transistor 11d with the drain electrode of the first transistor 11d. In this state, the second transistor 11e forms a cascode connection with the first transistor 11d.

The first transistor 11d has the apparent output resistance Ro expressed as Ro≈gm2×Ro2×Ro1, where Ro1 is the output resistance of the first transistor 11d, Ro2 is the output resistance of the second transistor 11e, and gm2 is the transconductance of the second transistor 11e. The output resistance of the first transistor 11d is thus increased by about (gm2×Ro2) times in a cascode connection with the second transistor 11e. More specifically, when (gm2×Ro2) is set to about 10, the first transistor 11d has the output resistance increased by about 10 times. In this state, the first transistor 11d has the change ΔIds in the drain current Ids as an output current decreased by about one-tenth in response to the change ΔVds in the voltage (or the drain-source voltage) Vds between the drain electrode and the source electrode. The first transistor 11d is thus less likely to undergo a change in the drain current Ids caused by channel length modulation in response to a change in at least one of the first power potential Vdd, the second power potential Vss, or a forward voltage applied to the light emitter 12. The display device 100 is thus less likely to have uneven luminance or uneven color.

In the first embodiment, the second transistor 11e functions as an analog device that forms a cascode connection with the first transistor 11d, in addition to functioning as a switch that switches the light emitter 12 between the emissive state and the non-emissive state. The first transistor 11d can thus effectively form a cascode connection with the second transistor 11e without increasing the number of transistors connected in cascade to the first transistor 11d. This avoids a lower drain-source voltage Vds of the first transistor 11d with the potential difference (Vdd−Vss) between the first power potential Vdd and the second power potential Vss. Thus, the conditions for the first transistor 11d to operate in a saturation region are less likely to be stricter in response to a decrease in the potential difference (Vdd−Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

The second potential V2 may be set as appropriate before the display panel 100p or the display device 100 is shipped. The second potential V2 may be set to a predetermined potential based on the conductivity types of the first transistor 11d and the second transistor 11e, the first power potential Vdd, the second power potential Vss, a threshold voltage (or a first threshold voltage) Vth1 of the first transistor 11d, a threshold voltage (or a second threshold voltage) Vth2 of the second transistor 11e, and the range of a potential Vin corresponding to an image signal input into the gate electrode of the first transistor 11d. In this example, the first transistor 11d and the second transistor 11e are both p-channel transistors, the first power potential Vdd is 8 V, the second power potential Vss is 0 V, the first threshold voltage Vth1 is −1 V, the second threshold voltage Vth2 is −1 V, and a minimum value in the range of the potential Vin is 5 V. In this case, the first transistor 11d has a pinch-off voltage (or a first pinch-off voltage) Vdsat1 obtained by subtracting the first threshold voltage Vth1 from a gate voltage (or a first gate voltage) Vgs1 of the first transistor 11d. More specifically, Vdsat1=Vgs1−Vth1=−3V−(−1 V)=−2V. The first pinch-off voltage Vdsat1 is set to be higher than the drain-source voltage Vds of the first transistor 11d (Vdsat1>Vds) and causes the first transistor 11d to operate in the saturation region. More specifically, the drain-source voltage Vds of the first transistor 11d may be set to −3 V that is lower than the first pinch-off voltage Vdsat1 (=−2 V), and the potential (or the drain potential) at the drain electrode of the first transistor 11d may be maintained at 5 V (=8-3 V). The second transistor 11e has a pinch-off voltage (or a second pinch-off voltage) Vsat2 obtained by subtracting the second threshold voltage Vth2 from a gate voltage (or a second gate voltage) Vgs2 of the second transistor 11e. The second pinch-off voltage Vdsat2 is set to be closer to 0 V than the first pinch-off voltage Vdsat1 and causes the second transistor 11e to operate in the saturation region. More specifically, when the second pinch-off voltage Vdsat2 is −1 V, the second gate voltage Vgs2 is −2 V obtained by adding the second threshold voltage Vth2 of −1V to the second pinch-off voltage Vdsat2 of −1V. The second potential V2 may be set to 3V obtained by adding the second gate voltage Vgs2 of −2V to the drain potential of the first transistor 11d of 5 V.

In the first subpixel circuit 1, the first transistor 11d may be connected in cascade to the second transistor 11e and may not be connected in cascade to another element between the first power potential input section 1d1 and the second power potential input section 1s1. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

### 1-3. Controller

The gate electrode of the second transistor 11e selectively receives the first potential V1 or the second potential V2 from the controller 5. In other words, the controller 5 can selectively output the first potential V1 or the second potential V2 to the gate electrode of the second transistor 11e. The controller 5 may be included in each of the first subpixel circuit 1, the second subpixel circuit 2, and the third subpixel circuit 3. This allows the light emitter 12 to be switched between the emissive state and the non-emissive state for each of the subpixel circuits 1, 2, and 3.

The controller 5 is connected to the gate electrode of the second transistor 11e through a signal line (or a potential output signal line) L1. The controller 5 can thus output a signal (or a switch control signal) CTL to the gate electrode of the second transistor 11e through the potential output signal line L1.

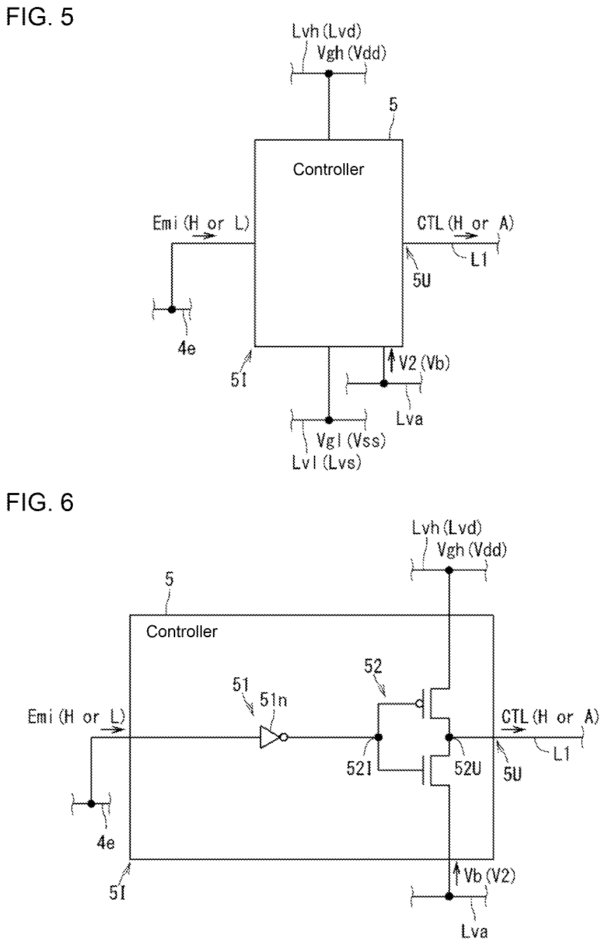

FIG. 5 is a schematic diagram of the controller 5, illustrating example input and output. The controller 5 functions as an element (or a switch) that performs switch control over the second transistor 11e. Switch control includes switching the second transistor 11e selectively between a state in which a current flows between the source electrode and the drain electrode and a state in which no current flows between the source electrode and the drain electrode. The switch can set the light emitter 12 selectively to the emissive state or the non-emissive state. As illustrated in FIG. 5, the controller 5 includes a section (or a signal input section) 5I for receiving signals and a section (or a signal output section) 5U for outputting signals. The signal input section 5I may include, for example, multiple terminals or multiple wires. The signal output section 5U may include, for example, at least one terminal or at least one wire. The signal input section 5I in the controller 5 selectively receives an on-signal or an off-signal and the second potential V2. In the first embodiment, the off-signal is a signal that is input from the emission control signal line 4e into the controller 5 to cause the light emitter 12 to be in the non-emissive state. The on-signal is a signal that is input from the emission control signal line 4e into the controller 5 to cause the light emitter 12 to be in the emissive state. The off-signal is a H signal, and the on-signal is a L signal. In other words, the controller 5 selectively receives a H signal or a L signal as the emission control signal (or an Emi signal) from the emission control signal line 4e. The controller 5 receives the second potential V2 from a wire (or a second potential supply line) Lva that provides the second potential V2. The second potential supply line Lva is connected to a power supply that provides the second potential V2 to the second potential supply line Lva.

The controller 5 outputs, from the signal output section 5U, the first potential V1 to the gate electrode of the second transistor 11e when the controller 5 receives an off-signal at the signal input section 5I. In the first embodiment, the controller 5 outputs, from the signal output section 5U, a H signal with the first potential V1 to the gate electrode of the second transistor 11e through the potential output signal line L1 when the controller 5 receives, at the signal input section 5I, a H signal being an off-signal. The controller 5 also outputs, from the signal output section 5U, the second potential V2 to the gate electrode of the second transistor 11e when the controller 5 receives, at the signal input section 5I, an on-signal and the second potential V2. In the first embodiment, the controller 5 outputs, from the signal output section 5U, an A signal with the second potential V2 to the gate electrode of the second transistor 11e through the potential output signal line L1 when the controller 5 receives, at the signal input section 5I, a L signal being an on-signal and the second potential V2.

In other words, the controller 5 can selectively output a H signal being an off-potential signal with the first potential V1 or an A signal with the second potential V2 as the switch control signal CTL to the gate electrode of the second transistor 11e through the potential output signal line L1. The single second transistor 11e can thus easily function as a switch that switches the light emitter 12 between the emissive state and the non-emissive state and also function as an analog device that forms a cascode connection with the first transistor 11d.

The controller 5 can function as a switch that controls the timing of light emission of the light emitter 12. The single second transistor 11e can thus easily achieve the switch control over the timing of light emission of the light emitter 12 and also function as an analog device that forms a cascode connection with the first transistor 11d.

As illustrated in FIG. 5, the controller 5 may receive the H potential Vgh from a wire (or a H potential supply line or a high potential supply line) Lvh that provides the H potential Vgh or receive the L potential Vgl from a wire (or a L potential supply line or a low potential supply line) Lvl that provides the L potential Vgl. The H potential supply line Lvh is connected to a power supply that provides the H potential Vgh to the H potential supply line Lvh. The L potential supply line Lvl is connected to a power supply that provides the L potential Vgl to the L potential supply line Lvl. The controller 5 may receive the first power potential Vdd from the first power line Lvd, instead of receiving the H potential Vgh from the H potential supply line Lvh. The controller 5 may receive the second power potential Vss from the second power line Lvs, instead of receiving the L potential Vgl from the L potential supply line Lvl.

FIG. 6 is a circuit diagram of an example controller 5. As illustrated in FIG. 6, the controller 5 includes a logic circuit 51 and a potential converter 52.

The logic circuit 51 converts the emission control signal input from the emission control signal line 4e as appropriate and outputs the resultant signal to the potential converter 52. In the example in FIG. 6, the logic circuit 51 is a NOT gate 51n. In this case, in response to a H signal input from the emission control signal line 4e, the logic circuit 51 converts the H signal to a L signal and outputs the L signal to the potential converter 52. In response to a L signal input from the emission control signal line 4e, the logic circuit 51 converts the L signal to a H signal and outputs the H signal to the potential converter 52.

In response to a L signal input from the logic circuit 51, the potential converter 52 converts the L signal to a H signal being an off-potential signal with the first potential V1, and outputs the H signal. In response to a H signal input from the logic circuit 51, the potential converter 52 converts the H signal to an A signal with the second potential V2, and outputs the A signal. The potential converter 52 is a circuit similar to a complementary metal-oxide-semiconductor (CMOS) NOT circuit as an inverter logic circuit. The potential converter 52 includes a p-channel transistor and an n-channel TFT (or an n-channel transistor) connected in cascade between the H potential supply line Lvh that provides the H potential Vgh and the second potential supply line Lva that provides the second potential V2. More specifically, the p-channel transistor includes the source electrode connected to the H potential supply line Lvh and the drain electrode connected to the drain electrode of the n-channel transistor. The n-channel transistor includes the source electrode connected to the second potential supply line Lva. The potential converter 52 includes an input section 52I at which the gate electrode of the p-channel transistor is connected to the gate electrode of the n-channel transistor, and an output section 52U at which the drain electrode of the p-channel transistor is connected to the drain electrode of the n-channel transistor. When the potential converter 52 receives a L signal from the logic circuit 51 at the input section 52I, the potential converter 52 outputs a H signal being an off-potential signal with the first potential V1 from the output section 52U. When the potential converter 52 receives a H signal from the logic circuit 51 at the input section 52I, the potential converter 52 outputs an A signal with the second potential V2 from the output section 52U. The output section 52U in the potential converter 52 is connected to the potential output signal line L1.

The controller 5 can thus output, from the signal output section 5U, the first potential V1 to the gate electrode of the second transistor 11e through the potential output signal line L1 when the controller 5 receives, at the signal input section 5I, a H signal being an off-signal as the emission control signal. The controller 5 can also output, from the signal output section 5U, the second potential V2 to the gate electrode of the second transistor 11e through the potential output signal line L1 when the controller 5 receives, at the signal input section 5I, a L signal being an on-signal as the emission control signal and the second potential V2.

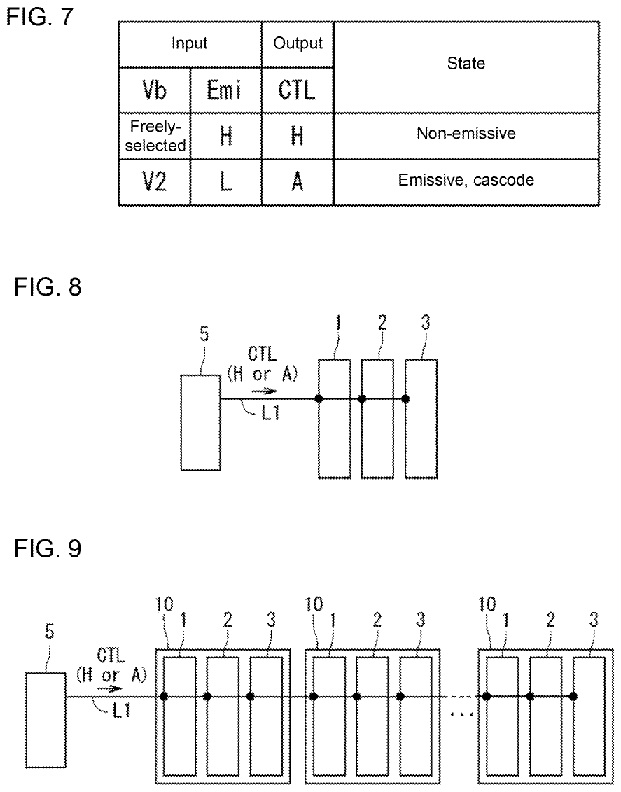

FIG. 7 is a truth table showing an example relationship between the input into the controller 5, the output from the controller 5, and the state of the first subpixel circuit 1. In this case, the controller 5 is designed to satisfy the relationship shown in FIG. 7 between a potential (or an input potential) Vb input from the second potential supply line Lva, the emission control signal input from the emission control signal line 4e, and the switch control signal CTL output to the potential output signal line L1. When the controller 5 receives a freely-selected potential as the input potential Vb from the second potential supply line Lva and a H signal being an off-signal as the emission control signal, the controller 5 outputs a H signal with the first potential V1 as the switch control signal CTL to the potential output signal line L1. The H signal being the off-potential signal with the first potential V1 is input into the gate electrode of the second transistor 11e, thus causing the second transistor 11e to enter the nonconductive state. This causes the light emitter 12 to enter the non-emissive state without light emission. When the controller 5 receives the second potential V2 as the input potential Vb from the second potential supply line Lva and a L signal being an on-signal as the emission control signal, the controller 5 outputs an A signal with the second potential V2 as the switch control signal CTL to the potential output signal line L1. The A signal with the second potential V2 is input into the gate electrode of the second transistor 11e, thus causing a current to flow between the source electrode and the drain electrode of the second transistor 11e. This causes the light emitter 12 to enter the emissive state with light emission and causes the second transistor 11e to form a cascode connection with the first transistor 11d.

The off-signal may be a L signal and the on-signal may be a H signal as the emission control signal from the emission control signal line 4e. In this case, the controller 5 may eliminate the logic circuit 51 and receive the emission control signal from the emission control signal line 4e directly at the input section 52I in the potential converter 52. In this case, the controller 5 can output, from the signal output section 5U, the first potential V1 to the gate electrode of the second transistor 11e through the potential output signal line L1 when the controller 5 receives, at the signal input section 5I, a L signal being an off-signal from the emission control signal line 4e. This causes the light emitter 12 to enter the non-emissive state without light emission. The controller 5 can also output, from the signal output section 5U, the second potential V2 to the gate electrode of the second transistor 11e through the potential output signal line L1 when the controller 5 receives, at the signal input section 5I, a H signal being an on-signal from the emission control signal line 4e and the second potential V2. This causes the light emitter 12 to enter the emissive state with light emission.

### 1-4. Variations of First Embodiment

Each pixel circuit 10 may include the controller 5 to selectively output the first potential V1 or the second potential V2 to each of the first subpixel circuit 1, the second subpixel circuit 2, and the third subpixel circuit 3. FIG. 8 is a block circuit diagram of the controller 5 connected to the subpixel circuits 1, 2, and 3 in an example manner. As illustrated in FIG. 8, the potential output signal line L1 connected to the controller 5 may be connected to the subpixel circuits 1, 2, and 3. This structure includes fewer controllers 5 for each pixel circuit 10, avoiding size increase of the pixel circuit 10. The display device 100 and the display panel 100p can thus include multiple pixel circuits 10 arranged with narrower pitches to improve resolution. The display device 100 can thus have higher image quality.

The display panel 100p may include the controller 5 for each set of multiple pixel circuits 10 to selectively output the first potential V1 or the second potential V2. In this case, the controller 5 can selectively output the first potential V1 or the second potential V2 to the gate electrode of the second transistor 11e in each pixel circuit 10. The controller 5 may be located in an open area in the image display 300 or the frame portion on the first surface F1 of the substrate 20, or may be located on the second surface F2 of the substrate 20. The controller 5 may be located for a set of pixel circuits 10 in each row. FIG. 9 is a block circuit diagram of the controller 5 connected to multiple pixel circuits 10 in an example manner. As illustrated in FIG. 9, the potential output signal line L1 connected to the controller 5 may be connected to multiple pixel circuits 10. More specifically, the potential output signal line L1 connected to the controller 5 may be connected to the subpixel circuits 1, 2, and 3 in each pixel circuit 10. This structure includes a single controller 5 for each set of multiple pixel circuits 10, avoiding size increase of the pixel circuits 10. The display device 100 and the display panel 100p can thus include multiple pixel circuits 10 arranged with narrower pitches to improve resolution. The display device 100 can thus have higher image quality.

In this case, the controller 5 can output, from the signal output section 5U, the first potential V1 as the off-potential to the gate electrode of the second transistor 11e in each pixel circuit 10 when the controller 5 receives, at the signal input section 5I, an off-signal for the switch. More specifically, the controller 5 can output, from the signal output section 5U, the first potential V1 as the off-potential to the gate electrode of the second transistor 11e in each of the subpixel circuits 1, 2, and 3 in each pixel circuit 10 when the controller 5 receives, at the signal input section 5I, an off-signal for the switch. In other words, the controller 5 can output, from the signal output section 5U, a H signal being an off-potential signal with the first potential V1 to the gate electrode of the second transistor 11e in each pixel circuit 10 through the potential output signal line L1 when the controller 5 receives, at the signal input section 5I, a H signal being an off-signal for the switch. More specifically, the controller 5 can output, from the signal output section 5U, a H signal being an off-potential signal with the first potential V1 to the gate electrode of the second transistor 11e in each of the subpixel circuits 1, 2, and 3 in each pixel circuit 10 through the potential output signal line L1 when the controller 5 receives, at the signal input section 5I, a H signal being an off-signal for the switch.

The controller 5 can output, from the signal output section 5U, the second potential V2 to the gate electrode of the second transistor 11e in each pixel circuit 10 when the controller 5 receives, at the signal input section 5I, an on-signal for the switch and the second potential V2. More specifically, the controller 5 can output, from the signal output section 5U, the second potential V2 to the gate electrode of the second transistor 11e in each of the subpixel circuits 1, 2, and 3 in each pixel circuit 10 when the controller 5 receives, at the signal input section 5I, an on-signal for the switch and the second potential V2. In other words, the controller 5 can output, from the signal output section 5U, an A signal with the second potential V2 to the gate electrode of the second transistor 11e in each pixel circuit 10 through the potential output signal line L1 when the controller 5 receives, at the signal input section 5I, a L signal being an on-signal for the switch and the second potential V2. More specifically, the controller 5 can output, from the signal output section 5U, an A signal with the second potential V2 to the gate electrode of the second transistor 11e in each of the subpixel circuits 1, 2, and 3 in each pixel circuit 10 through the potential output signal line L1 when the controller 5 receives, at the signal input section 5I, a L signal being an on-signal for the switch and the second potential V2.

In other words, the controller 5 can selectively output a H signal being an off-potential signal with the first potential V1 or an A signal with the second potential V2 as the switch control signal CTL to the gate electrode of the second transistor 11e in each pixel circuit 10 through the potential output signal line L1. More specifically, the controller 5 can selectively output a H signal being an off-potential signal with the first potential V1 or an A signal with the second potential V2 as the switch control signal CTL to the gate electrode of the second transistor 11e in each of the subpixel circuits 1, 2, and 3 in each pixel circuit 10 through the potential output signal line L1.

In the first embodiment, the multiple elements E1 connected in series or in cascade between the first power potential input section 1d1 and the second power potential input section 1s1 may include elements other than the light emitter 12 as the first element E11, the first transistor 11d as the second element E12, and the second transistor 11e as the third element E13.

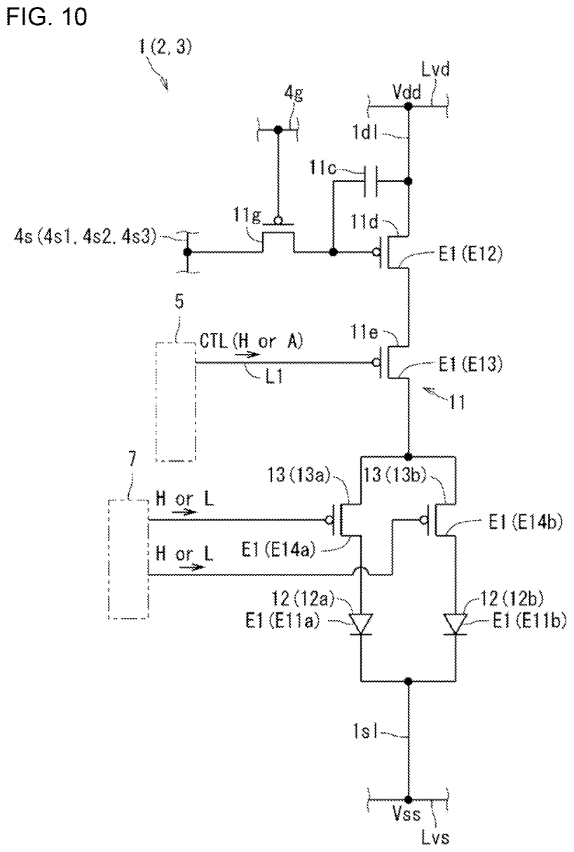

As illustrated in FIG. 10, the light emitter 12 as the first element E11 may be replaced with a light emitter 12 (or a first light emitter 12a) as a first element (or a first-A element) E11a and a light emitter 12 (or a second light emitter 12b) as another first element (or a first-B element) E11b connected in parallel. In this case, the multiple elements E1 may include a fourth transistor 13 (or a fourth-A transistor 13a) as a fourth element (or a fourth-A element) E14a connected in series to the first light emitter 12a and a fourth transistor 13 (or a fourth-B transistor 13b) as another fourth element (or a fourth-B element) E14b connected in series to the second light emitter 12b.

FIG. 10 is a circuit diagram of another example first subpixel circuit 1 in the first embodiment. In the example of the first embodiment as well, each of the second subpixel circuit 2 and the third subpixel circuit 3 has the same or similar structure as the first subpixel circuit 1.

The first subpixel circuit 1 in the example of the first embodiment is based on the first subpixel circuit 1 in the first embodiment illustrated in FIG. 4. In the example of the first embodiment, the first subpixel circuit 1 includes parallel-connected two sets of the fourth transistor 13 and the light emitter 12, instead of the single light emitter 12, between the second transistor 11e and the second power potential input section 1s1. The fourth transistor 13 and the light emitter 12 in each set are connected in series. The two sets of the fourth transistor 13 and the light emitter 12 include the set of fourth-A transistor 13a and first light emitter 12a connected in series and the set of fourth-B transistor 13b and second light emitter 12b connected in series. In other words, the first subpixel circuit 1 includes two sets of elements E1 connected in series or in cascade between the first power potential input section 1d1 and the second power potential input section 1s1. The two sets of elements E1 include a first set of elements E1 and a second set of elements E1.

The first set of elements E1 includes the first light emitter 12a as a first element (first-A element) E11a, the first transistor 11d as the second element E12, the second transistor 11e as the third element E13, and the fourth-A transistor 13a as a fourth element (fourth-A element) E14a. In the example in FIG. 10, the first transistor 11d as the second element E12, the second transistor 11e as the third element E13, the fourth-A transistor 13a as the fourth-A element E14a, and the first light emitter 12a as the first-A element E11a are connected in series or in cascade in this order between the first power potential input section 1d1 and the second power potential input section 1s1.

The second set of elements E1 includes the second light emitter 12b as another first element (first-B element) E11b, the first transistor 11d as the second element E12, the second transistor 11e as the third element E13, and the fourth-B transistor 13b as another fourth element (fourth-B element) E14b. In the example in FIG. 10, the first transistor 11d as the second element E12, the second transistor 11e as the third element E13, the fourth-B transistor 13b as the fourth-B element E14b, and the second light emitter 12b as the first-B element E11b are connected in series or in cascade in this order between the first power potential input section 1d1 and the second power potential input section 1s1.

The fourth-A transistor 13a is connected in cascade to the first transistor 11d and the second transistor 11e. The fourth-A transistor 13a is located on the connection line (drive line) connecting the second transistor 11e and the first light emitter 12a. When the fourth-A transistor 13a is a p-channel transistor, the fourth-A transistor 13a includes the source electrode connected to the drain electrode of the second transistor 11e and the drain electrode connected to the positive electrode of the first light emitter 12a. The fourth-A transistor 13a functions as an element (or a use setting element) for selectively setting the first light emitter 12a in use (or an in-use state) or not in use (or a non-use state). The fourth-A transistor 13a switches between a state (nonconductive state) in which no current flows between the source electrode and the drain electrode, and a state (conductive state) in which a current flows between the source electrode and the drain electrode in response to a H signal or a L signal selectively input from a setting controller 7. In this example, the fourth-A transistor 13a is a p-channel transistor. In this case, in response to a H signal received at the gate electrode, the fourth-A transistor 13a enters the nonconductive state to set the first light emitter 12a to the non-use state. In response to a L signal received at the gate electrode, the fourth-A transistor 13a enters the conductive state to set the first light emitter 12a to the in-use state. The setting controller 7 may be a control circuit included in each of the subpixel circuits 1, 2, and 3, or in each pixel circuit 10, or in each set of pixel circuits 10 in the display panel 100p, or in the drive 30.

The fourth-B transistor 13b is connected in cascade to the first transistor 11d and the second transistor 11e. The fourth-B transistor 13b is located on the connection line (drive line) connecting the second transistor 11e and the second light emitter 12b. When the fourth-B transistor 13b is a p-channel transistor, the fourth-B transistor 13b includes the source electrode connected to the drain electrode of the second transistor 11e and the drain electrode connected to the positive electrode of the second light emitter 12b. The fourth-B transistor 13b functions as an element (use setting element) for selectively setting the second light emitter 12b in use (in-use state) or not in use (non-use state). The fourth-B transistor 13b switches between the nonconductive state and the conductive state in response to a H signal or a L signal selectively input from the setting controller 7. In this example, the fourth-B transistor 13b is a p-channel transistor. In this case, in response to a H signal received at the gate electrode, the fourth-B transistor 13b enters the nonconductive state to set the second light emitter 12b to the non-use state. In response to a L signal received at the gate electrode. the fourth-B transistor 13b enters the conductive state to set the second light emitter 12b to the in-use state.

The fourth-A transistor 13a may be an n-channel transistor, and the fourth-B transistor 13b may be an n-channel transistor. In this example, the fourth-A transistor 13a is an n-channel transistor. In this case, in response to a L signal received at the gate electrode, the fourth-A transistor 13a enters the nonconductive state to set the first light emitter 12a to the non-use state. In response to a H signal received at the gate electrode, the fourth-A transistor 13a enters the conductive state to set the first light emitter 12a to the in-use state. In this example, the fourth-B transistor 13b is an n-channel transistor. In this case, in response to a L signal received at the gate electrode, the fourth-B transistor 13b enters the nonconductive state to set the second light emitter 12b to the non-use state. In response to a H signal received at the gate electrode, the fourth-B transistor 13b enters the conductive state to set the second light emitter 12b to the in-use state.

The fourth-A transistor 13a may be between the first light emitter 12a and the second power potential input section 1s1. The fourth-B transistor 13b may be between the second light emitter 12b and the second power potential input section 1s1.

### 1-5. Overview of First Embodiment

As described above, the pixel circuit 10 includes the light emitter 12, the first transistor 11d, and the second transistor 11e connected in series or in cascade between the first power potential input section Idi and the second power potential input section 1s1. In this case, the first transistor 11d can control a current flowing through the light emitter 12 in response to a potential corresponding to an image signal received at the gate electrode. The second transistor 11e is connected in cascade to the first transistor 11d to switch the light emitter 12 between the emissive state and the non-emissive state. The second transistor 11e is of the same conductivity type as the first transistor 11d and is connected in cascade to the first transistor 11d with the drain electrode of the first transistor 11d. The second transistor 11e includes the drain electrode connected to the light emitter 12. The second transistor 11e includes the gate electrode to selectively receive the first potential V1 or the second potential V2. The first potential V1 can set the second transistor 11e to the nonconductive state. The second potential V2 is between the first power potential Vdd and the second power potential Vss to allow a current to flow between the source electrode and the drain electrode of the second transistor 11e.

In this structure, the second transistor 11e functions as an analog device that forms a cascode connection with the first transistor 11d, in addition to functioning as a switch that switches the light emitter 12 between the emissive state and the non-emissive state. The first transistor 11d can thus effectively form a cascode connection with the second transistor 11e without increasing the number of transistors connected in cascade to the first transistor 11d. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

### 2. Other Embodiments

The present disclosure is not limited to the first embodiment described above and may be changed or varied in various manners without departing from the spirit and scope of the present disclosure.

### 2-1. Second Embodiment

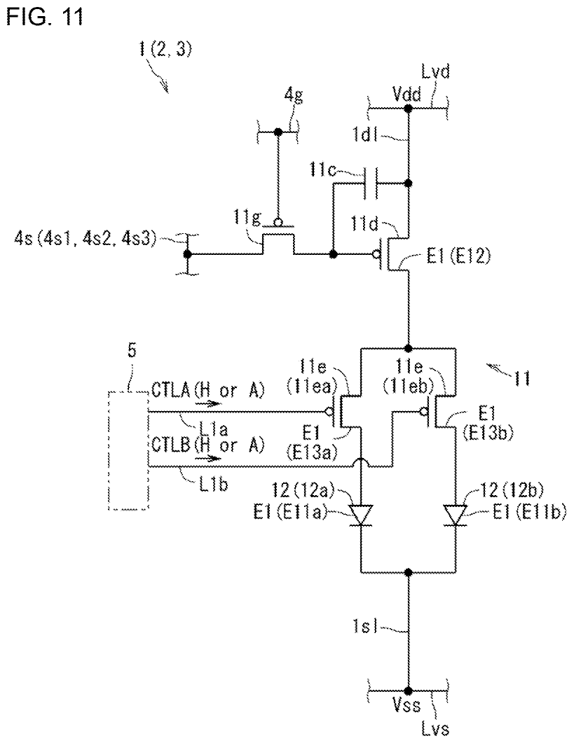

In the first embodiment, as illustrated in FIG. 11, the first subpixel circuit 1 may include multiple light emitters 12 and multiple second transistors 11e. In this case, the multiple light emitters 12 include a first light emitter 12a and a second light emitter 12b connected in parallel. The multiple second transistors 11e include a second transistor 11e (or a second-A transistor 11ea) connected in series to the first light emitter 12a and a second transistor 11e (or a second-B transistor 11eb) connected in series to the second light emitter 12b. The second-A transistor 11ea may include the gate electrode to selectively receive the first potential V1 or the second potential V2. The second-B transistor 11eb may include the gate electrode to selectively receive the first potential V1 or the second potential V2.

In this case, each second transistor 11e functions as an analog device that forms a cascode connection with the first transistor 11d, as well as a switch that switches the redundantly located light emitters 12 between the emissive state and the non-emissive state. The first transistor 11d can thus effectively form a cascode connection with the second transistors 11e without increasing the number of transistors connected in cascade to the first transistor 11d. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd −Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

### Structure of Subpixel Circuit

FIG. 11 is a circuit diagram of an example first subpixel circuit 1 in a second embodiment. Each pixel circuit 10 includes the first subpixel circuit 1 with the same or similar structure. Each of the second subpixel circuit 2 and the third subpixel circuit 3 has the same or similar structure as the first subpixel circuit 1.

The first subpixel circuit 1 in an example of the second embodiment is based on the first subpixel circuit 1 in the first embodiment illustrated in FIG. 4. In the second embodiment, the first subpixel circuit 1 includes parallel-connected two sets of the second transistor 11e and the light emitter 12, instead of a single set of the second transistor 11e and the light emitter 12 connected in series, between the first transistor 11d and the second power potential input section 1s1. The second transistor 11e and the light emitter 12 in each set are connected in series. The two sets of the second transistor 11e and the light emitter 12 include the set of second-A transistor 11ea and first light emitter 12a connected in series and the set of second-B transistor 11eb and second light emitter 12b connected in series. In other words, the first subpixel circuit 1 includes two sets of elements E1 connected in series or in cascade between the first power potential input section 1d1 and the second power potential input section 1s1. The two sets of elements E1 include a first set of elements E1 and a second set of elements E1.

The first set of elements E1 includes the first light emitter 12a as a first element (first-A element) E11a, the first transistor 11d as the second element E12, and the second-A transistor 11ea as a third element (or a third-A element) E13a. In the example in FIG. 11, the first transistor 11d as the second element E12, the second-A transistor 11ea as the third-A element E13a, and the first light emitter 12a as the first-A element E11a are connected in series or in cascade in this order between the first power potential input section 1d1 and the second power potential input section 1s1.

The second set of elements E1 includes the second light emitter 12b as another first element (first-B element) E11b, the first transistor 11d as the second element E12, and the second-B transistor 11eb as another third element (or a third-B element) E13b. In the example in FIG. 11, the first transistor 11d as the second element E12, the second-B transistor 11eb as the third-B element E13b, and the second light emitter 12b as the first-B element E11b are connected in series or in cascade in this order between the first power potential input section 1d1 and the second power potential input section 1s1.

The first transistor 11d, the multiple second transistors 11e, the third transistor 11g, and the capacitor 11c are included in the emission controller 11 to control the light emission of the multiple light emitters 12.

The second-A transistor 11ea can switch the first light emitter 12a between the emissive state and the non-emissive state. In the second embodiment, the second-A transistor 11ea functions as an element (use setting element) for setting the first light emitter 12a selectively to the in-use state or the non-use state, and also functions as an element (emission control element) for controlling the emission or non-emission of the first light emitter 12a. The second-A transistor 11ea is located on the connection line (drive line) connecting the first transistor 11d and the first light emitter 12a. The second-A transistor 11ea is of the same conductivity type as the first transistor 11d. The transistor of the same conductivity type may be a p-channel transistor. In this case, the second-A transistor 11ea is connected in cascade to the first transistor 11d with the drain electrode of the first transistor 11d. More specifically, the first transistor 11d includes the drain electrode connected to the source electrode of the second-A transistor 11ea. The second-A transistor 11ea includes the drain electrode connected to the first light emitter 12a. More specifically, the second-A transistor 11ea includes the drain electrode connected to the positive electrode of the first light emitter 12a. The first light emitter 12a includes the negative electrode connected to the second power potential input section 1s1.

The second-B transistor 11eb can switch the second light emitter 12b between the emissive state and the non-emissive state. In the second embodiment, the second-B transistor 11eb functions as an element (use setting element) for setting the second light emitter 12b selectively to the in-use state or the non-use state, and also functions as an element (emission control element) for controlling the emission or non-emission of the second light emitter 12b. The second-B transistor 11eb is located on the connection line (drive line) connecting the first transistor 11d and the second light emitter 12b. The second-B transistor 11eb is of the same conductivity type as the first transistor 11d. The transistor of the same conductivity type may be a p-channel transistor. In this case, the second-B transistor 11eb is connected in cascade to the first transistor 11d with the drain electrode of the first transistor 11d. More specifically, the first transistor 11d includes the drain electrode connected to the source electrode of the second-B transistor 11eb. The second-B transistor 11eb includes the drain electrode connected to the second light emitter 12b. More specifically, the second-B transistor 11eb includes the drain electrode connected to the positive electrode of the second light emitter 12b. The second light emitter 12b includes the negative electrode connected to the second power potential input section 1s1.

In the first subpixel circuit 1, the first transistor 11d may be connected in cascade to the second-A transistor 11ea and the second-B transistor 11eb as the second transistors 11e and may not be connected in cascade to another element between the first power potential input section 1d1 and the second power potential input section 1s1. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the first light emitter 12a and the second light emitter 12b. This reduces gradations (uneven luminance), or a gradual decrease in the luminance of the display device 100, thus improving the image quality of the display device 100.

### Controller

In the second embodiment, the gate electrode of the second-A transistor 11ea selectively receives the first potential V1 or the second potential V2 from the controller 5. In other words, the controller 5 can selectively output the first potential V1 or the second potential V2 to the gate electrode of the second-A transistor 11ea. The gate electrode of the second-B transistor 11eb selectively receives the first potential V1 or the second potential V2 from the controller 5. In other words, the controller 5 can selectively output the first potential V1 or the second potential V2 to the gate electrode of the second-B transistor 11eb. The controller 5 may be included in each of the first subpixel circuit 1, the second subpixel circuit 2, and the third subpixel circuit 3. This allows each of the first light emitter 12a and the second light emitter 12b to be switched between the emissive state and the non-emissive state for each of the subpixel circuits 1, 2, and 3.

In this case, the controller 5 is connected to the gate electrode of the second-A transistor 11ea through a first potential output signal line L1a. The controller 5 can thus output a first switch control signal CTLA to the gate electrode of the second-A transistor 11ea through the first potential output signal line L1a. The controller 5 is connected to the gate electrode of the second-B transistor 11eb through a second potential output signal line L1b. The controller 5 can thus output a second switch control signal CTLB to the gate electrode of the second-B transistor 11eb through the second potential output signal line L1b.

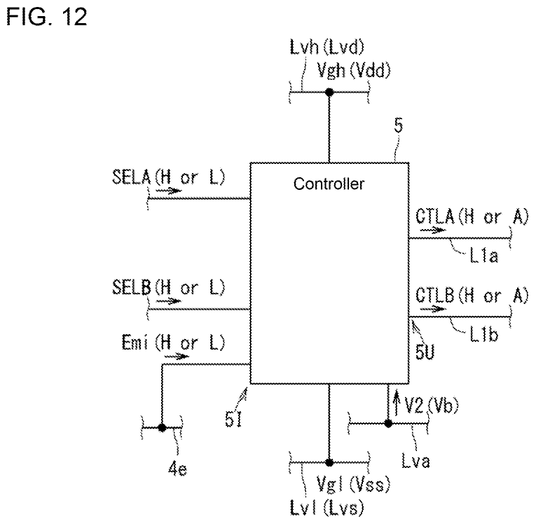

FIG. 12 is a schematic gate circuit diagram of the controller 5, illustrating example input and output gates. In the second embodiment, the controller 5 functions as multiple switches that perform switch control over the second transistor 11e. Switch control includes switching the second transistor 11e selectively between a state in which a current flows between the source electrode and the drain electrode and a state in which no current flows between the source electrode and the drain electrode. The multiple switches can set the light emitter 12 selectively in use (in-use state) or not in use (non-use state) and can set the light emitter 12 selectively to the emissive state or the non-emissive state. For the first light emitter 12a, the multiple switches can set the first light emitter 12a selectively to the in-use state or the non-use state and can set the light emitter 12 selectively to the emissive state or the non-emissive state. For the second light emitter 12b, the multiple switches can set the second light emitter 12b selectively to the in-use state or the non-use state and can set the light emitter 12 selectively to the emissive state or the non-emissive state. In other words, the controller 5 functions as a switch (or a first switch) that can set the first light emitter 12a selectively to the in-use state or the non-use state, and as a switch (or a second switch) that can set the second light emitter 12b selectively to the in-use state or the non-use state. The controller 5 also functions as a switch (or a third switch) that can set each of the first light emitter 12a and the second light emitter 12b selectively to the emissive state or the non-emissive state.

As illustrated in FIG. 12, the signal input section 5I in the controller 5 selectively receives an on-signal or an off-signal for each of the multiple switches to perform switch control over a single second transistor 11e, and receives the second potential V2. In the second embodiment, the signal input section 5I in the controller 5 selectively receives an on-signal or an off-signal for the first switch, selectively receives an on-signal or an off-signal for the second switch, and receives the second potential V2. The signal input section 5I in the controller 5 also selectively receives an on-signal or an off-signal for the third switch.

For the first switch for the first light emitter 12a, the off-signal is a signal to cause the first light emitter 12a to be in the non-use state, and the on-signal is a signal to cause the first light emitter 12a to be in the in-use state. For the second switch for the second light emitter 12b, the off-signal is a signal to cause the second light emitter 12b to be in the non-use state, and the on-signal is a signal to cause the second light emitter 12b to be in the in-use state. For the third switch, the off-signal is a signal to cause the light emitter 12 to be in the non-emissive state, and the on-signal is a signal to cause the light emitter 12 to be in the emissive state. The off-signal is a H signal, and the on-signal is a L signal.

More specifically, the controller 5 receives an on-signal or an off-signal (or a first selection setting signal) SELA for the first switch, an on-signal or an off-signal (or a second selection setting signal) SELB for the second switch, and the emission control signal being an on-signal or an off-signal from the emission control signal line 4e for the third switch. The controller 5 selectively receives a H signal being an off-signal or a L signal being an on-signal as the first selection setting signal SELA. The controller 5 selectively receives a H signal being an off-signal or a L signal being an on-signal as the second selection setting signal SELB. The controller 5 selectively receives, from the emission control signal line 4e, a H signal being an off-signal or a L signal being an on-signal as the emission control signal. The controller 5 receives the second potential V2 from the second potential supply line Lva.

The controller 5 outputs, from the signal output section 5U, the first potential V1 to the gate electrode of the second transistor 11e when the controller 5 receives, at the signal input section 5I, an off-signal for at least one of the multiple switches for a light emitter 12. The controller 5 also outputs, from the signal output section 5U, the second potential V2 to the gate electrode of the second transistor 11e when the controller 5 receives, at the signal input section 5I, an on-signal for each of the multiple switches and the second potential V2 for a light emitter 12.

The controller 5 outputs, from the signal output section 5U, the first potential V1 to the gate electrode of the second-A transistor 11ea when the controller 5 receives, at the signal input section 5I, at least one of an off-signal for the first switch or an off-signal for the third switch. The controller 5 also outputs, from the signal output section 5U, the second potential V2 to the gate electrode of the second-A transistor 11ea when the controller 5 receives, at the signal input section 5I, an on-signal for the first switch, an on-signal for the third switch, and the second potential V2.

In this case, the controller 5 outputs, from the signal output section 5U, a H signal being an off-potential signal with the first potential V1 to the gate electrode of the second-A transistor 11ea through the first potential output signal line L1a when the controller 5 receives, at the signal input section 5I, at least one of a H signal being an off-signal to cause the first light emitter 12a to be in the non-use state or a H signal being an off-signal to cause the light emitter 12 to be in the non-emissive state. More specifically, the controller 5 outputs, from the signal output section 5U, a H signal being an off-potential signal with the first potential V1 as the first switch control signal CTLA to the gate electrode of the second-A transistor 11ea through the first potential output signal line L1a when the controller 5 receives, at the signal input section 5I, at least one of a H signal being an off-signal as the first selection setting signal SELA or a H signal being an off-signal as the emission control signal. The controller 5 also outputs, from the signal output section 5U, an A signal with the second potential V2 to the gate electrode of the second-A transistor 11ea through the first potential output signal line L1a when the controller 5 receives, at the signal input section 5I, a L signal being an on-signal to cause the first light emitter 12a to be in the in-use state, a L signal being an on-signal to cause the light emitter 12 to be in the emissive state, and the second potential V2. More specifically, the controller 5 outputs, from the signal output section 5U, an A signal with the second potential V2 as the first switch control signal CTLA to the gate electrode of the second-A transistor 11ea through the first potential output signal line L1a when the controller 5 receives, at the signal input section 5I, a L signal being an on-signal as the first selection setting signal SELA, a L signal being an on-signal as the emission control signal, and the second potential V2 from the second potential supply line Lva.

The controller 5 can thus selectively output a H signal being an off-potential signal with the first potential V1 or an A signal with the second potential V2 as the first switch control signal CTLA to the gate electrode of the second-A transistor 11ea through the first potential output signal line L1a. The single second-A transistor 11ea can thus easily function as a switch that switches the first light emitter 12a of the redundantly located two light emitters 12 between the in-use state and the non-use state, function as a switch that switches between the emissive state and the non-emissive state, and also function as an analog device that forms a cascode connection with the first transistor 11d.

The controller 5 outputs, from the signal output section 5U, the first potential V1 to the gate electrode of the second-B transistor 11eb when the controller 5 receives, at the signal input section 5I, at least one of an off-signal for the second switch or an off-signal for the third switch. The controller 5 also outputs, from the signal output section 5U, the second potential V2 to the gate electrode of the second-B transistor 11eb when the controller 5 receives, at the signal input section 5I, an on-signal for the second switch, an on-signal for the third switch, and the second potential V2.

In this case, the controller 5 outputs, from the signal output section 5U, a H signal being an off-potential signal with the first potential V1 to the gate electrode of the second-B transistor 11eb through the second potential output signal line L1b when the controller 5 receives, at the signal input section 5I, at least one of a H signal being an off-signal to cause the second light emitter 12b to be in the non-use state or a H signal being an off-signal to cause the light emitter 12 to be in the non-emissive state. More specifically, the controller 5 outputs, from the signal output section 5U, a H signal being an off-potential signal with the first potential V1 as the second switch control signal CTLB to the gate electrode of the second-B transistor 11eb through the second potential output signal line L1b when the controller 5 receives, at the signal input section 5I, at least one of a H signal being an off-signal as the second selection setting signal SELB or a H signal being an off-signal as the emission control signal. The controller 5 also outputs, from the signal output section 5U, an A signal with the second potential V2 to the gate electrode of the second-B transistor 11eb through the second potential output signal line L1b when the controller 5 receives, at the signal input section 5I, a L signal being an on-signal to cause the second light emitter 12b to be in the in-use state, a L signal being an on-signal to cause the light emitter 12 to be in the emissive state, and the second potential V2. More specifically, the controller 5 outputs, from the signal output section 5U, an A signal with the second potential V2 as the second switch control signal CTLB to the gate electrode of the second-B transistor 11eb through the second potential output signal line L1b when the controller 5 receives, at the signal input section 5I, a L signal being an on-signal as the second selection setting signal SELB, a L signal being an on-signal as the emission control signal, and the second potential V2 from the second potential supply line Lva.

The controller 5 can thus selectively output a H signal being an off-potential signal with the first potential V1 or an A signal with the second potential V2 as the second switch control signal CTLB to the gate electrode of the second-B transistor 11eb through the second potential output signal line L1b. The single second-B transistor 11eb can thus easily function as a switch that switches the second light emitter 12b of the redundantly located two light emitters 12 between the in-use state and the non-use state, function as a switch that switches between the emissive state and the non-emissive state, and also function as an analog device that forms a cascode connection with the first transistor 11d.

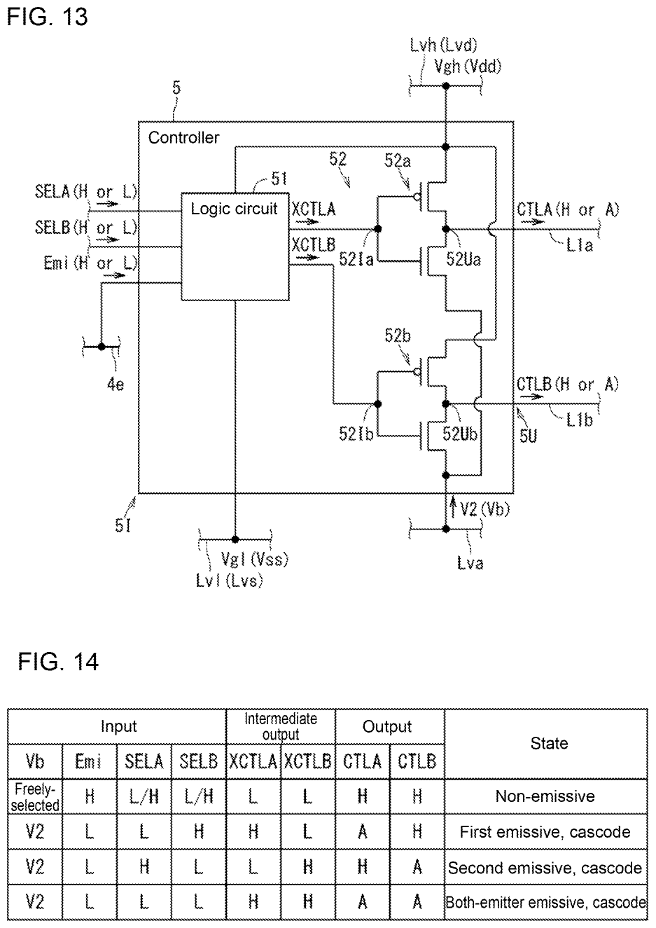

FIG. 13 is a circuit diagram of an example controller 5. The controller 5 in an example of the second embodiment is based on the controller 5 in the first embodiment illustrated in FIG. 6. The controller 5 in the second embodiment corresponds to the controller 5 in the first embodiment but with the logic circuit 51 and the potential converter 52 being changed.

In the second embodiment, the logic circuit 51 can output a first intermediate signal (or a first intermediate output signal) XCTLA and a second intermediate signal (or a second intermediate output signal) XCTLB in response to the first selection setting signal SELA, the second selection setting signal SELB, and the emission control signal. In this case, the logic circuit 51 can output a L signal or a H signal as each of the first intermediate output signal XCTLA and the second intermediate output signal XCTLB based on the combination of L signals (on-potential signals) and H signals (off-potential signals) for the three signals, or specifically the first selection setting signal SELA, the second selection setting signal SELB, and the emission control signal. The controller 5 or the logic circuit 51 may receive the H potential Vgh from the H potential supply line Lvh or the L potential Vgl from the L potential supply line Lvl. The controller 5 or the logic circuit 51 may receive the first power potential Vdd from the first power line Lvd, instead of receiving the H potential Vgh from the H potential supply line Lvh. The controller 5 or the logic circuit 51 may receive the second power potential Vss from the second power line Lvs, instead of receiving the L potential Vgl from the L potential supply line Lvl.

The potential converter 52 includes a first potential converter 52a and a second potential converter 52b.

In response to a L signal as the first intermediate output signal XCTLA input from the logic circuit 51, the first potential converter 52a converts the L signal to a H signal with the first potential V1, and outputs the H signal being an off-potential signal as the first switch control signal CTLA. In response to a H signal as the first intermediate output signal XCTLA input from the logic circuit 51, the first potential converter 52a converts the H signal to an A signal with the second potential V2, and outputs the A signal as the first switch control signal CTLA. The first potential converter 52a is a circuit similar to a CMOS NOT circuit as an inverter logic circuit. The first potential converter 52a includes a p-channel transistor and an n-channel transistor connected in cascade between the H potential supply line Lvh that provides the H potential Vgh and the second potential supply line Lva that provides the second potential V2. More specifically, the p-channel transistor includes the source electrode connected to the H potential supply line Lvh and the drain electrode connected to the drain electrode of the n-channel transistor. The n-channel transistor includes the source electrode connected to the second potential supply line Lva. The first potential converter 52a includes an input section (or a first input section) 52Ia at which the gate electrode of the p-channel transistor is connected to the gate electrode of the n-channel transistor, and an output section (or a first output section) 52Ua at which the drain electrode of the p-channel transistor is connected to the drain electrode of the n-channel transistor. When the first potential converter 52a receives a L signal as the first intermediate output signal XCTLA from the logic circuit 51 at the first input section 52Ia, the first potential converter 52a outputs a H signal being an off-potential signal with the first potential V1 from the first output section 52Ua. When the first potential converter 52a receives a H signal as the first intermediate output signal XCTLA from the logic circuit 51 at the first input section 52Ia, the first potential converter 52a outputs an A signal with the second potential V2 from the first output section 52Ua. The first output section 52Ua in the first potential converter 52a is connected to the first potential output signal line L1a.

The controller 5 can thus output, from the signal output section 5U, the first potential V1 to the gate electrode of the second-A transistor 11ea through the first potential output signal line L1a when the controller 5 receives, at the signal input section 5I, at least one of a H signal being an off-signal as the first selection setting signal SELA or a H signal being an off-signal as the emission control signal. The controller 5 can also output, from the signal output section 5U, the second potential V2 to the gate electrode of the second-A transistor 11ea through the first potential output signal line L1a when the controller 5 receives, at the signal input section 5I, a L signal being an on-signal as the first selection setting signal SELA, a L signal being an on-signal as the emission control signal, and the second potential V2.

The second potential converter 52b has the same or similar structure as the first potential converter 52a. In response to a L signal as the second intermediate output signal XCTLB input from the logic circuit 51, the second potential converter 52b converts the L signal to a H signal with the first potential V1, and outputs the H signal being an off-potential signal as the second switch control signal CTLB. In response to a H signal as the second intermediate output signal XCTLB input from the logic circuit 51, the second potential converter 52b converts the H signal to an A signal with the second potential V2, and outputs the A signal as the second switch control signal CTLB. The second potential converter 52b is a circuit similar to a CMOS NOT circuit as an inverter logic circuit. The second potential converter 52b includes a p-channel transistor and an n-channel transistor connected in cascade between the H potential supply line Lvh that provides the H potential Vgh and the second potential supply line Lva that provides the second potential V2. More specifically, the p-channel transistor includes the source electrode connected to the H potential supply line Lvh and the drain electrode connected to the drain electrode of the n-channel transistor. The n-channel transistor includes the source electrode connected to the second potential supply line L va. The second potential converter 52b includes an input section (or a second input section) 52Ib at which the gate electrode of the p-channel transistor is connected to the gate electrode of the n-channel transistor, and an output section (or a second output section) 52Ub at which the drain electrode of the p-channel transistor is connected to the drain electrode of the n-channel transistor. When the second potential converter 52b receives a L signal as the second intermediate output signal XCTLB from the logic circuit 51 at the second input section 52Ib, the second potential converter 52b outputs a H signal being an off-potential signal with the first potential V1 from the second output section 52Ub. When the second potential converter 52b receives a H signal as the second intermediate output signal XCTLB from the logic circuit 51 at the second input section 52Ib, the second potential converter 52b outputs an A signal with the second potential V2 from the second output section 52Ub. The second output section 52Ub in the second potential converter 52b is connected to the second potential output signal line L1b.

The controller 5 can thus output, from the signal output section 5U, the first potential V1 to the gate electrode of the second-B transistor 11eb through the second potential output signal line L1b when the controller 5 receives, at the signal input section 5I, at least one of a H signal being an off-signal as the second selection setting signal SELB or a H signal being an off-signal as the emission control signal. The controller 5 can also output, from the signal output section 5U, the second potential V2 to the gate electrode of the second-B transistor 11eb through the second potential output signal line L1b when the controller 5 receives, at the signal input section 5I, a L signal being an on-signal as the second selection setting signal SELB, a L signal being an on-signal as the emission control signal, and the second potential V2.

FIG. 14 is a truth table showing an example relationship between the input into the controller 5, the intermediate output signal in the controller 5, the output from the controller 5, and the state of the first subpixel circuit 1. In this case, the controller 5 is designed to satisfy the relationship shown in FIG. 14 between the input potential Vb input from the second potential supply line Lva, the emission control signal input from the emission control signal line 4e, the first selection setting signal SELA being input, the second selection setting signal SELB being input, the first switch control signal CTLA output to the first potential output signal line L1a, and the second switch control signal CTLB output to the second potential output signal line L1b. In this case, the logic circuit 51 is designed to provide various logic outputs to satisfy the relationship shown in FIG. 14 between the emission control signal input from the emission control signal line 4e, the first selection setting signal SELA being input, the second selection setting signal SELB being input, the first intermediate output signal XCTLA output to the first potential converter 52a, and the second intermediate output signal XCTLB output to the second potential converter 52b.

As shown in FIG. 14, when the controller 5 receives a freely-selected potential as the input potential Vb from the second potential supply line Lva and a H signal being an off-signal as the emission control signal, the controller 5 outputs a H signal being an off-potential signal with the first potential V1 as both the first switch control signal CTLA to the first potential output signal line L1a and the second switch control signal CTLB to the second potential output signal line Lib. In response to the H signal being the off-signal as the emission control signal input into the controller 5, the logic circuit 51 outputs a L signal as both the first intermediate output signal XCTLA and the second intermediate output signal XCTLB independently of whether the first selection setting signal SELA and the second selection setting signal SELB are each a L signal being an on-signal or a H signal being an off-signal. The H signal being the off-potential signal with the first potential V1 is input into the gate electrode of each of the second-A transistor 11ea and the second-B transistor 11eb, thus causing these transistors to enter the nonconductive state. This causes both the first light emitter 12a and the second light emitter 12b to enter the non-emissive state.

When the controller 5 receives the second potential V2 as the input potential Vb from the second potential supply line Lva, a L signal being an on-signal as the emission control signal, a L signal being an on-signal as the first selection setting signal SELA, and a H signal being an off-signal as the second selection setting signal SELB, the controller 5 outputs an A signal with the second potential V2 as the first switch control signal CTLA to the first potential output signal line L1a, and a H signal being an off-potential signal with the first potential V1 as the second switch control signal CTLB to the second potential output signal line L1b. In response to the L signal being the on-signal as the emission control signal, the L signal being the on-signal as the first selection setting signal SELA, and the H signal being the off-signal as the second selection setting signal SELB input into the controller 5, the logic circuit 51 outputs a H signal as the first intermediate output signal XCTLA and a L signal as the second intermediate output signal XCTLB. The A signal with the second potential V2 is input into the gate electrode of the second-A transistor 11ea, thus causing the first light emitter 12a to enter the emissive state (or a first emissive state). In this state, the second-A transistor 11ea forms a cascode connection with the first transistor 11d. The H signal being the off-potential signal with the first potential V1 is input into the gate electrode of the second-B transistor 11eb, thus causing the second light emitter 12b to enter the non-emissive state (or a second non-emissive state).

When the controller 5 receives the second potential V2 as the input potential Vb from the second potential supply line Lva, a L signal being an on-signal as the emission control signal, a H signal being an off-signal as the first selection setting signal SELA, and a L signal being an on-signal as the second selection setting signal SELB, the controller 5 outputs a H signal being an off-potential signal with the first potential V1 as the first switch control signal CTLA to the first potential output signal line L1a and an A signal with the second potential V2 as the second switch control signal CTLB to the second potential output signal line L1b. In response to the L signal being the on-signal as the emission control signal, the H signal being the off-signal as the first selection setting signal SELA, and the L signal being the on-signal as the second selection setting signal SELB input into the controller 5, the logic circuit 51 outputs a L signal as the first intermediate output signal XCTLA and a H signal as the second intermediate output signal XCTLB. The H signal being the off-potential signal with the first potential V1 is input into the gate electrode of the second-A transistor 11ea, thus causing the first light emitter 12a to enter the non-emissive state (or a first non-emissive state). The A signal with the second potential V2 is input into the gate electrode of the second-B transistor 11eb, thus causing the second light emitter 12b to enter the emissive state (or a second emissive state). In this state, the second-B transistor 11eb forms a cascode connection with the first transistor 11d.

When the controller 5 receives the second potential V2 as the input potential Vb from the second potential supply line Lva, a L signal being an on-signal as the emission control signal, a L signal being an on-signal as the first selection setting signal SELA, and a L signal being an on-signal as the second selection setting signal SELB, the controller 5 outputs an A signal with the second potential V2 as the first switch control signal CTLA to the first potential output signal line L1a, and an A signal with the second potential V2 as the second switch control signal CTLB to the second potential output signal line L1b. In response to the L signal being the on-signal as the emission control signal, the L signal being the on-signal as the first selection setting signal SELA, and the L signal being the on-signal as the second selection setting signal SELB input into the controller 5, the logic circuit 51 outputs a H signal as both the first intermediate output signal XCTLA and the second intermediate output signal XCTLB. The A signal with the second potential V2 is input into the gate electrode of each of the second-A transistor 11ea and the second-B transistor 11eb, thus causing both the first light emitter 12a and the second light emitter 12b to enter the emissive state (or a both-emitter emissive state). In this state, the second-A transistor 11ea and the second-B transistor 11eb both form a cascode connection with the first transistor 11d.

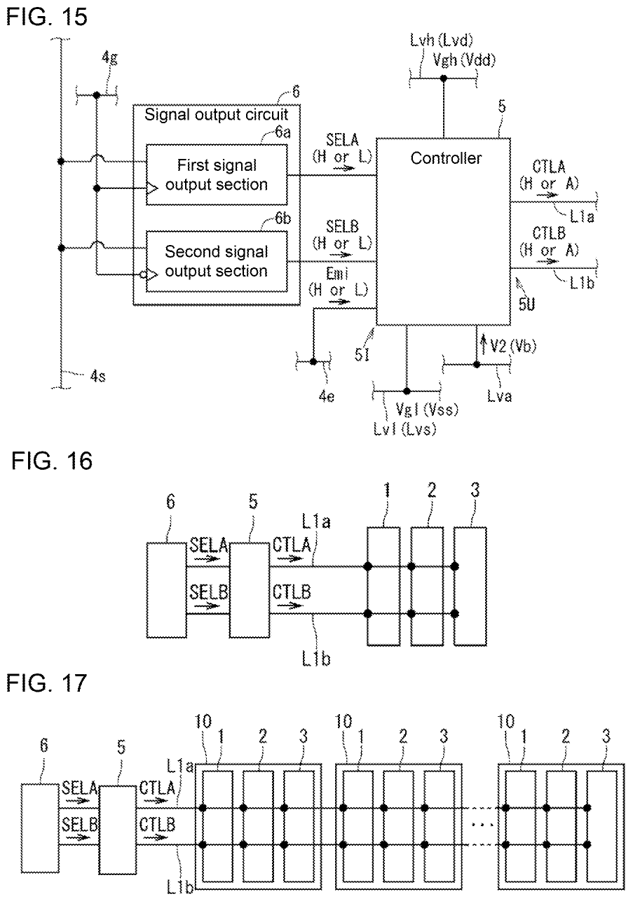

FIG. 15 is a block circuit diagram of an example signal output circuit 6 that outputs the first selection setting signal SELA and the second selection setting signal SELB to the controller 5. As illustrated in FIG. 15, the signal output circuit 6 includes a first signal output section 6a and a second signal output section 6b. The first signal output section 6a can output the first selection setting signal SELA The second signal output section 6b can output the second selection setting signal SELB. More specifically, the first signal output section 6a can selectively output a H signal being an off-signal or a L signal being an on-signal as the first selection setting signal SELA to the controller 5. The second signal output section 6b can selectively output a H signal being an off-signal or a L signal being an on-signal as the second selection setting signal SELB to the controller 5. The first signal output section 6a may be a flip-flop circuit that can selectively switch the first selection setting signal SELA to a L signal or a H signal and retain the status of the resulting signal, or may be a circuit (or a storage circuit) that stores data, such as a latch circuit. The second signal output section 6b may be a flip-flop circuit that can selectively switch the second selection setting signal SELB to a L signal or a H signal and retain the status of the resulting signal, or may be a circuit (storage circuit) that stores data, such as a latch circuit.

The storage circuit as the first signal output section 6a is set to continue outputting either a L signal or a H signal as the first selection setting signal SELA once receiving an input (writing) of a signal (or a first setting signal) as data for setting the status of the signal. The storage circuit as the second signal output section 6b is set to continue outputting either a L signal or a H signal as the second selection setting signal SELB once receiving an input (writing) of a signal (or a second setting signal) as data for setting the status of the signal. The image signal line 4s may be used as a signal line (or a first write signal line) for inputting (writing) the first setting signal into the first signal output section 6a, and as a signal line (or a second write signal line) for inputting (writing) the second setting signal into the second signal output section 6b. The scanning signal line 4g may be used as a signal line (or a first specific signal line) for inputting a signal (or a first specific signal) specifying the timing at which the setting signal is input (written) into the first signal output section 6a. The scanning signal line 4g may also be used as a signal line (or a second specific signal line) for inputting a signal (or a second specific signal) specifying the timing at which the setting signal is input (written) into the second signal output section 6b.

As illustrated in FIG. 15, one image signal line 4s may be connected to the first signal output section 6a and the second signal output section 6b. One scanning signal line 4g may be connected to the first signal output section 6a and to the second signal output section 6b through a NOT circuit. This structure allows one single scanning signal line 4g to specify, in time sequence, the first timing at which the setting signal is input (written) from the image signal line 4s into the storage circuit as the first signal output section 6a and the second timing at which the setting signal is input (written) from the image signal line 4s into the storage circuit as the second signal output section 6b. A L signal as the first specific signal from the scanning signal line 4g is input into the storage circuit as the first signal output section 6a. The L signal as the first specific signal from the scanning signal line 4g is converted to a H signal as a second unspecific signal using the NOT circuit. The resulting H signal is input into the storage circuit as the second signal output section 6b. This may allow the first setting signal to be input (written) from the image signal line 4s into the storage circuit as the first signal output section 6a. A H signal as a signal (or a first unspecific signal) from the scanning signal line 4g is input into the storage circuit as the first signal output section 6a. The H signal as the first unspecific signal from the scanning signal line 4g is converted to a L signal as the second specific signal using the NOT circuit. The resulting L signal is input into the storage circuit as the second signal output section 6b. This may allow the second setting signal to be input (written) from the image signal line 4s into the storage circuit as the second signal output section 6b. The storage circuit as the first signal output section 6a receives an input (writing) of a L signal or a H signal as the first setting signal from the image signal line 4s upon receiving the first specific signal from the scanning signal line 4g. The storage circuit as the second signal output section 6b receives an input (writing) of a L signal or a H signal as the second setting signal from the image signal line 4s upon receiving the second specific signal from the scanning signal line 4g.

### Variations of Second Embodiment

Each pixel circuit 10 may include a single controller 5 and a single signal output circuit 6 for a set of the first subpixel circuit 1, the second subpixel circuit 2, and the third subpixel circuit 3. In other words, each pixel circuit 10 may include the controller 5 to selectively output the first potential V1 or the second potential V2 to each of the first subpixel circuit 1, the second subpixel circuit 2, and the third subpixel circuit 3. FIG. 16 is a block circuit diagram of the controller 5 connected to the signal output circuit 6 and to the subpixel circuits 1, 2, and 3 in an example manner. As illustrated in FIG. 16, each of the first potential output signal line L1a and the second potential output signal line L1b connected to the controller 5 may be connected to the subpixel circuits 1, 2, and 3. This structure includes fewer controllers 5 for each pixel circuit 10, avoiding size increase of the pixel circuit 10. The display device 100 and the display panel 100p can thus include multiple pixel circuits 10 arranged with narrower pitches to improve resolution. The display device 100 can thus have higher image quality.

The display panel 100p may include a single controller 5 and a single signal output circuit 6 for multiple pixel circuits 10. In other words, the display panel 100p may include the controller 5 for each set of multiple pixel circuits 10 to selectively output the first potential V1 or the second potential V2. In this case, the controller 5 and the signal output circuit 6 may be located in an open area in the image display 300 or the frame portion on the first surface F1 of the substrate 20, or may be located on the second surface F2 of the substrate 20. In this case, the controller 5 can selectively output the first potential V1 or the second potential V2 to the gate electrode of the second transistor 11e in each pixel circuit 10. More specifically, the controller 5 can selectively output the first potential V1 or the second potential V2 to the gate electrode of the second-A transistor 11ea in each pixel circuit 10. The controller 5 can selectively output the first potential V1 or the second potential V2 to the gate electrode of the second-B transistor 11eb in each pixel circuit 10.

The controller 5 and the signal output circuit 6 may be located for a set of pixel circuits 10 in each row. FIG. 17 is a block circuit diagram of the controller 5 connected to the signal output circuit 6 and to multiple pixel circuits 10 in an example manner. As illustrated in FIG. 17, each of the first potential output signal line L1a and the second potential output signal line L1b connected to the controller 5 may be connected to multiple pixel circuits 10. More specifically, the first potential output signal line L1a and the second potential output signal line L1b connected to the controller 5 may each be connected to the subpixel circuits 1, 2, and 3 in each pixel circuit 10. This structure includes a single controller 5 and a single signal output circuit 6 for each set of multiple pixel circuits 10, avoiding size increase of the pixel circuits 10. The display device 100 and the display panel 100p can thus include multiple pixel circuits 10 arranged with narrower pitches to improve resolution. The display device 100 can thus have higher image quality.

The controller 5 outputs, from the signal output section 5U, the first potential V1 to the gate electrode of the second transistor 11e in each pixel circuit 10 when the controller 5 receives, at the signal input section 5I, an off-signal for at least one of the multiple switches for a light emitter 12. The controller 5 also outputs, from the signal output section 5U, the second potential V2 to the gate electrode of the second transistor 11e in each pixel circuit 10 when the controller 5 receives, at the signal input section 5I, an on-signal for each of the multiple switches and the second potential V2 for the light emitter 12.

In this case, the controller 5 outputs, from the signal output section 5U, the first potential V1 to the gate electrode of the second-A transistor 11ea in each pixel circuit 10 when the controller 5 receives, at the signal input section 5I, at least one of an off-signal for the first switch or an off-signal for the third switch. More specifically, the controller 5 outputs, from the signal output section 5U, a H signal being an off-potential signal with the first potential V1 to the gate electrode of the second-A transistor 11ea in each pixel circuit 10 through the first potential output signal line L1a when the controller 5 receives, at the signal input section 5I, at least one of a H signal being an off-signal to cause the first light emitter 12a to be in the non-use state or a H signal being an off-signal to cause the light emitter 12 to be in the non-emissive state. The controller 5 also outputs, from the signal output section 5U, the second potential V2 to the gate electrode of the second-A transistor 11ea in each pixel circuit 10 when the controller 5 receives, at the signal input section 5I, an on-signal for the first switch, an on-signal for the third switch, and the second potential V2. More specifically, the controller 5 outputs, from the signal output section 5U, an A signal with the second potential V2 to the gate electrode of the second-A transistor 11ea in each of the subpixel circuits 1, 2, and 3 in each pixel circuit 10 through the first potential output signal line L1a when the controller 5 receives, at the signal input section 5I, a L signal being an on-signal to cause the first light emitter 12a to be in the in-use state, a L signal being an on-signal to cause the first light emitter 12a to be in the emissive state, and the second potential V2. In other words, the controller 5 can selectively output a H signal being an off-potential signal with the first potential V1 or an A signal with the second potential V2 as the first switch control signal CTLA to the gate electrode of the second-A transistor 11ea in each pixel circuit 10 through the first potential output signal line L1a. More specifically, the controller 5 can selectively output a H signal being an off-potential signal with the first potential V1 or an A signal with the second potential V2 as the first switch control signal CTLA to the gate electrode of the second-A transistor 11ea in each of the subpixel circuits 1, 2, and 3 in each pixel circuit 10 through the first potential output signal line L1a.

The controller 5 outputs, from the signal output section 5U, the first potential V1 to the gate electrode of the second-B transistor 11eb in each pixel circuit 10 when the controller 5 receives, at the signal input section 5I, at least one of an off-signal for the second switch or an off-signal for the third switch. More specifically, the controller 5 outputs, from the signal output section 5U, a H signal being an off-potential signal with the first potential V1 to the gate electrode of the second-B transistor 11eb in each pixel circuit 10 through the second potential output signal line L1b when the controller 5 receives, at the signal input section 5I, at least one of a H signal being an off-signal to cause the second light emitter 12b to be in the non-use state or a H signal being an off-signal to cause the light emitter 12 to be in the non-emissive state. The controller 5 also outputs, from the signal output section 5U, the second potential V2 to the gate electrode of the second-B transistor 11eb in each pixel circuit 10 when the controller 5 receives, at the signal input section 5I, an on-signal for the second switch, an on-signal for the third switch, and the second potential V2. More specifically, the controller 5 outputs, from the signal output section 5U, an A signal with the second potential V2 to the gate electrode of the second-B transistor 11eb in each of the subpixel circuits 1, 2, and 3 in each pixel circuit 10 through the second potential output signal line L1b when the controller 5 receives, at the signal input section 5I, a L signal being an on-signal to cause the second light emitter 12b to be in the in-use state, a L signal being an on-signal to cause the second light emitter 12b to be in the emissive state, and the second potential V2. In other words, the controller 5 can selectively output a H signal being an off-potential signal with the first potential V1 or an A signal with the second potential V2 as the second switch control signal CTLB to the gate electrode of the second-B transistor 11eb in each pixel circuit 10 through the second potential output signal line L1b. More specifically, the controller 5 can selectively output a H signal being an off-potential signal with the first potential V1 or an A signal with the second potential V2 as the second switch control signal CTLB to the gate electrode of the second-B transistor 11eb in each of the subpixel circuits 1, 2, and 3 in each pixel circuit 10 through the second potential output signal line L1b.

### 2-2. Third Embodiment

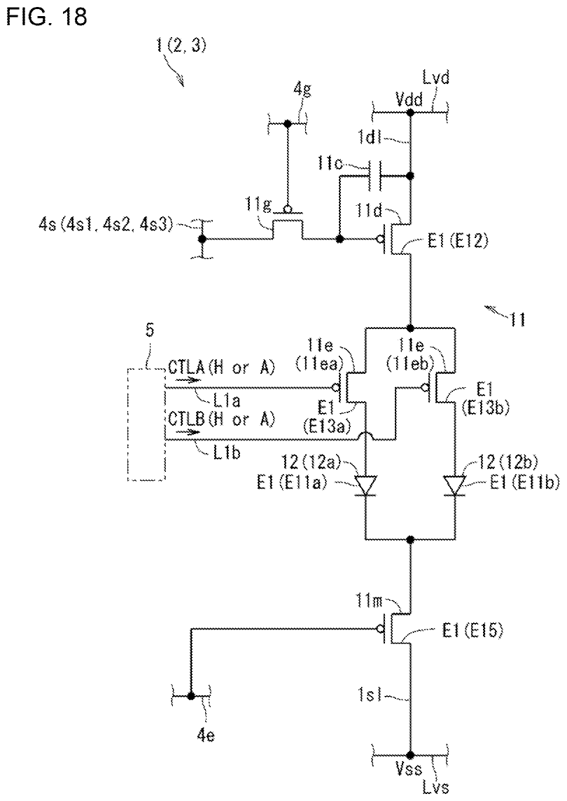

In the second embodiment, as illustrated in FIG. 18, the structure may include a fifth transistor 11m as a fifth element E15 to allow the second-A transistor 11ea as the third-A element E13a and the second-B transistor 11eb as the third-B element E13b to each function as an emission control element.

In this case as well, the first subpixel circuit 1 includes multiple light emitters 12 and multiple second transistors 11e. The multiple light emitters 12 include a first light emitter 12a and a second light emitter 12b connected in parallel. The multiple second transistors 11e include a second-A transistor 11ea being a second transistor 11e connected in series to the first light emitter 12a and a second-B transistor 11eb being a second transistor 11e connected in series to the second light emitter 12b. Each of the second-A transistor 11ea and the second-B transistor 11eb includes the gate electrode to selectively receive the first potential V1 or the second potential V2.

In this structure as well, each second transistor 11e functions as an analog device that forms a cascode connection with the first transistor 11d, as well as a switch that switches the redundantly located light emitters 12 between the emissive state and the non-emissive state. The first transistor 11d can thus effectively form a cascode connection with the second transistors 11e without increasing the number of transistors connected in cascade to the first transistor 11d. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd −Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

### Structure of Subpixel Circuit

FIG. 18 is a circuit diagram of an example first subpixel circuit 1 in a third embodiment. Each pixel circuit 10 includes the first subpixel circuit 1 with the same or similar structure. Each of the second subpixel circuit 2 and the third subpixel circuit 3 has the same or similar structure as the first subpixel circuit 1.

The first subpixel circuit 1 in the third embodiment is altered from the first subpixel circuit 1 in the second embodiment illustrated in FIG. 11, with the fifth transistor 11m as the fifth element E15 being added. The fifth transistor 11m is included in the emission controller 11. The first subpixel circuit 1 includes the first set of elements E1 connected in series or in cascade and the second set of elements E1 connected in series or in cascade between the first power potential input section 1d1 and the second power potential input section 1s1.

The first set of elements E1 includes the first light emitter 12a as the first-A element E11a, the first transistor 11d as the second element E12, the second-A transistor 11ea as the third-A element E13a, and the fifth transistor 11m as the fifth element E15. In the example in FIG. 18, the first transistor 11d as the second element E12, the second-A transistor 11ea as the third-A element E13a, the first light emitter 12a as the first-A element Ela, and the fifth transistor 11m as the fifth element E15 are connected in series or in cascade in this order.

The second set of elements E1 includes the second light emitter 12b as the first-B element E11b, the first transistor 11d as the second element E12, the second-B transistor 11eb as the third-B element E13b, and the fifth transistor 11m as the fifth element E15. In the example in FIG. 18, the first transistor 11d as the second element E12, the second-B transistor 11eb as the third-B element E13b, the second light emitter 12b as the first-B element E11b, and the fifth transistor 11m as the fifth element E15 are connected in series or in cascade in this order.

The first transistor 11d, the multiple second transistors 11e, the third transistor 11g, the capacitor 11c, and the fifth transistor 11m are included in the emission controller 11 to control the light emission of the multiple light emitters 12.

In the third embodiment, the second-A transistor 11ea functions as an element (use setting element) for setting the first light emitter 12a selectively to the in-use state or the non-use state, and does not function as an element (emission control element) for controlling the emission or non-emission of the first light emitter 12a. The second-B transistor 11eb functions as an element (use setting element) for setting the second light emitter 12b selectively to the in-use state or the non-use state, and does not function as an element (emission control element) for controlling the emission or non-emission of the second light emitter 12b.

The fifth transistor 11m can switch the first light emitter 12a and the second light emitter 12b between the emissive state and the non-emissive state. The fifth transistor 11m functions as an element (emission control element) for controlling the emission or non-emission of the first light emitter 12a and the second light emitter 12b. The fifth transistor 11m is between the first light emitter 12a and the second power potential input section 1s1. The fifth transistor 11m is between the second light emitter 12b and the second power potential input section 1s1. The fifth transistor 11m is a p-channel transistor. In this case, the fifth transistor 11m includes the source electrode connected to the negative electrode of the first light emitter 12a and to the negative electrode of the second light emitter 12b. The fifth transistor 11m includes the drain electrode connected to the second power potential input section 1s1. The fifth transistor 11m includes the gate electrode to receive the emission control signal from the emission control signal line 4e. In response to a L signal being an on-signal as the emission control signal received at the gate electrode, the fifth transistor 11m enters the conductive state in which a current flows between the source electrode and the drain electrode. In response to a H signal being an off-signal as the emission control signal received at the gate electrode, the fifth transistor 11m enters the nonconductive state in which no current flows between the source electrode and the drain electrode.

### Controller

In the third embodiment, the controller 5 can selectively output the first potential V1 or the second potential V2 to the gate electrode of the second-A transistor 11ea, in the same or similar manner as in the second embodiment. The controller 5 can selectively output the first potential V1 or the second potential V2 to the gate electrode of the second-B transistor 11eb. The controller 5 may be included in each of the first subpixel circuit 1, the second subpixel circuit 2, and the third subpixel circuit 3. This allows each of the first light emitter 12a and the second light emitter 12b to be switched between the in-use state and the non-use state for each of the subpixel circuits 1, 2, and 3. The controller 5 is connected to the gate electrode of the second-A transistor 11ea through the first potential output signal line L1a, in the same or similar manner as in the second embodiment. The controller 5 can thus output the first switch control signal CTLA to the gate electrode of the second-A transistor 11ea through the first potential output signal line L1a. The controller 5 is connected to the gate electrode of the second-B transistor 11eb through the second potential output signal line L1b. The controller 5 can thus output the second switch control signal CTLB to the gate electrode of the second-B transistor 11eb through the second potential output signal line L1b.

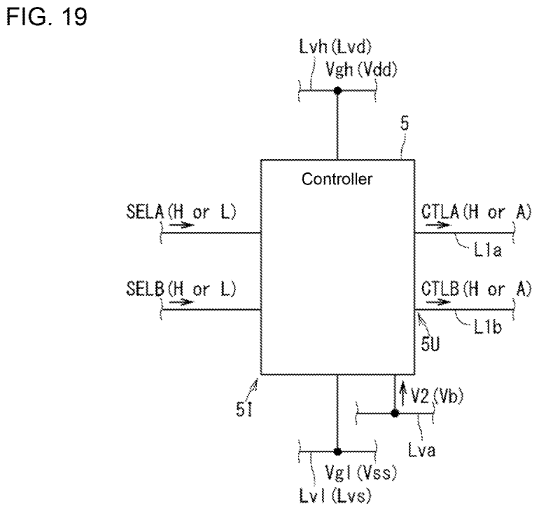

FIG. 19 is a schematic diagram of the controller 5, illustrating example input and output. The controller 5 functions as a switch that performs switch control over the second transistor 11e. Switch control includes switching the second transistor 11e selectively between a state in which a current flows between the source electrode and the drain electrode and a state in which no current flows between the source electrode and the drain electrode. The switch can set the light emitter 12 selectively in use (in-use state) or not in use (non-use state). For the first light emitter 12a, the switch can set the first light emitter 12a selectively to the in-use state or the non-use state. For the second light emitter 12b, the switch can set the second light emitter 12b selectively to the in-use state or the non-use state. In other words, the controller 5 functions as a switch (first switch) that sets the first light emitter 12a selectively to the in-use state or the non-use state, and as a switch (second switch) that sets the second light emitter 12b selectively to the in-use state or the non-use state.

As illustrated in FIG. 19, the signal input section 5I in the controller 5 selectively receives an on-signal or an off-signal for the first switch, selectively receives an on-signal or an off-signal for the second switch, and receives the second potential V2. For the first switch for the first light emitter 12a, the off-signal is a signal to cause the first light emitter 12a to be in the non-use state, and the on-signal is a signal to cause the first light emitter 12a to be in the in-use state. For the second switch, the off-signal is a signal to cause the second light emitter 12b to be in the non-use state, and the on-signal is a signal to cause the second light emitter 12b to be in the in-use state. The off-signal is a H signal, and the on-signal is a L signal.

More specifically, the controller 5 receives an on-signal or an off-signal (first selection setting signal) SELA for the first switch, and an on-signal or an off-signal (second selection setting signal) SELB for the second switch. The controller 5 selectively receives a H signal being an off-signal or a L signal being an on-signal as the first selection setting signal SELA. The controller 5 selectively receives a H signal being an off-signal or a L signal being an on-signal as the second selection setting signal SELB. The controller 5 receives the second potential V2 from the second potential supply line Lva.

The controller 5 outputs, from the signal output section 5U, the first potential V1 to the gate electrode of the second-A transistor 11ea when the controller 5 receives, at the signal input section 5I, an off-signal for the first switch. In this case, the controller 5 outputs, from the signal output section 5U, a H signal being an off-potential signal with the first potential V1 as the first switch control signal CTLA to the gate electrode of the second-A transistor 11ea through the first potential output signal line L1a when the controller 5 receives, at the signal input section 5I, a H signal being an off-signal to cause the first light emitter 12a to be in the non-use state. The controller 5 also outputs, from the signal output section 5U, the second potential V2 to the gate electrode of the second-A transistor 11ea when the controller 5 receives, at the signal input section 5I, an on-signal for the first switch and the second potential V2. In this case, the controller 5 outputs, from the signal output section 5U, an A signal with the second potential V2 as the first switch control signal CTLA to the gate electrode of the second-A transistor 11ea through the first potential output signal line L1a when the controller 5 receives, at the signal input section 5I, a L signal being an on-signal to cause the first light emitter 12a to be in the in-use state and the second potential V2. The controller 5 can thus selectively output a H signal being an off-potential signal with the first potential V1 or an A signal with the second potential V2 as the first switch control signal CTLA to the gate electrode of the second-A transistor 11ea through the first potential output signal line L1a. The single second-A transistor 11ea can thus easily function as a switch that switches the first light emitter 12a of the redundantly located two light emitters 12 between the in-use state and the non-use state and also function as an analog device that forms a cascode connection with the first transistor 11d.

The controller 5 outputs, from the signal output section 5U, the first potential V1 to the gate electrode of the second-B transistor 11eb when the controller 5 receives, at the signal input section 5I, an off-signal for the second switch. In this case, the controller 5 outputs, from the signal output section 5U, a H signal being an off-potential signal with the first potential V1 as the second switch control signal CTLB to the gate electrode of the second-B transistor 11eb through the second potential output signal line L1b when the controller 5 receives, at the signal input section 5I, a H signal being an off-signal to cause the second light emitter 12b to be in the non-use state. The controller 5 also outputs, from the signal output section 5U, the second potential V2 to the gate electrode of the second-B transistor 11eb when the controller 5 receives, at the signal input section 5I, an on-signal for the second switch and the second potential V2. In this case, the controller 5 outputs, from the signal output section 5U, an A signal with the second potential V2 as the second switch control signal CTLB to the gate electrode of the second-B transistor 11eb through the second potential output signal line L1b when the controller 5 receives, at the signal input section 5I, a L signal being an on-signal to cause the second light emitter 12b to be in the in-use state and the second potential V2. The controller 5 can thus selectively output a H signal being an off-potential signal with the first potential V1 or an A signal with the second potential V2 as the second switch control signal CTLB to the gate electrode of the second-B transistor 11eb through the second potential output signal line L1b. The single second-B transistor 11eb can thus easily function as a switch that switches the second light emitter 12b of the redundantly located two light emitters 12 between the in-use state and the non-use state and also function as an analog device that forms a cascode connection with the first transistor 11d.

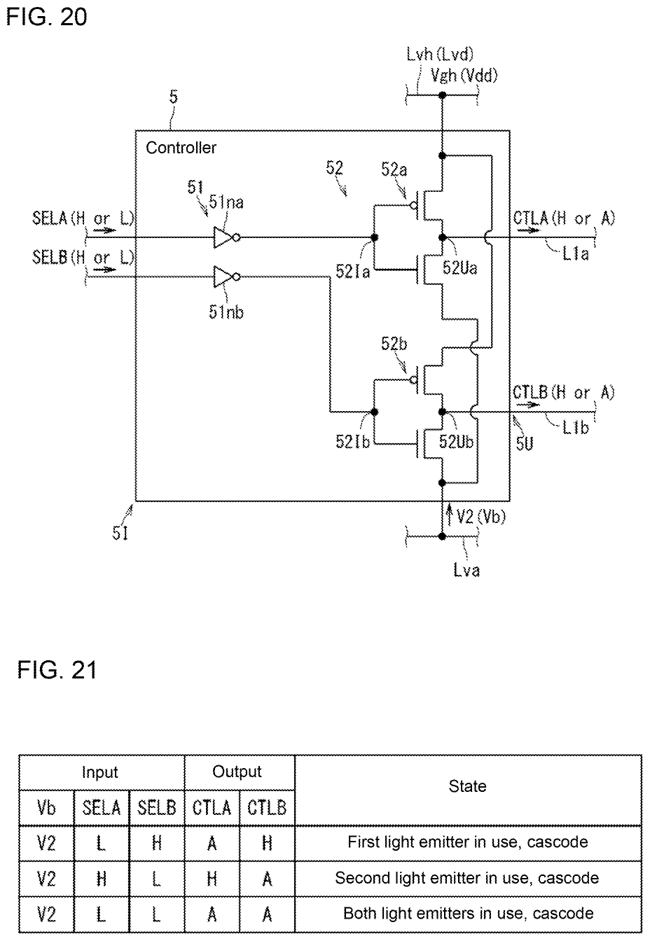

FIG. 20 is a circuit diagram of an example controller 5. The controller 5 in an example of the third embodiment is based on the controller 5 in the second embodiment illustrated in FIG. 13. The controller 5 in the third embodiment corresponds to the controller 5 in the second embodiment but with the logic circuit 51 being changed.

The logic circuit 51 converts the first switch control signal SELA as appropriate and outputs the resultant signal to the first potential converter 52a, and converts the second switch control signal SELB as appropriate and outputs the resultant signal to the second potential converter 52b. In the example in FIG. 20, the logic circuit 51 includes a first NOT gate 51na and a second NOT gate 51nb. The first NOT gate 51na converts a H signal as the first switch control signal SELA to a L signal and outputs the L signal to the first potential converter 52a. The first NOT gate 51na converts a L signal as the first switch control signal SELA to a H signal and outputs the H signal to the first potential converter 52a. The second NOT gate 51nb converts a H signal as the second switch control signal SELB to a L signal and outputs the L signal to the second potential converter 52b. The second NOT gate 51nb converts a L signal as the second switch control signal SELB to a H signal and outputs the H signal to the second potential converter 52b.

In response to a L signal input from the logic circuit 51, the first potential converter 52a converts the L signal to a H signal with the first potential V1, and outputs the H signal being an off-potential signal as the first switch control signal CTLA. In response to a H signal input from the logic circuit 51, the first potential converter 52a converts the H signal to an A signal with the second potential V2, and outputs the A signal as the first switch control signal CTLA. The first potential converter 52a has the same or similar structure as the first potential converter 52a in the second embodiment. The controller 5 can thus output, from the signal output section 5U, the first potential V1 to the gate electrode of the second-A transistor 11ea through the first potential output signal line L1a when the controller 5 receives, at the signal input section 5I, an off-signal as the first selection setting signal SELA The controller 5 can also output, from the signal output section 5U, the second potential V2 to the gate electrode of the second-A transistor 11ea through the first potential output signal line L1a when the controller 5 receives, at the signal input section 5I, a L signal being an on-signal as the first selection setting signal SELA and the second potential V2.

In response to a L signal input from the logic circuit 51, the second potential converter 52b converts the L signal to a H signal with the first potential V1, and outputs the H signal being an off-potential signal as the second switch control signal CTLB. In response to a H signal input from the logic circuit 51, the second potential converter 52b converts the H signal to an A signal with the second potential V2, and outputs the A signal as the second switch control signal CTLB. The second potential converter 52b has the same or similar structure as the second potential converter 52b in the second embodiment. The controller 5 can thus output, from the signal output section 5U, the first potential V1 to the gate electrode of the second-B transistor 11eb through the second potential output signal line L1b when the controller 5 receives, at the signal input section 5I, an off-signal as the second selection setting signal SELB. The controller 5 can also output, from the signal output section 5U, the second potential V2 to the gate electrode of the second-B transistor 11eb through the second potential output signal line L1b when the controller 5 receives, at the signal input section 5I, a L signal being an on-signal as the second selection setting signal SELB and the second potential V2.

FIG. 21 is a truth table showing an example relationship between the input into the controller 5, the output from the controller 5, and the state of the first subpixel circuit 1. In this case, the controller 5 is designed to satisfy, the relationship shown in FIG. 21 between the input potential Vb input from the second potential supply line Lva, the first selection setting signal SELA being input, the second selection setting signal SELB being input, the first switch control signal CTLA output to the first potential output signal line L1a, and the second switch control signal CTLB output to the second potential output signal line L1b.

When the input potential Vb is the second potential V2, the first selection setting signal SELA is a L signal being an on-signal, and the second selection setting signal SELB is a H signal being an off-signal, the first switch control signal CTLA is an A signal with the second potential V2, and the second switch control signal CTLB is a H signal being an off-potential signal with the first potential V1. In this case, the first light emitter 12a is set to the in-use state, and the second-A transistor 11ea forms a cascode connection with the first transistor 11d. The second-B transistor 11eb enters the nonconductive state, and the second light emitter 12b is set to the non-use state.

When the input potential Vb is the second potential V2, the first selection setting signal SELA is a H signal being an off-signal, and the second selection setting signal SELB is a L signal being an on-signal, the first switch control signal CTLA is a H signal being an off-potential signal with the first potential V1, and the second switch control signal CTLB is an A signal with the second potential V2. In this case, the second-A transistor 11ea enters the nonconductive state, and the first light emitter 12a is set to the non-use state. The second light emitter 12b is set to the in-use state, and the second-B transistor 11eb forms a cascode connection with the first transistor 11d.

When the input potential Vb is the second potential V2 and each of the first selection setting signal SELA and the second selection setting signal SELB is a L signal being an on-signal, each of the first switch control signal CTLA and the second switch control signal CTLB is an A signal with the second potential V2. In this case, the first light emitter 12a and the second light emitter 12b are both set to the in-use state, and the second-A transistor 11ea and the second-B transistor 11eb each form a cascode connection with the first transistor 11d.

In the third embodiment, the signal output circuit 6 that outputs the first selection setting signal SELA and the second selection setting signal SELB to the controller 5 has the same or similar structure as the signal output circuit 6 in the second embodiment.

The off-signal may be a L signal and the on-signal may be a H signal as the first switch control signal SELA and the second switch control signal SELB. In this case, the controller 5 may eliminate the logic circuit 51 and may receive the first switch control signal SELA directly at the first input section 52Ia in the first potential converter 52a or receive the second switch control signal SELB directly at the second input section 52Ib in the second potential converter 52b. The controller 5 can thus output, from the signal output section 5U, the first potential V1 to the gate electrode of the second-A transistor 11ea through the first potential output signal line L1a when the controller 5 receives, at the signal input section 5I, a L signal being an off-signal as the first switch control signal SELA. This sets the first light emitter 12a to the non-use state. The controller 5 can also output, from the signal output section 5U, the second potential V2 to the gate electrode of the second-A transistor 11ea through the first potential output signal line L1a when the controller 5 receives, at the signal input section 5I, a H signal being an on-signal as the first switch control signal SELA and the second potential V2. This sets the first light emitter 12a to the in-use state. The controller 5 can also output, from the signal output section 5U, the first potential V1 to the gate electrode of the second-B transistor 11eb through the second potential output signal line L1b when the controller 5 receives, at the signal input section 5I, a L signal being an off-signal as the second switch control signal SELB. This sets the second light emitter 12b to the non-use state. The controller 5 can also output, from the signal output section 5U, the second potential V2 to the gate electrode of the second-B transistor 11eb through the second potential output signal line L1b when the controller 5 receives, at the signal input section 5I, a H signal being an on-signal as the second switch control signal SELB and the second potential V2. This sets the second light emitter 12b to the in-use state.

### Variations of Third Embodiment

Each pixel circuit 10 may include a single controller 5 and a single signal output circuit 6 for a set of the first subpixel circuit 1, the second subpixel circuit 2, and the third subpixel circuit 3, in the same or similar manner as in the second embodiment. In other words, each pixel circuit 10 may include the controller 5 to selectively output the first potential V1 or the second potential V2 to each of the first subpixel circuit 1, the second subpixel circuit 2, and the third subpixel circuit 3. In this case, as illustrated in FIG. 16, each of the first potential output signal line L1a and the second potential output signal line L1b connected to the controller 5 may be connected to the subpixel circuits 1, 2, and 3. This structure includes fewer controllers 5 for each pixel circuit 10, avoiding size increase of the pixel circuit 10. The display device 100 and the display panel 100p can thus include multiple pixel circuits 10 arranged with narrower pitches to improve resolution. The display device 100 can thus have higher image quality.

The display panel 100p may include a single controller 5 and a single signal output circuit 6 for multiple pixel circuits 10, in the same or similar manner as in the second embodiment. In other words, the display panel 100p may include the controller 5 for each set of multiple pixel circuits 10 to selectively output the first potential V1 or the second potential V2. In this case, the controller 5 can selectively output the first potential V1 or the second potential V2 to the gate electrode of the second transistor 11e in each pixel circuit 10. More specifically, the controller 5 can selectively output the first potential V1 or the second potential V2 to the gate electrode of the second-A transistor 11ea in each pixel circuit 10. The controller 5 can selectively output the first potential V1 or the second potential V2 to the gate electrode of the second-B transistor 11eb in each pixel circuit 10. In this structure, the controller 5 and the signal output circuit 6 may be located in an open area in the image display 300 or the frame portion on the first surface F1 of the substrate 20, or may be located on the second surface F2 of the substrate 20. This structure includes a single controller 5 and a single signal output circuit 6 for each set of multiple pixel circuits 10, avoiding size increase of the pixel circuits 10. The display device 100 and the display panel 100p can thus include multiple pixel circuits 10 arranged with narrower pitches to improve resolution. The display device 100 can thus have higher image quality.

The controller 5 and the signal output circuit 6 may be located for a set of pixel circuits 10 in each row. As illustrated in FIG. 17, each of the first potential output signal line L1a and the second potential output signal line L1b connected to the controller 5 may be connected to multiple pixel circuits 10. More specifically, the first potential output signal line L1a and the second potential output signal line L1b connected to the controller 5 may each be connected to the subpixel circuits 1, 2, and 3 in each pixel circuit 10.

In this case, the controller 5 outputs, from the signal output section 5U, the first potential V1 to the gate electrode of the second-A transistor 11ea in each pixel circuit 10 when the controller 5 receives, at the signal input section 5I, an off-signal for the first switch. More specifically, the controller 5 outputs, from the signal output section 5U, a H signal being an off-potential signal with the first potential V1 to the gate electrode of the second-A transistor 11ea in each pixel circuit 10 through the first potential output signal line L1a when the controller 5 receives, at the signal input section 5I, a H signal being an off-signal to cause the first light emitter 12a to be in the non-use state. The controller 5 also outputs, from the signal output section 5U, the second potential V2 to the gate electrode of the second-A transistor 11ea in each pixel circuit 10 when the controller 5 receives, at the signal input section 5I, an on-signal for the first switch and the second potential V2. More specifically, the controller 5 outputs, from the signal output section 5U, an A signal with the second potential V2 to the gate electrode of the second-A transistor 11ea in each of the subpixel circuits 1, 2, and 3 in each pixel circuit 10 through the first potential output signal line L1a when the controller 5 receives, at the signal input section 5I, a L signal being an on-signal to cause the first light emitter 12a to be in the in-use state and the second potential V2. In other words, the controller 5 can selectively output a H signal being an off-potential signal with the first potential V1 or an A signal with the second potential V2 as the first switch control signal CTLA to the gate electrode of the second-A transistor 11ea in each pixel circuit 10 through the first potential output signal line L1a. More specifically, the controller 5 can selectively output a H signal being an off-potential signal with the first potential V1 or an A signal with the second potential V2 as the first switch control signal CTLA to the gate electrode of the second-A transistor 11ea in each of the subpixel circuits 1, 2, and 3 in each pixel circuit 10 through the first potential output signal line L1a.

In this case, the controller 5 outputs, from the signal output section 5U, the first potential V1 to the gate electrode of the second-B transistor 11eb in each pixel circuit 10 when the controller 5 receives, at the signal input section 5I, an off-signal for the second switch. More specifically, the controller 5 outputs, from the signal output section 5U, a H signal being an off-potential signal with the first potential V1 to the gate electrode of the second-B transistor 11eb in each pixel circuit 10 through the second potential output signal line L1b when the controller 5 receives, at the signal input section 5I, a H signal being an off-signal to cause the second light emitter 12b to be in the non-use state. The controller 5 also outputs, from the signal output section 5U, the second potential V2 to the gate electrode of the second-B transistor 11eb in each pixel circuit 10 when the controller 5 receives, at the signal input section 5I, an on-signal for the second switch and the second potential V2. More specifically, the controller 5 outputs, from the signal output section 5U, an A signal with the second potential V2 to the gate electrode of the second-B transistor 11eb in each of the subpixel circuits 1, 2, and 3 in each pixel circuit 10 through the second potential output signal line L1b when the controller 5 receives, at the signal input section 5I, a L signal being an on-signal to cause the second light emitter 12b to be in the in-use state and the second potential V2. In other words, the controller 5 can selectively output a H signal being an off-potential signal with the first potential V1 or an A signal with the second potential V2 as the second switch control signal CTLB to the gate electrode of the second-B transistor 11eb in each pixel circuit 10 through the second potential output signal line L1b. More specifically, the controller 5 can selectively output a H signal being an off-potential signal with the first potential V1 or an A signal with the second potential V2 as the second switch control signal CTLB to the gate electrode of the second-B transistor 11eb in each of the subpixel circuits 1, 2, and 3 in each pixel circuit 10 through the second potential output signal line L1b.

The fifth transistor 11m may be an n-channel transistor. In response to a H signal being an on-signal as the emission control signal received at the gate electrode, the fifth transistor 11m enters the conductive state. In response to a L signal being an off-signal as the emission control signal received at the gate electrode, the fifth transistor 11m enters the nonconductive state.

### 2-3. Fourth Embodiment

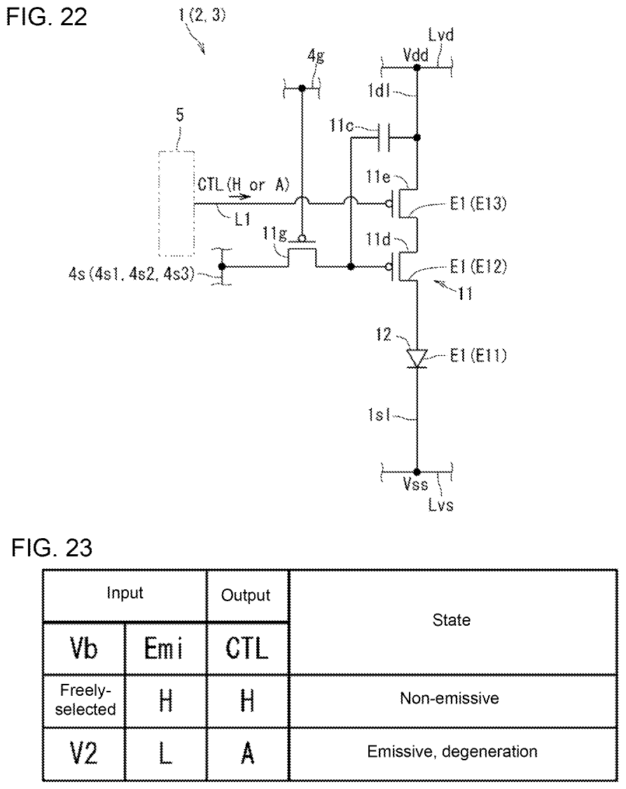

In the first embodiment, as illustrated in FIG. 22, the second transistor 11e may be connected in cascade to the first transistor 11d with the source electrode of the first transistor 11d. In this structure, the second transistor 11e can function as a degeneration resistance as an analog device, as well as a switch that switches the light emitter 12 between the emissive state and the non-emissive state. This allows an approximately linear relationship between the gate voltage Vgs and the drain current Ids in the first transistor 11d. The drain current Ids of the first transistor 11d can thus be finely adjusted easily by changing the gate voltage Vgs. The display device 100 can thus have higher image quality. The structure also allows the second transistor 11e to effectively serve as a degeneration resistance for the first transistor 11d without increasing the number of transistors connected in cascade to the first transistor 11d. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

The second transistor 11e is connected in cascade to the first transistor 11d and includes the gate electrode to selectively receive the first potential V1 or the second potential V2. The second transistor 11e with this structure can function as an analog device, as well as a switch that switches the light emitter 12 between the emissive state and the non-emissive state. The display device 100 can thus have higher image quality.

### Structure of Subpixel Circuit

FIG. 22 is a circuit diagram of an example first subpixel circuit 1 in a fourth embodiment. Each pixel circuit 10 includes the first subpixel circuit 1 with the same or similar structure. Each of the second subpixel circuit 2 and the third subpixel circuit 3 has the same or similar structure as the first subpixel circuit 1.

The first subpixel circuit 1 in the fourth embodiment is based on the first subpixel circuit 1 in the first embodiment illustrated in FIG. 4. In the fourth embodiment, the first subpixel circuit 1 includes the second transistor 11e connected in cascade to the first transistor 11d with the source electrode, not with the drain electrode, of the first transistor 11d. In the example in FIG. 22, the second transistor 11e as the third element E13, the first transistor 11d as the second element E12, and the light emitter 12 as the first element E11 are connected in series or in cascade in this order between the first power potential input section 1d1 and the second power potential input section 1s1. In the fourth embodiment, the first subpixel circuit 1 includes the capacitor 11c located on the connection line connecting the gate electrode of the first transistor 11d and one of the source electrode or the drain electrode of the second transistor 11e not connected to the first transistor 11d. The first transistor 11d, the second transistor 11e, the third transistor 11g, and the capacitor 11c are included in the emission controller 11 to control the light emission of the light emitter 12, in the same or similar manner as in the first embodiment.

In this example, the first transistor 11d and the second transistor 11e are of the same conductivity type, or specifically p-channel transistors. In this case, the second transistor 11e includes the source electrode connected to the first power potential input section 1d1. The capacitor 11c is located on the connection line connecting the source electrode of the second transistor 11e and the gate electrode of the first transistor 11d. The second transistor 11e includes the drain electrode connected to the source electrode of the first transistor 11d. The first transistor 11d includes the drain electrode connected to the positive electrode of the light emitter 12. The light emitter 12 includes the negative electrode connected to the second power potential input section 1s1. The second transistor 11e includes the gate electrode to selectively receive the first potential V1 or the second potential V2, in the same or similar manner as in the first embodiment. The second potential V2 may be set as appropriate, at a predetermined time such as before the shipment of the display panel 100p or the display device 100, to a potential that allows an approximately linear relationship between the gate voltage Vgs and the drain current Ids in the first transistor 11d when the second potential V2 is applied to the gate electrode of the second transistor 11e.

In the first subpixel circuit 1, the first transistor 11d may be connected in cascade to the second transistor 11e and may not be connected in cascade to another element between the first power potential input section 1d1 and the second power potential input section 1s1. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

### Controller

In the fourth embodiment, the gate electrode of the second transistor 11e may selectively receive the first potential V1 or the second potential V2 from the controller 5, in the same or similar manner as in the first embodiment. In other words, as described in the first embodiment, the controller 5 may selectively output the first potential V1 or the second potential V2 to the gate electrode of the second transistor 11e. The controller 5 in the fourth embodiment may have the same or similar structure as the controller 5 in the first embodiment. As described in the first embodiment, the controller 5 may be included in each of the first subpixel circuit 1, the second subpixel circuit 2, and the third subpixel circuit 3. This allows the light emitter 12 to be switched between the emissive state and the non-emissive state for each of the subpixel circuits 1, 2, and 3. As described in the first embodiment, each pixel circuit 10 may include the controller 5 to selectively output the first potential V1 or the second potential V2 to each of the first subpixel circuit 1, the second subpixel circuit 2, and the third subpixel circuit 3. This structure includes fewer controllers 5 for each pixel circuit 10, avoiding size increase of the pixel circuit 10. The display device 100 and the display panel 100p can thus include multiple pixel circuits 10 arranged with narrower pitches to improve resolution. The display device 100 can thus have higher image quality. As described in the first embodiment, the display panel 100p may include the controller 5 for each set of multiple pixel circuits 10 to selectively output the first potential V1 or the second potential V2. In this case, the controller 5 can selectively output the first potential V1 or the second potential V2 to the gate electrode of the second transistor 11e in each pixel circuit 10. This structure includes a single controller 5 for each set of multiple pixel circuits 10, avoiding size increase of the pixel circuits 10. The display device 100 and the display panel 100p can thus include multiple pixel circuits 10 arranged with narrower pitches to improve resolution. The display device 100 can thus have higher image quality.

FIG. 23 is a truth table showing an example relationship between the input into the controller 5, the output from the controller 5, and the state of the first subpixel circuit 1. In this case, the controller 5 is designed to satisfy the relationship shown in FIG. 23 between the potential (input potential) Vb input from the second potential supply line L va, the emission control signal input from the emission control signal line 4e, and the switch control signal CTL output to the potential output signal line LL. The truth table in FIG. 23 is altered from the truth table in FIG. 7, with the state of the first subpixel circuit 1 being changed from the state with a cascode connection for the first transistor 11d to the state with a degeneration resistance for the first transistor 11d.

When the input potential Vb is a freely-selected potential and the emission control signal is a H signal being an off-signal, the switch control signal CTL is a H signal being an off-potential signal with the first potential V1. The H signal being the off-potential signal with the first potential V1 is input into the gate electrode of the second transistor 11e, thus causing the second transistor 11e to enter the nonconductive state. This causes the light emitter 12 to enter the non-emissive state. When the input potential Vb is the second potential V2 and the emission control signal is a L signal being an on-signal, the switch control signal CTL is an A signal with the second potential V2. The A signal with the second potential V2 is input into the gate electrode of the second transistor 11e, thus causing a current to flow between the source electrode and the drain electrode of the second transistor 11e. This causes the light emitter 12 to enter the emissive state. In this state, the second transistor 11e serves as a degeneration resistance for the first transistor 11d.

### Variations of Fourth Embodiment

The second transistor 11e may be an n-channel transistor. In this case, the first potential V1 as the off-potential input into the second transistor 11e is set to a potential lower than or equal to the second power potential Vss. In this case, the first potential V1 as the off-potential is a L potential Vgl of a L signal being an off-potential signal to cause the second transistor 11e to be in the nonconductive state (off-state). When the second power potential Vss is 0 V, the first potential V1 is set to about −2 to 0 V. In this manner, the first potential V1 as the off-potential received at the gate electrode of the second transistor 11e may be higher than or equal to the first power potential Vdd or lower than or equal to the second power potential Vss based on the conductivity type of the second transistor 11e.

### 2-4. Fifth Embodiment

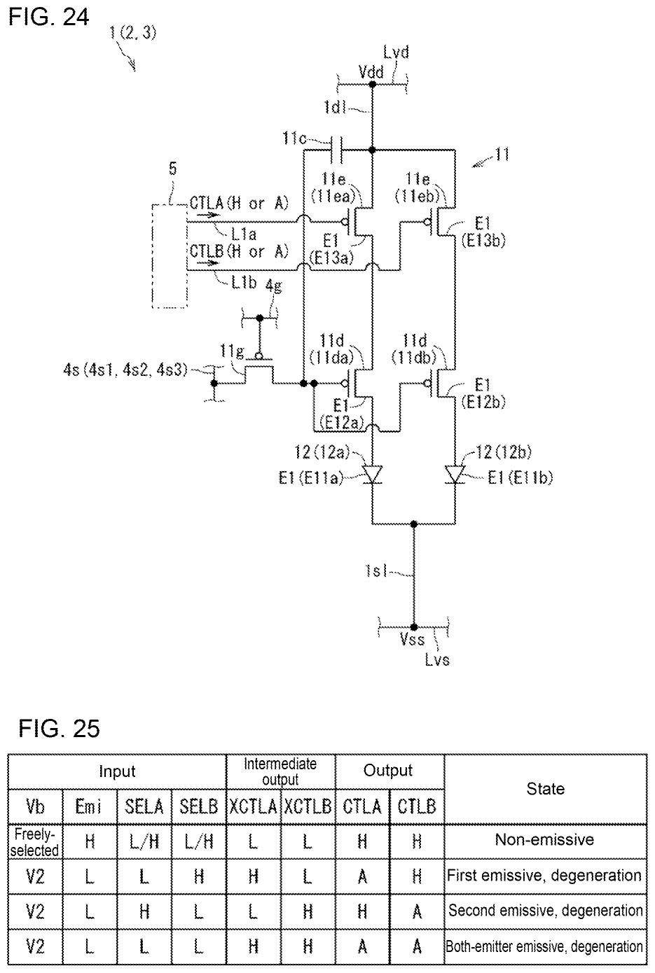

In the second embodiment, as illustrated in FIG. 24, the second transistor 11e may be connected in cascade to the first transistor 11d with the source electrode of the first transistor 11d. In this structure, the second transistor 11e can function as a degeneration resistance as an analog device, as well as a switch that switches the light emitter 12 between the emissive state and the non-emissive state. This allows an approximately linear relationship between the gate voltage Vgs and the drain current Ids in the first transistor 11d. The drain current Ids of the first transistor 11d can thus be finely adjusted easily by changing the gate voltage Vgs. The display device 100 can thus have higher image quality. The structure also allows the second transistor 11e to effectively serve as a degeneration resistance for the first transistor 11d without increasing the number of transistors connected in cascade to the first transistor 11d. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd −Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

### Structure of Subpixel Circuit

FIG. 24 is a circuit diagram of an example first subpixel circuit 1 in a fifth embodiment. Each pixel circuit 10 includes the first subpixel circuit 1 with the same or similar structure. Each of the second subpixel circuit 2 and the third subpixel circuit 3 has the same or similar structure as the first subpixel circuit 1.

The first subpixel circuit 1 in the fifth embodiment is based on the first subpixel circuit 1 in the second embodiment illustrated in FIG. 11. In the fifth embodiment, the first subpixel circuit 1 includes multiple first transistors 11d instead of the single first transistor 11d. In the fifth embodiment, the first subpixel circuit 1 includes multiple light emitters 12, multiple first transistors 11d, and multiple second transistors 11e. In the fifth embodiment, the first subpixel circuit 1 includes the second transistors 11e each connected in cascade to the corresponding first transistor 11d with the source electrode, not with the drain electrode, of the first transistor 11d. Further, in the fifth embodiment, the first subpixel circuit 1 includes the capacitor 11c located on the connection line connecting the gate electrode of the first transistor 11d and one of the source electrode or the drain electrode of the second transistor 11e not connected to the first transistor 11d.

In the fifth embodiment, the first subpixel circuit 1 includes the first set of elements E1 connected in series or in cascade and the second set of elements E1 connected in series or in cascade between the first power potential input section 1d1 and the second power potential input section 1s1.

The first set of elements E1 includes the first light emitter 12a as the first-A element E11a, the first transistor 11d (or a first-A transistor 11da) as a second element (or a second-A element) E12a, and the second-A transistor 11ea as the third-A element E13a. In the example in FIG. 24, the second-A transistor 11ea as the third-A element E13a, the first-A transistor 11da as the second-A element E12a, and the first light emitter 12a as the first-A element E11a are connected in series or in cascade in this order between the first power potential input section 1d1 and the second power potential input section 1s1.

The second set of elements E1 includes the second light emitter 12b as the first-B element E11b, the first transistor 11d (or a first-B transistor 11db) as another second element (or a second-B element) E12b, and the second-B transistor 11eb as the third-B element E13b. In the example in FIG. 24, the second-B transistor 11eb as the third-B element E13b, the first-B transistor 11db as the second-B element E12b, and the second light emitter 12b as the first-B element E11b are connected in series or in cascade in this order between the first power potential input section 1d1 and the second power potential input section 1s1.

In other words, in the example in FIG. 24, the first set of elements E1 connected in series or in cascade and the second set of elements E1 connected in series or in cascade are connected in parallel between the first power potential input section 1d1 and the second power potential input section 1s1.

In this case, as illustrated in FIG. 24, the multiple light emitters 12 include a first light emitter 12a and a second light emitter 12b connected in parallel. The multiple first transistors 11d include a first-A transistor 11da and a first-B transistor 11db. The first-A transistor 11da is connected in series to the first light emitter 12a. The first-B transistor 11db is connected in series to the second light emitter 12b. The multiple second transistors 11e include a second-A transistor 11ea and a second-B transistor 11eb. The second-A transistor 11ea is connected in cascade to the first-A transistor 11da with the source electrode of the first-A transistor 11da. The second-B transistor 11eb is connected in cascade to the first-B transistor 11db with the source electrode of the first-B transistor 11db. The multiple first transistors 11d, the multiple second transistors 11e, the third transistor 11g, and the capacitor 11c are included in the emission controller 11 to control the light emission of the multiple light emitters 12.

In this example, the first-A transistor 11da, the first-B transistor 11db, the second-A transistor 11ea, and the second-B transistor 11eb are of the same conductivity type, or specifically p-channel transistors. In this case, the second-A transistor 11ea includes the source electrode connected to the first power potential input section 1d1. The second-A transistor 11ea includes the drain electrode connected to the source electrode of the first-A transistor 11da. The first-A transistor 11da includes the drain electrode connected to the positive electrode of the first light emitter 12a. The first light emitter 12a includes the negative electrode connected to the second power potential input section 1s1. The second-B transistor 11eb includes the source electrode connected to the first power potential input section 1d1. The second-B transistor 11eb includes the drain electrode connected to the source electrode of the first-B transistor 11db. The first-B transistor 11db includes the drain electrode connected to the positive electrode of the second light emitter 12b. The second light emitter 12b includes the negative electrode connected to the second power potential input section 1s1.

The third transistor 11g includes the drain electrode (source electrode) connected to the gate electrode of each of the first-A transistor 11da and the first-B transistor 11db. In response to an on-potential signal as a scanning signal from the scanning signal line 4g received at the gate electrode, the third transistor 11g enters the conductive state in which a current flows between the source electrode and the drain electrode. This allows an image signal from the first image signal line 4s1 to be input into the gate electrode of each of the first-A transistor 11da and the first-B transistor 11db through the third transistor 11g. When the third transistor 11g is a p-channel transistor, an on-potential signal is a L signal with the L potential Vgl. In the second subpixel circuit 2, an image signal is input from the second image signal line 4s2 instead of the first image signal line 4s1. In the third subpixel circuit 3, an image signal is input from the third image signal line 4s3 instead of the first image signal line 4s1.

The capacitor 11c is located on the connection line connecting the gate electrode of the first-A transistor 11da and the source electrode of the second-A transistor 11ea and connecting the gate electrode of the first-B transistor 11db and the source electrode of the second-B transistor 11eb. The capacitor 11c retains the potential Vsig of the image signal input into the gate electrodes of the first-A transistor 11da and the first-B transistor 11db for a period (period of one frame) until the next image signal is input (or until refreshing occurs).

Each of the second-A transistor 11ea and the second-B transistor 11eb includes the gate electrode to selectively receive the first potential V1 or the second potential V2, in the same or similar manner as in the second embodiment. The second potential V2 may be set as appropriate, at a predetermined time such as before the shipment of the display panel 100p or the display device 100, to a potential that allows an approximately linear relationship between the gate voltage Vgs and the drain current Ids in each first transistor 11d when the second potential V2 is applied to the gate electrode of the corresponding second transistor 11e connected in cascade to the first transistor 11d. Each of the second-A transistor 11ea and the second-B transistor 11eb can thus function as a degeneration resistance, as well as a switch that switches each of the first light emitter 12a and the second light emitter 12b between the emissive state and the non-emissive state. This allows an approximately linear relationship between the gate voltage Vgs and the drain current Ids in each of the first-A transistor 11da and the first-B transistor 11db. The drain current Ids of each of the first-A transistor 11da and the first-B transistor 11db can thus be finely adjusted easily by changing the gate voltage Vgs. The display device 100 can thus have higher image quality. The structure also allows the second-A transistor 11ea to effectively serve as a degeneration resistance for the first-A transistor 11da without increasing the number of transistors connected in cascade to the first-A transistor 11da. The structure also allows the second-B transistor 11eb to effectively serve as a degeneration resistance for the first-B transistor 11db without increasing the number of transistors connected in cascade to the first-B transistor 11db. This avoids a lower drain-source voltage Vds of each of the first-A transistor 11da and the first-B transistor 11db with the potential difference (Vdd−Vss) between the first power potential Vdd and the second power potential Vss. Thus, the conditions for the first-A transistor 11da and the first-B transistor 11db to operate in the saturation region are less likely to be stricter in response to a decrease in the potential difference (Vdd−Vss) resulting from, for example, a decrease in the first power potential Vdd or in response to an increase in the forward voltage applied to the first light emitter 12a and the second light emitter 12b. This reduces gradations (uneven luminance), or a gradual decrease in the luminance of the display device 10, thus improving the image quality of the display device 100.

In the first subpixel circuit 1, the first-A transistor 11da may be connected in cascade to the second-A transistor 11ea and may not be connected in cascade to another element between the first power potential input section 1d1 and the second power potential input section 1s1. This avoids a lower drain-source voltage Vds of the first-A transistor 11da with the potential difference (Vdd−Vss) between the first power potential Vdd and the second power potential Vss. Thus, the conditions for the first-A transistor 11da to operate in the saturation region are less likely to be stricter in response to a decrease in the potential difference (Vdd−Vss) resulting from, for example, a decrease in the first power potential Vdd or in response to an increase in the forward voltage applied to the first light emitter 12a. In the first subpixel circuit 1, the first-B transistor 11db may be connected in cascade to the second-B transistor 11eb and may not be connected in cascade to another element between the first power potential input section 1d1 and the second power potential input section 1s1. This avoids a lower drain-source voltage Vds of the first-B transistor 11db with the potential difference (Vdd−Vss) between the first power potential Vdd and the second power potential Vss. Thus, the conditions for the first-B transistor 11db to operate in the saturation region are less likely to be stricter in response to a decrease in the potential difference (Vdd−Vss) resulting from, for example, a decrease in the first power potential Vdd or in response to an increase in the forward voltage applied to the second light emitter 12b. This reduces gradations (uneven luminance), or a gradual decrease in the luminance of the display device 100, thus improving the image quality of the display device 100.

### Controller

In the fifth embodiment, in the same or similar manner as in the second embodiment, the controller 5 may selectively output the first potential V1 or the second potential V2 to the gate electrode of each of the second-A transistor 11ea and the second-B transistor 11eb. The controller 5 in the fifth embodiment may have the same or similar structure as the controller 5 in the second embodiment. As described in the second embodiment, the controller 5 may be included in each of the first subpixel circuit 1, the second subpixel circuit 2, and the third subpixel circuit 3. This allows each of the first light emitter 12a and the second light emitter 12b to be switched between the emissive state and the non-emissive state for each of the subpixel circuits 1, 2, and 3. As described in the second embodiment, each pixel circuit 10 may include a single controller 5 and a single signal output circuit 6 for a set of the first subpixel circuit 1, the second subpixel circuit 2, and the third subpixel circuit 3. This structure includes fewer controllers 5 for each pixel circuit 10, avoiding size increase of the pixel circuit 10. The display device 100 and the display panel 100p can thus include multiple pixel circuits 10 arranged with narrower pitches to improve resolution. The display device 100 can thus have higher image quality. As described in the second embodiment, the display panel 100p may include a single controller 5 and a single signal output circuit 6 for multiple pixel circuits 10. In this case, the controller 5 can selectively output the first potential V1 or the second potential V2 to the gate electrode of the second transistor 11e in each pixel circuit 10. More specifically, the controller 5 can selectively output the first potential V1 or the second potential V2 to the gate electrode of the second-A transistor lea in each pixel circuit 10. The controller 5 can selectively output the first potential V1 or the second potential V2 to the gate electrode of the second-B transistor 11eb in each pixel circuit 10. This structure includes a single controller 5 and a single signal output circuit 6 for each set of multiple pixel circuits 10, avoiding size increase of the pixel circuits 10. The display device 100 and the display panel 100p can thus include multiple pixel circuits 10 arranged with narrower pitches to improve resolution. The display device 100 can thus have higher image quality.

FIG. 25 is a truth table showing an example relationship between the input into the controller 5, the intermediate output signal in the controller 5, the output from the controller 5, and the state of the first subpixel circuit 1. In this case, the controller 5 is designed to satisfy the relationship shown in FIG. 25 between the input potential Vb input from the second potential supply line Lva, the emission control signal input from the emission control signal line 4e, the first selection setting signal SELA being input, the second selection setting signal SELB being input, the first switch control signal CTLA output to the first potential output signal line L1a, and the second switch control signal CTLB output to the second potential output signal line L1b. In this case, the logic circuit 51 is designed to provide various logic outputs to satisfy the relationship shown in FIG. 25 between the emission control signal input from the emission control signal line 4e, the first selection setting signal SELA being input, the second selection setting signal SELB being input, the first intermediate output signal XCTLA output to the first potential converter 52a, and the second intermediate output signal XCTLB output to the second potential converter 52b. The truth table in FIG. 25 is altered from the truth table in FIG. 14, with the state of the first subpixel circuit 1 being changed from the state with a cascode connection for the first transistor 11d to the state with a degeneration resistance for at least one of the first transistors 11d, or specifically at least one of the first-A transistor 11da or the first-B transistor 11db.

As shown in FIG. 25, when the controller 5 receives a freely-selected potential as the input potential Vb and a H signal being an off-signal as the emission control signal, the controller 5 outputs a H signal being an off-potential signal with the first potential V1 as each of the first switch control signal CTLA and the second switch control signal CTLB. In response to the H signal being the off-signal as the emission control signal input into the controller 5, the logic circuit 51 outputs a L signal as both the first intermediate output signal XCTLA and the second intermediate output signal XCTLB independently of whether the first selection setting signal SELA and the second selection setting signal SELB are each a L signal being an on-signal or a H signal being an off-signal. The H signal being the off-potential signal with the first potential V1 is input into the gate electrode of each of the second-A transistor 11ea and the second-B transistor 11eb, thus causing these transistors to enter the nonconductive state. This causes both the first light emitter 12a and the second light emitter 12b to enter the non-emissive state.

When the controller 5 receives the second potential V2 as the input potential Vb, a L signal being an on-signal as the emission control signal, a L signal being an on-signal as the first selection setting signal SELA, and a H signal being an off-signal as the second selection setting signal SELB, the controller 5 outputs an A signal with the second potential V2 as the first switch control signal CTLA and a H signal being an off-potential signal with the first potential V1 as the second switch control signal CTLB. In response to the L signal being the on-signal as the emission control signal, the L signal being the on-signal as the first selection setting signal SELA, and the H signal being the off-signal as the second selection setting signal SELB input into the controller 5, the logic circuit 51 outputs a H signal as the first intermediate output signal XCTLA and a L signal as the second intermediate output signal XCTLB. The A signal with the second potential V2 is input into the gate electrode of the second-A transistor 11ea, thus causing the first light emitter 12a to enter the emissive state (first emissive state). In this state, the second-A transistor 11ea serves as a degeneration resistance for the first-A transistor 11da. The H signal being the off-potential signal with the first potential V1 is input into the gate electrode of the second-B transistor 11eb, thus causing the second light emitter 12b to enter the non-emissive state (second non-emissive state).

When the controller 5 receives the second potential V2 as the input potential Vb, a L signal being an on-signal as the emission control signal, a H signal being an off-signal as the first selection setting signal SELA, and a L signal being an on-signal as the second selection setting signal SELB, the controller 5 outputs a H signal with the first potential V1 as the first switch control signal CTLA and an A signal with the second potential V2 as the second switch control signal CTLB. In response to the L signal being the on-signal as the emission control signal, the H signal being the off-signal as the first selection setting signal SELA, and the L signal being the on-signal as the second selection setting signal SELB input into the controller 5, the logic circuit 51 outputs a L signal as the first intermediate output signal XCTLA and a H signal as the second intermediate output signal XCTLB. The H signal being the off-potential signal with the first potential V1 is input into the gate electrode of the second-A transistor 11ea, thus causing the first light emitter 12a to enter the non-emissive state (first non-emissive state). The A signal with the second potential V2 is input into the gate electrode of the second-B transistor 11eb, thus causing the second light emitter 12b to enter the emissive state (second emissive state). In this state, the second-B transistor 11eb serves as a degeneration resistance for the first-B transistor 11db.

When the controller 5 receives the second potential V2 as the input potential Vb, a L signal being an on-signal as the emission control signal, a L signal being an on-signal as the first selection setting signal SELA, and a L signal being an on-signal as the second selection setting signal SELB, the controller 5 outputs an A signal with the second potential V2 as each of the first switch control signal CTLA and the second switch control signal CTLB. In response to the L signal being the on-signal as the emission control signal, the L signal being the on-signal as the first selection setting signal SELA, and the L signal being the on-signal as the second selection setting signal SELB input into the controller 5, the logic circuit 51 outputs a H signal as both the first intermediate output signal XCTLA and the second intermediate output signal XCTLB. The A signal with the second potential V2 is input into the gate electrode of each of the second-A transistor 11ea and the second-B transistor 11eb, thus causing both the first light emitter 12a and the second light emitter 12b to enter the emissive state (both-emitter emissive state). In this state, the second-A transistor 11ea serves as a degeneration resistance for the first-A transistor 11da, and the second-B transistor 11eb serves as a degeneration resistance for the first-B transistor 11db.

### Variations of Fifth Embodiment

The second-A transistor 11ea may be an n-channel transistor, and the second-B transistor 11eb may be an n-channel transistor. When the second-A transistor 11ea is an n-channel transistor, the first potential V1 as the off-potential input into the second-A transistor 11ea is set to a potential lower than or equal to the second power potential Vss. When the second-B transistor 11eb is an n-channel transistor, the first potential V1 as the off-potential input into the second-B transistor 11eb is set to a potential lower than or equal to the second power potential Vss. In this case, the first potential V1 as the off-potential is a L potential Vgl of a L signal being an off-potential signal to cause the second transistor 11e to be in the nonconductive state (off-state). When the second power potential Vss is 0 V, the first potential V1 is set to about −2 to 0 V. In this manner, the first potential V1 as the off-potential received at the gate electrode of the second-A transistor 11ea and the second-B transistor 11eb may be higher than or equal to the first power potential Vdd or lower than or equal to the second power potential Vss based on the conductivity type of the second-A transistor 11ea and the second-B transistor 11eb.

### 2-5. Sixth Embodiment

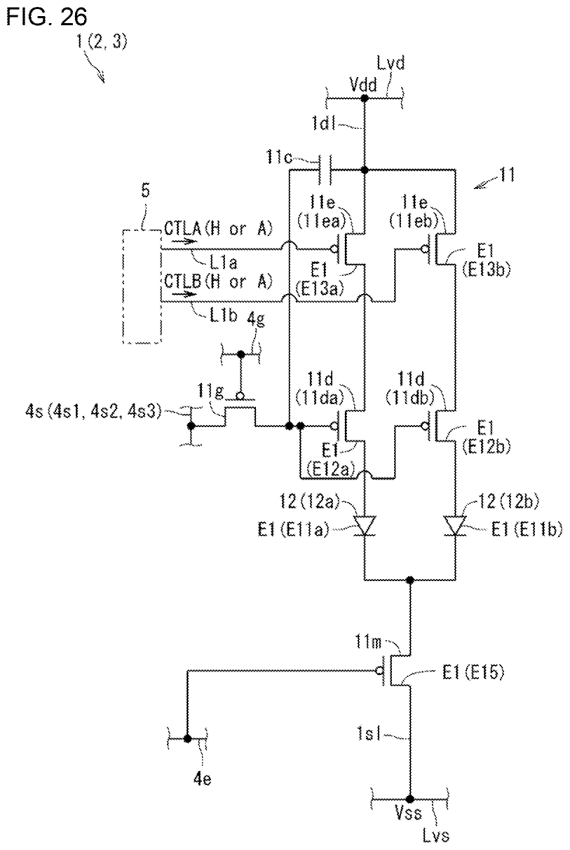

In the fifth embodiment, as illustrated in FIG. 26, the structure may include the fifth transistor 11m as the fifth element E15 to allow the second-A transistor 11ea as the third-A element E13a and the second-B transistor 11eb as the third-B element E13b to each function as an emission control element.

In this case as well, the first subpixel circuit 1 includes multiple light emitters 12, multiple first transistors 11d, and multiple second transistors 11e. The multiple light emitters 12 include a first light emitter 12a and a second light emitter 12b connected in parallel. The multiple first transistors 11d include a first-A transistor 11da connected in series to the first light emitter 12a and a first-B transistor 11db connected in series to the second light emitter 12b. The multiple second transistors 11e include a second-A transistor 11ea connected in cascade to the first-A transistor 11da with the source electrode of the first-A transistor 11da, and a second-B transistor 11eb connected in cascade to the first-B transistor 11db with the source electrode of the first-B transistor 11db. Each of the second-A transistor 11ea and the second-B transistor 11eb includes the gate electrode to selectively receive the first potential V1 or the second potential V2.

In this structure as well, each of the second-A transistor 11ea and the second-B transistor 11eb can function as a degeneration resistance, as well as a switch that switches each of the first light emitter 12a and the second light emitter 12b between the emissive state and the non-emissive state. This allows an approximately linear relationship between the gate voltage Vgs and the drain current Ids in each of the first-A transistor 11da and the first-B transistor 11db. The drain current Ids of each of the first-A transistor 11da and the first-B transistor 11db can thus be finely adjusted easily by changing the gate voltage Vgs. The display device 100 can thus have higher image quality. The structure also allows the second-A transistor 11ea to effectively serve as a degeneration resistance for the first-A transistor 11da without increasing the number of transistors connected in cascade to the first-A transistor 11da. The structure also allows the second-B transistor 11eb to effectively serve as a degeneration resistance for the first-B transistor 11db without increasing the number of transistors connected in cascade to the first-B transistor 11db. This avoids a lower drain-source voltage Vds of each of the first-A transistor 11da and the first-B transistor 11db with the potential difference (Vdd−Vss) between the first power potential Vdd and the second power potential Vss. Thus, the conditions for the first-A transistor 11da and the first-B transistor 11db to operate in the saturation region are less likely to be stricter in response to a decrease in the potential difference (Vdd−Vss) resulting from, for example, a decrease in the first power potential Vdd or in response to an increase in the forward voltage applied to the first light emitter 12a and the second light emitter 12b. This reduces gradations (uneven luminance), or a gradual decrease in the luminance of the display device 10, thus improving the image quality of the display device 100.

### Structure of Subpixel Circuit

FIG. 26 is a circuit diagram of an example first subpixel circuit 1 in a sixth embodiment. Each pixel circuit 10 includes the first subpixel circuit 1 with the same or similar structure. Each of the second subpixel circuit 2 and the third subpixel circuit 3 has the same or similar structure as the first subpixel circuit 1.

The first subpixel circuit 1 in the sixth embodiment is altered from the first subpixel circuit 1 in the sixth embodiment illustrated in FIG. 24, with the fifth transistor 11m as the fifth element E15 being added. The fifth transistor 11m is included in the emission controller 11. In this structure as well, the first subpixel circuit 1 includes the first set of elements E1 connected in series or in cascade and the second set of elements E1 connected in series or in cascade between the first power potential input section 1d1 and the second power potential input section 1s1.

The first set of elements E1 includes the first light emitter 12a as the first-A element E11a, the first-A transistor 11da as the second-A element E12a, the second-A transistor 11ea as the third-A element E13a, and the fifth transistor 11m as the fifth element E15. In the example in FIG. 26, the second-A transistor 11ea as the third-A element E13a, the first-A transistor 11da as the second-A element E12a, the first light emitter 12a as the first-A element E11a, and the fifth transistor 11m as the fifth element E15 are connected in series or in cascade in this order between the first power potential input section 1d1 and the second power potential input section 1s1.

The second set of elements E1 includes the second light emitter 12b as the first-B element E11b, the first-B transistor 11db as the second-B element E12b, the second-B transistor 11eb as the third-B element E13b, and the fifth transistor 11m as the fifth element E15. In the example in FIG. 26, the second-B transistor 11eb as the third-B element E13b, the first-B transistor 11db as the second-B element E12b, the second light emitter 12b as the first-B element E11b, and the fifth transistor 11m as the fifth element E15 are connected in series or in cascade in this order between the first power potential input section 1d1 and the second power potential input section 1s1.

The multiple first transistors 11d, the multiple second transistors 11e, the third transistor 11g, the capacitor 11c, and the fifth transistor 11m are included in the emission controller 11 to control the light emission of the multiple light emitters 12.

In the sixth embodiment, the second-A transistor 11ea functions as an element (use setting element) for setting the first light emitter 12a selectively to the in-use state or the non-use state, and does not function as an element (emission control element) for controlling the emission or non-emission of the first light emitter 12a. The second-B transistor 11eb functions as an element (use setting element) for setting the second light emitter 12b selectively to the in-use state or the non-use state, and does not function as an element (emission control element) for controlling the emission or non-emission of the second light emitter 12b.

The fifth transistor 11m can switch the first light emitter 12a and the second light emitter 12b between the emissive state and the non-emissive state. The fifth transistor 11m functions as an element (emission control element) for controlling the emission or non-emission of the first light emitter 12a and the second light emitter 12b. The fifth transistor 11m is between the first light emitter 12a and the second power potential input section 1s1. The fifth transistor 11m is between the second light emitter 12b and the second power potential input section 1s1. The fifth transistor 11m is a p-channel transistor. In this case, the fifth transistor 11m includes the source electrode connected to the negative electrode of the first light emitter 12a and to the negative electrode of the second light emitter 12b. The fifth transistor 11m includes the drain electrode connected to the second power potential input section 1s1. The fifth transistor 11m includes the gate electrode to receive the emission control signal from the emission control signal line 4e. In response to a L signal being an on-signal as the emission control signal received at the gate electrode, the fifth transistor 11m enters the conductive state. In response to a H signal being an off-signal as the emission control signal received at the gate electrode, the fifth transistor 11m enters the nonconductive state.

### Controller

In the sixth embodiment, the controller 5 may selectively output the first potential V1 or the second potential V2 to the gate electrode of each of the second-A transistor 11ea and the second-B transistor 11eb, in the same or similar manner as in the third embodiment. The controller 5 in the sixth embodiment may have the same or similar structure as the controller 5 in the third embodiment. In this structure, as described in the third embodiment, the controller 5 may be included in each of the first subpixel circuit 1, the second subpixel circuit 2, and the third subpixel circuit 3. This allows each of the first light emitter 12a and the second light emitter 12b to be switched between the in-use state and the non-use state for each of the subpixel circuits 1, 2, and 3. In this structure, as described in the third embodiment, each pixel circuit 10 may include a single controller 5 and a single signal output circuit 6 for a set of the first subpixel circuit 1, the second subpixel circuit 2, and the third subpixel circuit 3. This structure includes fewer controllers 5 for each pixel circuit 10, avoiding size increase of the pixel circuit 10. The display device 100 and the display panel 100p can thus include multiple pixel circuits 10 arranged with narrower pitches to improve resolution. The display device 100 can thus have higher image quality. As described in the third embodiment, the display panel 100p may include a single controller 5 and a single signal output circuit 6 for multiple pixel circuits 10. In this case, the controller 5 can selectively output the first potential V1 or the second potential V2 to the gate electrode of the second transistor 11e in each pixel circuit 10. More specifically, the controller 5 can selectively output the first potential V1 or the second potential V2 to the gate electrode of the second-A transistor 11ea in each pixel circuit 10. The controller 5 can selectively output the first potential V1 or the second potential V2 to the gate electrode of the second-B transistor 11eb in each pixel circuit 10. This structure includes a single controller 5 and a single signal output circuit 6 for each set of multiple pixel circuits 10, avoiding size increase of the pixel circuits 10. The display device 100 and the display panel 100p can thus include multiple pixel circuits 10 arranged with narrower pitches to improve resolution. The display device 100 can thus have higher image quality.

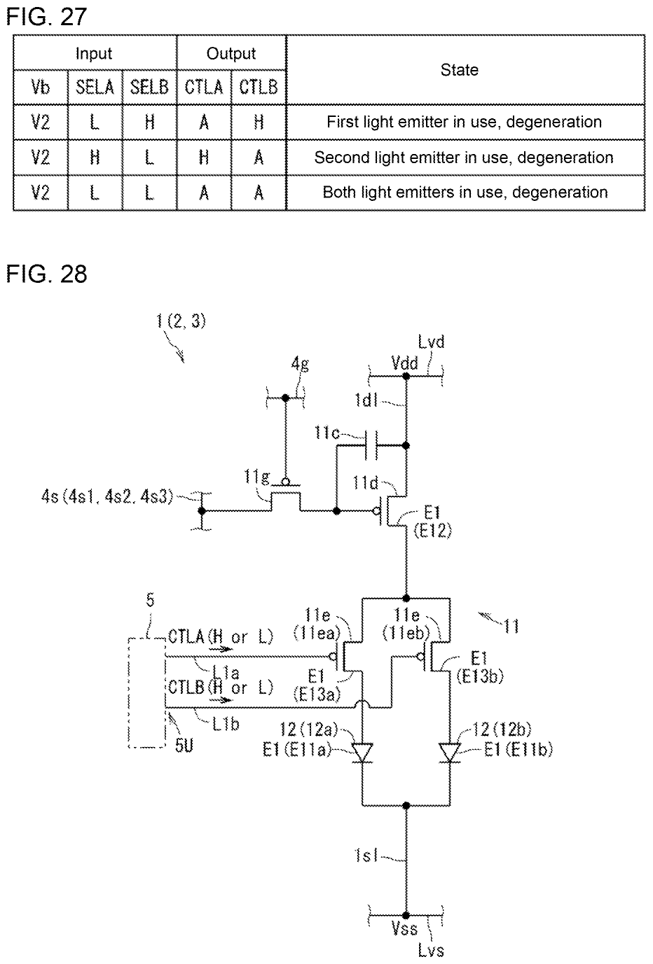

FIG. 27 is a truth table showing an example relationship between the input into the controller 5, the output from the controller 5, and the state of the first subpixel circuit 1. In this case, the controller 5 is designed to satisfy the relationship shown in FIG. 27 between the input potential Vb input from the second potential supply line Lva, the first selection setting signal SELA being input, the second selection setting signal SELB being input, the first switch control signal CTLA output to the first potential output signal line L1a, and the second switch control signal CTLB output to the second potential output signal line L1b. The truth table in FIG. 27 is altered from the truth table in FIG. 21, with the state of the first subpixel circuit 1 being changed from the state with a cascode connection for the first transistor 11d to the state with a degeneration resistance for at least one of the first transistors 11d, or specifically at least one of the first-A transistor 11da or the first-B transistor 11db.

As shown in FIG. 27, when the input potential Vb is the second potential V2, the first selection setting signal SELA is a L signal being an on-signal, and the second selection setting signal SELB is a H signal being an off-signal, the first switch control signal CTLA is an A signal with the second potential V2, and the second switch control signal CTLB is a H signal being an off-potential signal with the first potential V1. In this case, the A signal with the second potential V2 is input into the gate electrode of the second-A transistor 11ea, thus causing the first light emitter 12a to enter the in-use state. In this state, the second-A transistor 11ea serves as a degeneration resistance for the first-A transistor 11da. The H signal being the off-potential signal with the first potential V1 is input into the gate electrode of the second-B transistor 11eb, thus causing the second light emitter 12b to enter the non-use state.

When the input potential Vb is the second potential V2, the first selection setting signal SELA is a H signal being an off-signal, and the second selection setting signal SELB is a L signal being an on-signal, the first switch control signal CTLA is a H signal being an off-potential signal with the first potential V1, and the second switch control signal CTLB is an A signal with the second potential V2. In this case, the H signal being the off-potential signal with the first potential V1 is input into the gate electrode of the second-A transistor 11ea, thus causing the first light emitter 12a to enter the non-use state. The A signal with the second potential V2 is input into the gate electrode of the second-B transistor 11eb, thus causing the second light emitter 12b to enter the in-use state. In this state, the second-B transistor 11eb serves as a degeneration resistance for the first-B transistor 11db.

When the input potential Vb is the second potential V2, the first selection setting signal SELA is a L signal being an on-signal, and the second selection setting signal SELB is a L signal being an on-signal, each of the first switch control signal CTLA and the second switch control signal CTLB is an A signal with the second potential V2. In this case, the A signal with the second potential V2 is input into the gate electrode of each of the second-A transistor 11ea and the second-B transistor 11eb, thus causing both the first light emitter 12a and the second light emitter 12b to enter the in-use state. In this state, the second-A transistor 11ea serves as a degeneration resistance for the first-A transistor 11da, and the second-B transistor 11eb serves as a degeneration resistance for the first-B transistor 11db.

### Variations of Sixth Embodiment

In the above structure, the second-A transistor 11ea may be an n-channel transistor, and the second-B transistor 11eb may be an n-channel transistor. When the second-A transistor 11ea is an n-channel transistor, the first potential V1 as the off-potential input into the second-A transistor 11ea is set to a potential lower than or equal to the second power potential Vss. When the second-B transistor 11eb is an n-channel transistor, the first potential V1 as the off-potential input into the second-B transistor 11eb is set to a potential lower than or equal to the second power potential Vss. In this case, the first potential V1 as the off-potential is a L potential Vgl of a L signal being an off-potential signal to cause the second transistor 11e to be in the nonconductive state (off-state). When the second power potential Vss is 0 V, the first potential V1 is set to about −2 to 0 V. In this manner, the first potential V1 as the off-potential received at the gate electrode of the second-A transistor 11ea and the second-B transistor 11eb may be higher than or equal to the first power potential Vdd or lower than or equal to the second power potential Vss based on the conductivity type of the second-A transistor 11ea and the second-B transistor 11eb.

### 2-6. Seventh Embodiment

In the second embodiment, the signal input section 5I in the controller 5 may selectively receive an on-signal or an off-signal for each of the multiple switches that perform switch control over the single second transistor 11e, and may not receive the second potential V2. The controller 5 may output, from the signal output section 5U, a potential to the gate electrode of the second transistor 11e to cause a light emitter 12 to be in the non-emissive state when the controller 5 receives, at the signal input section 5I, an off-signal for at least one of the multiple switches for the light emitter 12. The controller 5 may also output, from the signal output section 5U, a potential to the gate electrode of the second transistor 11e to cause a light emitter 12 to be in the emissive state when the controller 5 receives, at the signal input section 5I, an on-signal for each of the multiple switches for the light emitter 12.

This achieves the switch control over the multiple switches using the single second transistor 11e that switches a light emitter 12 between the emissive state and the non-emissive state, without increasing the number of transistors connected in cascade to the first transistor 11d. The multiple switches can set the light emitter 12 selectively to the in-use state or the non-use state and can set the light emitter 12 selectively to the emissive state or the non-emissive state. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

### Structure of Subpixel Circuit

FIG. 28 is a circuit diagram of an example first subpixel circuit 1 in a seventh embodiment. Each pixel circuit 10 includes the first subpixel circuit 1 with the same or similar structure. Each of the second subpixel circuit 2 and the third subpixel circuit 3 has the same or similar structure as the first subpixel circuit 1.

The example first subpixel circuit 1 in the seventh embodiment is altered from the first subpixel circuit 1 in the second embodiment illustrated in FIG. 11, with the A signal with the second potential V2 received at the gate electrode of each of the second-A transistor 11ea and the second-B transistor 11eb being replaced with a signal with a third potential V3. The third potential V3 is a potential (or an on-potential) to set the second-A transistor 11ea and the second-B transistor 11eb to the state (conductive state) in which a current flows between the source electrode and the drain electrode. When the second-A transistor 11ea is a p-channel transistor, the on-potential is the L potential Vgl lower than or equal to the second power potential Vss. When the second power potential Vss is 0 V, the L potential Vgl is set to about −2 to 0 V.

As illustrated in FIG. 28, the first subpixel circuit 1 includes multiple light emitters 12 and multiple second transistors 11e, in the same or similar manner as in the second embodiment. The multiple light emitters 12 include a first light emitter 12a and a second light emitter 12b connected in parallel. The multiple second transistors 11e include a second-A transistor 11ea connected in series to the first light emitter 12a and a second-B transistor 11eb connected in series to the second light emitter 12b.

The structure includes two sets of elements E1 connected in series or in cascade between the first power potential input section 1d1 and the second power potential input section 1s1. A first set of elements E1 will now be described. The first subpixel circuit 1 includes the first light emitter 12a as the first-A element E11a, the first transistor 11d as the second element E12, and the second-A transistor 11ea as the third-A element E13a. The first transistor 11d connected in series to the first light emitter 12a can control a current flowing through the first light emitter 12a in response to a potential corresponding to an image signal received at the gate electrode. The second-A transistor 11ea is connected in cascade to the first transistor 11d to switch the first light emitter 12a between the emissive state and the non-emissive state.

The two sets of elements E1 connected in series or in cascade between the first power potential input section 1d1 and the second power potential input section 1s1 include the second set of elements E1. In this case, the first subpixel circuit 1 includes the second light emitter 12b as the first-B element E11b, the first transistor 11d as the second element E12, and the second-B transistor 11eb as the third-B element E13b. The first transistor 11d connected in series to the second light emitter 12b can control a current flowing through the second light emitter 12b in response to a potential corresponding to an image signal received at the gate electrode. The second-B transistor 11eb is connected in cascade to the first transistor 11d to switch the second light emitter 12b between the emissive state and the non-emissive state.

In this structure, in the same or similar manner as in the second embodiment, the first transistor 11d, the multiple second transistors 11e, the third transistor 11g, and the capacitor 11c are included in the emission controller 11 to control the light emission of the multiple light emitters 12.

### Controller

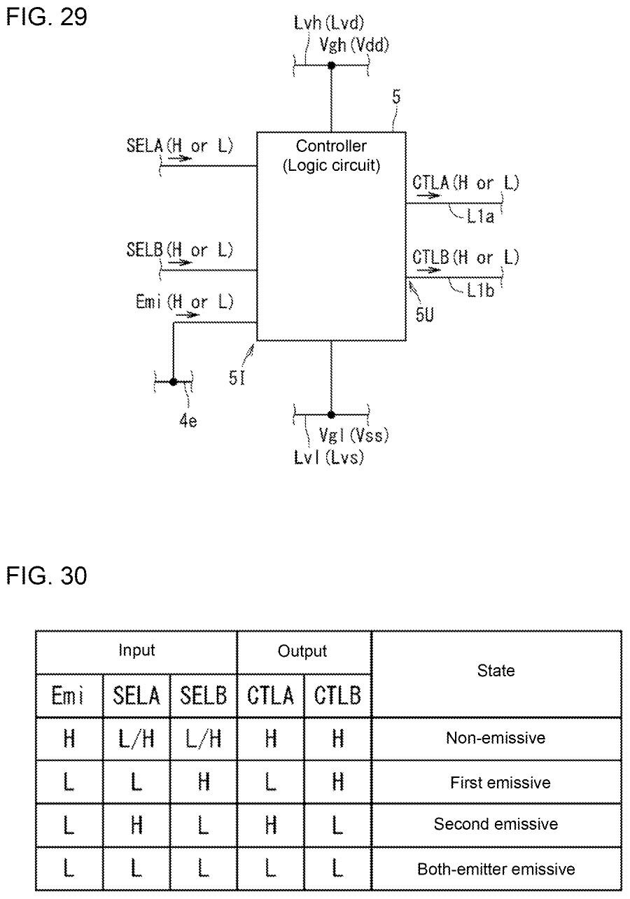

FIG. 29 is a schematic gate circuit diagram of the controller 5, illustrating example input and output gates. In the seventh embodiment, the controller 5 functions as multiple switches that perform switch control over the second transistor 11e. In this case, the controller 5 functions as multiple switches that perform switch control over the second-A transistor 11ea as the third-A element E13a. The controller 5 also functions as multiple switches that perform switch control over the second-B transistor 11eb as the third-B element E13b. Switch control includes switching the second transistor 11e selectively between a state in which a current flows between the source electrode and the drain electrode and a state in which no current flows between the source electrode and the drain electrode. The multiple switches can set the light emitter 12 selectively to the in-use state or the non-use state and can set the light emitter 12 selectively to the emissive state or the non-emissive state. For the first set of elements E1 described above, the multiple switches can set the first light emitter 12a selectively to the in-use state or the non-use state and can set the light emitter 12 selectively to the emissive state or the non-emissive state. For the second set of elements E1 described above, the multiple switches can set the second light emitter 12b selectively to the in-use state or the non-use state and can set the light emitter 12 selectively to the emissive state or the non-emissive state.

In other words, the controller 5 functions as the first switch, the second switch, and the third switch. The first switch can set the first light emitter 12a selectively to the in-use state or the non-use state. The second switch can set the second light emitter 12b selectively to the in-use state or the non-use state. The third switch can set the first light emitter 12a and the second light emitter 12b as the light emitters 12 selectively to the emissive state or the non-emissive state. This allows the single second transistor 11e to easily achieve the switch control for switching selectively between the in-use state and the non-use state and also achieve the switch control over the timing of light emission for each of the redundantly located light emitters 12.

As illustrated in FIG. 29, the signal input section 5I in the controller 5 selectively receives an on-signal or an off-signal for each of the multiple switches for each light emitter 12. In this case, the signal input section 5I in the controller 5 selectively receives an on-signal or an off-signal for each of the multiple switches for the first light emitter 12a as the first-A element E11a. The signal input section 5I in the controller 5 also selectively receives an on-signal or an off-signal for each of the multiple switches for the second light emitter 12b as the first-B element E11b. In the seventh embodiment, the signal input section 5I in the controller 5 selectively receives an on-signal or an off-signal for the first switch, selectively receives an on-signal or an off-signal for the second switch, and selectively receives an on-signal or an off-signal for the third switch.

For the first switch, the off-signal is a signal to cause the first light emitter 12a to be in the non-use state, and the on-signal is a signal to cause the first light emitter 12a to be in the in-use state. For the second switch, the off-signal is a signal to cause the second light emitter 12b to be in the non-use state, and the on-signal is a signal to cause the second light emitter 12b to be in the in-use state. For the third switch, the off-signal is a signal to cause the light emitter 12 to be in the non-emissive state, and the on-signal is a signal to cause the light emitter 12 to be in the emissive state. The off-signal is a H signal, and the on-signal is a L signal.

More specifically, the controller 5 receives an on-signal or an off-signal as the first selection setting signal SELA for the first switch, an on-signal or an off-signal as the second selection setting signal SELB for the second switch, and the emission control signal being an on-signal or an off-signal from the emission control signal line 4e for the third switch. The controller 5 selectively receives a H signal being an off-signal or a L signal being an on-signal as the first selection setting signal SELA. The controller 5 selectively receives a H signal being an off-signal or a L signal being an on-signal as the second selection setting signal SELB. The controller 5 selectively receives, from the emission control signal line 4e, a H signal being an off-signal or a L signal being an on-signal as the emission control signal.

The controller 5 outputs, from the signal output section 5U, a potential to the gate electrode of the second transistor 11e to cause a light emitter 12 to be in the non-emissive state when the controller 5 receives, at the signal input section 5I, an off-signal for at least one of the multiple switches for the light emitter 12. The controller 5 also outputs, from the signal output section 5U, a potential to the gate electrode of the second transistor 11e to cause a light emitter 12 to be in the emissive state when the controller 5 receives, at the signal input section 5I, an on-signal for each of the multiple switches for the light emitter 12.

In this case, the controller 5 can output, from the signal output section 5U, a potential to the gate electrode of the second-A transistor 11ea as the third-A element E13a to cause the first light emitter 12a as the first-A element E11a to be in the non-emissive state when the controller 5 receives, at the signal input section 5I, an off-signal for at least one of the multiple switches for the first light emitter 12a. The controller 5 can also output, from the signal output section 5U, a potential to the gate electrode of the second-A transistor 11ea to cause the first light emitter 12a as the first-A element E11a to be in the emissive state when the controller 5 receives, at the signal input section 5I, an on-signal for each of the multiple switches for the first light emitter 12a.

The controller 5 can also output, from the signal output section 5U, a potential to the gate electrode of the second-B transistor 11eb as the third-B element E13b to cause the second light emitter 12b as the first-B element E11b to be in the non-emissive state when the controller 5 receives, at the signal input section 5I, an off-signal for at least one of the multiple switches for the second light emitter 12b. The controller 5 can also output, from the signal output section 5U, a potential to the gate electrode of the second-B transistor 11eb to cause the second light emitter 12b as the first-B element E11b to be in the emissive state when the controller 5 receives, at the signal input section 5I, an on-signal for each of the multiple switches for the second light emitter 12b.

This structure achieves the switch control over the multiple switches using the single second transistor 11e that switches a light emitter 12 between the emissive state and the non-emissive state, without increasing the number of transistors connected in cascade to the first transistor 11d. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

In the seventh embodiment, the controller 5 outputs, from the signal output section 5U, a potential (off-potential) to the gate electrode of the second-A transistor 11ea to cause the second-A transistor 11ea to be in the nonconductive state when the controller 5 receives, at the signal input section 5I, at least one of an off-signal for the first switch or an off-signal for the third switch. The controller 5 outputs, from the signal output section 5U, a potential (on-potential) to the gate electrode of the second-A transistor 11ea to cause the second-A transistor 11ea to be in the conductive state when the controller 5 receives, at the signal input section 5I, an on-signal for the first switch and an on-signal for the third switch.

The controller 5 outputs, from the signal output section 5U, a H signal being an off-potential signal with the off-potential to the gate electrode of the second-A transistor 11ea through the first potential output signal line L1a when the controller 5 receives, at the signal input section 5I, at least one of a H signal being an off-signal to cause the first light emitter 12a to be in the non-use state or a H signal being an off-signal to cause the light emitter 12 to be in the non-emissive state. In this case, the controller 5 outputs, from the signal output section 5U, a H signal being an off-potential signal with the off-potential as the first switch control signal CTLA to the gate electrode of the second-A transistor 11ea through the first potential output signal line L1a when the controller 5 receives, at the signal input section 5I, at least one of a H signal being an off-signal as the first selection setting signal SELA or a H signal being an off-signal as the emission control signal. This causes the second-A transistor 11ea to enter the nonconductive state. The controller 5 also outputs, from the signal output section 5U, a L signal being an on-potential signal with the on-potential to the gate electrode of the second-A transistor 11ea through the first potential output signal line L1a when the controller 5 receives, at the signal input section 5I, a L signal being an on-signal to cause the first light emitter 12a to be in the in-use state and a L signal being an on-signal to cause the light emitter 12 to be in the emissive state. In this case, the controller 5 outputs, from the signal output section 5U, a L signal being an on-potential signal with the on-potential as the first switch control signal CTLA to the gate electrode of the second-A transistor 11ea through the first potential output signal line L1a when the controller 5 receives, at the signal input section 5I, a L signal being an on-signal as the first selection setting signal SELA and a L signal being an on-signal as the emission control signal. This causes the second-A transistor 11ea to enter the conductive state.

In this structure, the controller 5 can selectively output a H signal being an off-potential signal with the off-potential or a L signal being an on-potential signal with the on-potential as the first switch control signal CTLA to the gate electrode of the second-A transistor 11ea through the first potential output signal line L1a. This allows the single second-A transistor 11ea to easily achieve the switch control for switching selectively between the in-use state and the non-use state and also achieve the switch control over the timing of light emission for the first light emitter 12a of the redundantly located two light emitters 12.

The controller 5 also outputs, from the signal output section 5U, a potential (off-potential) to the gate electrode of the second-B transistor 11eb to cause the second-B transistor 11eb to be in the nonconductive state when the controller 5 receives, at the signal input section 5I, at least one of an off-signal for the second switch or an off-signal for the third switch. The controller 5 outputs, from the signal output section 5U, a potential (on-potential) to the gate electrode of the second-B transistor 11eb to cause the second-B transistor 11eb to be in the conductive state when the controller 5 receives, at the signal input section 5I, an on-signal for the second switch and an on-signal for the third switch.

The controller 5 outputs, from the signal output section 5U, a H signal being an off-potential signal with the off-potential to the gate electrode of the second-B transistor 11eb through the second potential output signal line L1b when the controller 5 receives, at the signal input section 5I, at least one of a H signal being an off-signal to cause the second light emitter 12b to be in the non-use state or a H signal being an off-signal to cause the light emitter 12 to be in the non-emissive state. In this case, the controller 5 outputs, from the signal output section 5U, a H signal being an off-potential signal with the off-potential as the second switch control signal CTLB to the gate electrode of the second-B transistor 11eb through the second potential output signal line L1b when the controller 5 receives, at the signal input section 5I, at least one of a H signal being an off-signal as the second selection setting signal SELB or a H signal being an off-signal as the emission control signal. This causes the second-B transistor 11eb to enter the nonconductive state. The controller 5 also outputs, from the signal output section 5U, a L signal being an on-potential signal with the on-potential to the gate electrode of the second-B transistor 11eb through the second potential output signal line L1b when the controller 5 receives, at the signal input section 5I, a L signal being an on-signal to cause the second light emitter 12b to be in the in-use state and a L signal being an on-signal to cause the light emitter 12 to be in the emissive state. In this case, the controller 5 outputs, from the signal output section 5U, a L signal being an on-potential signal with the on-potential as the second switch control signal CTLB to the gate electrode of the second-B transistor 11eb through the second potential output signal line L1b when the controller 5 receives, at the signal input section 5I, a L signal being an on-signal as the second selection setting signal SELB and a L signal being an on-signal as the emission control signal. This causes the second-B transistor 11eb to enter the conductive state.

In this structure, the controller 5 can selectively output a H signal being an off-potential signal with the off-potential or a L signal being an on-potential signal with the on-potential as the second switch control signal CTLB to the gate electrode of the second-B transistor 11eb through the second potential output signal line L1b. This allows the single second-B transistor 11eb to easily achieve the switch control for switching selectively between the in-use state and the non-use state and also achieve the switch control over the timing of light emission for the second light emitter 12b of the redundantly located two light emitters 12.

FIG. 30 is a truth table showing an example relationship between the input into the controller 5, the output from the controller 5, and the state of the first subpixel circuit 1. In this case, the controller 5 is designed to provide various logic outputs to satisfy the relationship shown in FIG. 30 between the emission control signal input from the emission control signal line 4e, the first selection setting signal SELA being input, the second selection setting signal SELB being input, the first switch control signal CTLA output to the first potential output signal line L1a, and the second switch control signal CTLB output to the second potential output signal line L1b. The controller 5 may include a combination of multiple logic circuits.

As shown in FIG. 30, when the controller 5 receives a H signal being an off-signal as the emission control signal, the controller 5 outputs a H signal being an off-potential signal with the first potential V1 as each of the first switch control signal CTLA and the second switch control signal CTLB. In this case, the H signal being the off-potential signal with the first potential V1 is input into the gate electrode of each of the second-A transistor 11ea and the second-B transistor 11eb, thus causing these transistors to enter the nonconductive state. This causes both the first light emitter 12a and the second light emitter 12b to enter the non-emissive state.

When the controller 5 receives a L signal being an on-signal as the emission control signal, a L signal being an on-signal as the first selection setting signal SELA, and a H signal being an off-signal as the second selection setting signal SELB, the controller 5 outputs a L signal being an on-potential signal with the on-potential as the first switch control signal CTLA and a H signal being an off-potential signal with the first potential V1 as the second switch control signal CTLB. In this case, the L signal being the on-potential signal with the on-potential is input into the gate electrode of the second-A transistor 11ea, thus causing the second-A transistor 11ea to enter the conductive state. This causes the first light emitter 12a to enter the emissive state (first emissive state). The H signal being the off-potential signal with the first potential V1 is input into the gate electrode of the second-B transistor 11eb, thus causing the second-B transistor 11eb to enter the nonconductive state. This causes the second light emitter 12b to enter the non-emissive state (second non-emissive state).

When the controller 5 receives a L signal being an on-signal as the emission control signal, a H signal being an off-signal as the first selection setting signal SELA, and a L signal being an on-signal as the second selection setting signal SELB, the controller 5 outputs a H signal being an off-potential signal with the first potential V1 as the first switch control signal CTLA and a L signal being an on-potential signal with the on-potential as the second switch control signal CTLB. In this case, the H signal being the off-potential signal with the first potential V1 is input into the gate electrode of the second-A transistor 11ea, thus causing the second-A transistor 11ea to enter the nonconductive state. This causes the first light emitter 12a to enter the non-emissive state (first non-emissive state). The L signal being the on-potential signal with the on-potential is input into the gate electrode of the second-B transistor 11eb, thus causing the second-B transistor 11eb to enter the conductive state. This causes the second light emitter 12b to enter the emissive state (second emissive state).

When the controller 5 receives a L signal being an on-signal as the emission control signal, a L signal being an on-signal as the first selection setting signal SELA, and a L signal being an on-signal as the second selection setting signal SELB, the controller 5 outputs a L signal being an on-potential signal with the on-potential as each of the first switch control signal CTLA and the second switch control signal CTLB. In this case, the L signal being the on-potential signal with the on-potential is input into the gate electrode of each of the second-A transistor 11ea and the second-B transistor 11eb, thus causing these transistors to enter the conductive state. This causes both the first light emitter 12a and the second light emitter 12b to enter the emissive state (both-emitter emissive state).

In this structure, the first selection setting signal SELA and the second selection setting signal SELB may be output to the controller 5 from the signal output circuit 6 with the same or similar structure as in the second embodiment.

In the first subpixel circuit 1, the first transistor 11d may be connected in cascade to the second-A transistor 11ea and the second-B transistor 11eb as the second transistors 11e and may not be connected in cascade to another element between the first power potential input section 1d1 and the second power potential input section 1s1. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the first light emitter 12a and the second light emitter 12b. This reduces gradations (uneven luminance), or a gradual decrease in the luminance of the display device 100, thus improving the image quality of the display device 100.

### Variations of Seventh Embodiment

In the above structure, each pixel circuit 10 may include a single controller 5 and a single signal output circuit 6 for a set of the first subpixel circuit 1, the second subpixel circuit 2, and the third subpixel circuit 3, in the same or similar manner as in the second embodiment. In other words, each pixel circuit 10 may include the controller 5 to selectively output, to each of the first subpixel circuit 1, the second subpixel circuit 2, and the third subpixel circuit 3, a potential to cause the light emitter 12 to be in the non-emissive state or a potential to cause the light emitter 12 to be in the emissive state. In this case, as illustrated in FIG. 16, each of the first potential output signal line L1a and the second potential output signal line L1b connected to the controller 5 may be connected to the subpixel circuits 1, 2, and 3. This structure includes fewer controllers 5 for each pixel circuit 10, avoiding size increase of the pixel circuit 10. The display device 100 and the display panel loop can thus include multiple pixel circuits 10 arranged with narrower pitches to improve resolution. The display device 100 can thus have higher image quality.

The display panel 100p may include a single controller 5 and a single signal output circuit 6 for multiple pixel circuits 10, in the same or similar manner as in the second embodiment. In other words, the display panel 100p may include the controller 5 for each set of multiple pixel circuits 10 to selectively output a potential to cause the light emitter 12 to be in the non-emissive state or a potential to cause the light emitter 12 to be in the emissive state. In this case, the controller 5 and the signal output circuit 6 may be located in an open area in the image display 300 or the frame portion on the first surface F1 of the substrate 20, or may be located on the second surface F2 of the substrate 20.

In this case, the controller 5 can output, from the signal output section 5U, a potential to the gate electrode of the second transistor 11e in each pixel circuit 10 to cause a light emitter 12 to be in the non-emissive state w % ben the controller 5 receives, at the signal input section 5I, an off-signal for at least one of the multiple switches for the light emitter 12. The controller 5 can also output, from the signal output section 5U, a potential to the gate electrode of the second transistor 11e in each pixel circuit 10 to cause a light emitter 12 to be in the emissive state when the controller 5 receives, at the signal input section 5I, an on-signal for each of the multiple switches for the light emitter 12.

The controller 5 and the signal output circuit 6 may be located for a set of pixel circuits 10 in each row. As illustrated in FIG. 17, each of the first potential output signal line L1a and the second potential output signal line L1b connected to the controller 5 may be connected to multiple pixel circuits 10. More specifically, the first potential output signal line L1a and the second potential output signal line L1b connected to the controller 5 may each be connected to the subpixel circuits 1, 2, and 3 in each pixel circuit 10. This structure includes a single controller 5 and a single signal output circuit 6 for each set of multiple pixel circuits 10, avoiding size increase of the pixel circuits 10. The display device 100 and the display panel 100p can thus include multiple pixel circuits 10 arranged with narrower pitches to improve resolution. The display device 100 can thus have higher image quality.

In this case, the controller 5 can output, from the signal output section 5U, a potential to the gate electrode of the second-A transistor 11ea as the third-A element E13a in each pixel circuit 10 to cause the first light emitter 12a as the first-A element E11a to be in the non-emissive state when the controller 5 receives, at the signal input section 5I, an off-signal for at least one of the multiple switches for the first light emitter 12a. The controller 5 can also output, from the signal output section 5U, a potential to the gate electrode of the second-A transistor 11ea in each pixel circuit 10 to cause the first light emitter 12a as the first-A element E11a to be in the emissive state when the controller 5 receives, at the signal input section 5I, an on-signal for each of the multiple switches for the first light emitter 12a.

The controller 5 can also output, from the signal output section 5U, a potential to the gate electrode of the second-B transistor 11eb as the third-B element E13b in each pixel circuit 10 to cause the second light emitter 12b as the first-B element E11b to be in the non-emissive state when the controller 5 receives, at the signal input section 5I, an off-signal for at least one of the multiple switches for the second light emitter 12b. The controller 5 can also output, from the signal output section 5U, a potential to the gate electrode of the second-B transistor 11eb in each pixel circuit 10 to cause the second light emitter 12b as the first-B element E11b to be in the emissive state when the controller 5 receives, at the signal input section 5I, an on-signal for each of the multiple switches for the second light emitter 12b.

More specifically, the controller 5 can output, from the signal output section 5U, a potential (off-potential) to the gate electrode of the second-A transistor 11ea in each pixel circuit 10 to cause the second-A transistor 11ea to be in the nonconductive state when the controller 5 receives, at the signal input section 5I, at least one of an off-signal for the first switch or an off-signal for the third switch. The controller 5 can output, from the signal output section 5U, a potential (on-potential) to the gate electrode of the second-A transistor 11ea in each pixel circuit 10 to cause the second-A transistor 11ea to be in the conductive state when the controller 5 receives, at the signal input section 5I, an on-signal for the first switch and an on-signal for the third switch.

The controller 5 outputs, from the signal output section 5U, a H signal being an off-potential signal with the off-potential to the gate electrode of the second-A transistor 11ea in each pixel circuit 10 through the first potential output signal line L1a when the controller 5 receives, at the signal input section 5I, at least one of a H signal being an off-signal to cause the first light emitter 12a to be in the non-use state or a H signal being an off-signal to cause the light emitter 12 to be in the non-emissive state. In this case, the controller 5 outputs, from the signal output section 5U, a H signal being an off-potential signal with the off-potential as the first switch control signal CTLA to the gate electrode of the second-A transistor 11ea in each pixel circuit 10 through the first potential output signal line L1a when the controller 5 receives, at the signal input section 5I, at least one of a H signal being an off-signal as the first selection setting signal SELA or a H signal being an off-signal as the emission control signal. This causes the second-A transistor 11ea to enter the nonconductive state. The controller 5 also outputs, from the signal output section 5U, a L signal being an on-potential signal with the on-potential to the gate electrode of the second-A transistor 11ea in each pixel circuit 10 through the first potential output signal line L1a when the controller 5 receives, at the signal input section 5I, a L signal being an on-signal to cause the first light emitter 12a to be in the in-use state and a L signal being an on-signal to cause the light emitter 12 to be in the emissive state. In this case, the controller 5 outputs, from the signal output section 5U, a L signal being an on-potential signal with the on-potential as the first switch control signal CTLA to the gate electrode of the second-A transistor 11ea in each pixel circuit 10 through the first potential output signal line L1a when the controller 5 receives, at the signal input section 5I, a L signal being an on-signal as the first selection setting signal SELA and a L signal being an on-signal as the emission control signal. This causes the second-A transistor 11ea to enter the conductive state.

In this structure, the controller 5 can selectively output a H signal being an off-potential signal with the off-potential or a L signal being an on-potential signal with the on-potential as the first switch control signal CTLA to the gate electrode of the second-A transistor 11ea in each pixel circuit 10 through the first potential output signal line L1a.

The controller 5 can also output, from the signal output section 5U, a potential (off-potential) to the gate electrode of the second-B transistor 11eb in each pixel circuit 10 to cause the second-B transistor 11eb to be in the nonconductive state when the controller 5 receives, at the signal input section 5I, at least one of an off-signal for the second switch or an off-signal for the third switch. The controller 5 can output, from the signal output section 5U, a potential (on-potential) to the gate electrode of the second-B transistor 11eb in each pixel circuit 10 to cause the second-B transistor 11eb to be in the conductive state when the controller 5 receives, at the signal input section 5I, an on-signal for the second switch and an on-signal for the third switch.

The controller 5 outputs, from the signal output section 5U, a H signal being an off-potential signal with the off-potential to the gate electrode of the second-B transistor 11eb in each pixel circuit 10 through the second potential output signal line L1b when the controller 5 receives, at the signal input section 5I, at least one of a H signal being an off-signal to cause the second light emitter 12b to be in the non-use state or a H signal being an off-signal to cause the light emitter 12 to be in the non-emissive state. In this case, the controller 5 outputs, from the signal output section 5U, a H signal being an off-potential signal with the off-potential as the second switch control signal CTLB to the gate electrode of the second-B transistor 11eb in each pixel circuit 10 through the second potential output signal line L1b when the controller 5 receives, at the signal input section 5I, at least one of a H signal being an off-signal as the second selection setting signal SELB or a H signal being an off-signal as the emission control signal. This causes the second-B transistor 11eb to enter the nonconductive state. The controller 5 also outputs, from the signal output section 5U, a L signal being an on-potential signal with the on-potential to the gate electrode of the second-B transistor 11eb in each pixel circuit 10 through the second potential output signal line L1b when the controller 5 receives, at the signal input section 5I, a L signal being an on-signal to cause the second light emitter 12b to be in the in-use state and a L signal being an on-signal to cause the light emitter 12 to be in the emissive state. In this case, the controller 5 outputs, from the signal output section 5U, a L signal being an on-potential signal with the on-potential as the second switch control signal CTLB to the gate electrode of the second-B transistor 11eb in each pixel circuit 10 through the second potential output signal line L1b when the controller 5 receives, at the signal input section 5I, a L signal being an on-signal as the second selection setting signal SELB and a L signal being an on-signal as the emission control signal. This causes the second-B transistor 11eb to enter the conductive state.

In this structure, the controller 5 can selectively output a H signal being an off-potential signal with the off-potential or a L signal being an on-potential signal with the on-potential as the second switch control signal CTLB to the gate electrode of the second-B transistor 11eb in each pixel circuit 10 through the second potential output signal line L1b.

In this structure, the second-A transistor 11ea may be an n-channel transistor, and the second-B transistor 11eb may be an n-channel transistor. When the second-A transistor 11ea is an n-channel transistor, the off-potential is set to a potential lower than or equal to the second power potential Vss and the on-potential is set to a potential higher than or equal to the first power potential Vdd for the second-A transistor 11ea. When the second-B transistor 11eb is an n-channel transistor, the off-potential is set to a potential lower than or equal to the second power potential Vss and the on-potential is set to a potential higher than or equal to the first power potential Vdd for the second-B transistor 11eb. In this case, the off-potential is the L potential Vgl of a L signal being an off-potential signal to cause the second transistor 11e to be in the nonconductive state (off-state). When the second power potential Vss is 0 V, the off-potential is set to about −2 to 0 V The on-potential is the H potential Vgh of a H signal being an on-potential signal to cause the second transistor 11e to be in the conductive state (on-state). When the second power potential Vdd is 8 V, the on-potential is set to 8 to about 10 V

In this case, in response to the L potential Vgl as the off-potential received at the gate electrode, the second-A transistor 11ea enters the nonconductive state, and the first light emitter 12a enters the non-emissive state. In response to the H potential Vgh as the on-potential received at the gate electrode, the second-A transistor 11ea enters the conductive state, and the first light emitter 12a enters the emissive state. In response to the L potential Vgl as the off-potential received at the gate electrode, the second-B transistor 11eb enters the nonconductive state, and the second light emitter 12b enters the non-emissive state. In response to the H potential Vgh as the on-potential received at the gate electrode, the second-B transistor 11eb enters the conductive state, and the second light emitter 12b enters the emissive state.

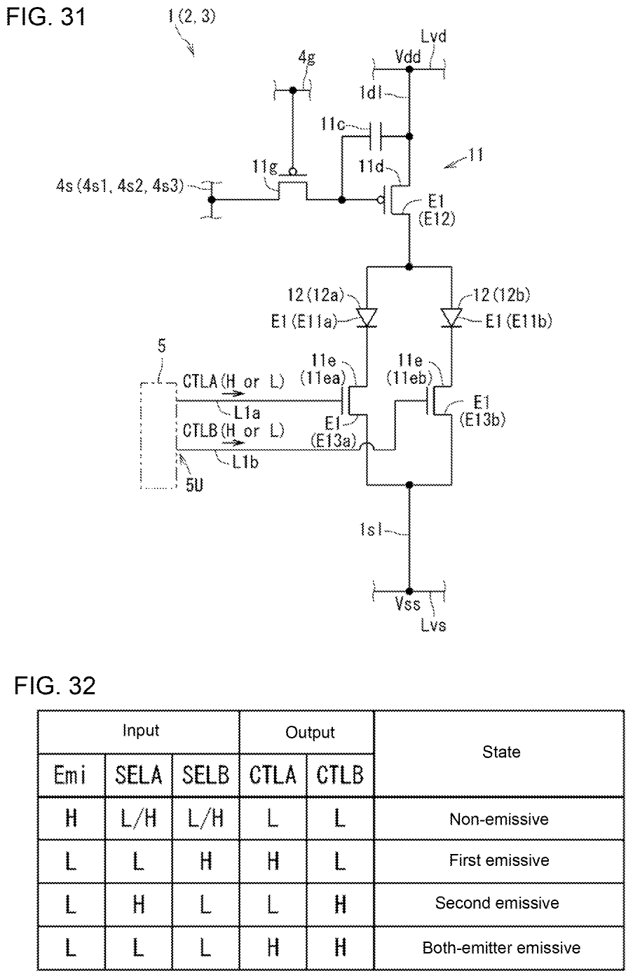

FIG. 31 is a circuit diagram of another example first subpixel circuit 1 in the seventh embodiment. In the example of the seventh embodiment as well, each of the second subpixel circuit 2 and the third subpixel circuit 3 has the same or similar structure as the first subpixel circuit 1.

The first subpixel circuit 1 in the example of the seventh embodiment is based on the first subpixel circuit 1 in the seventh embodiment illustrated in FIG. 28. In the example of the seventh embodiment, the first subpixel circuit 1 includes a second-A transistor 11ea that is an n-channel transistor connected to the negative electrode of the first light emitter 12a, instead of the second-A transistor 11ea that is a p-channel transistor. In the example of the seventh embodiment, the first subpixel circuit 1 includes a second-B transistor 11eb that is an n-channel transistor connected to the negative electrode of the second light emitter 12b, instead of the second-B transistor 11eb that is a p-channel transistor.

In the example in FIG. 31, the first transistor 11d as the second element E12, the first light emitter 12a as the first-A element E11a, and the second-A transistor 11ea as the third-A element E13a are connected in series or in cascade in this order between the first power potential input section 1d1 and the second power potential input section 1s1. The first transistor 11d as the second element E12, the second light emitter 12b as the first-B element E11b, and the second-B transistor 11eb as the third-B element E13b are connected in series or in cascade in this order between the first power potential input section 1d1 and the second power potential input section 1s1. More specifically, the first transistor 11d includes the source electrode connected to the first power potential input section 1d1. The first transistor 11d includes the drain electrode connected to the positive electrode of each of the first light emitter 12a and the second light emitter 12b. The first light emitter 12a includes the negative electrode connected to the drain electrode of the second-A transistor 11ea. The second light emitter 12b includes the negative electrode connected to the drain electrode of the second-B transistor 11eb. The second-A transistor 11ea and the second-B transistor 11eb each include the source electrode connected to the second power potential input section 1s1.

FIG. 32 is a truth table showing an example relationship between the input into the controller 5, the output from the controller 5, and the state of the first subpixel circuit 1 in the example of the seventh embodiment. In this case, the controller 5 is designed to provide various logic outputs to satisfy the relationship shown in FIG. 32 between the emission control signal input from the emission control signal line 4e, the first selection setting signal SELA being input, the second selection setting signal SELB being input, the first switch control signal CTLA output to the first potential output signal line L1a, and the second switch control signal CTLB output to the second potential output signal line L1b. The truth table in FIG. 32 is altered from the truth table shown in FIG. 30, with the L signal and the H signal interchanged for the first switch control signal CTLA and the second switch control signal CTLB.

As shown in FIG. 32, when the controller 5 receives a H signal being an off-signal as the emission control signal, the controller 5 outputs a L signal being an off-potential signal with the first potential V1 as each of the first switch control signal CTLA and the second switch control signal CTLB. In this case, the L signal being the off-potential signal with the first potential V1 is input into the gate electrode of each of the second-A transistor 11ea and the second-B transistor 11eb, thus causing these transistors to enter the nonconductive state. This causes both the first light emitter 12a and the second light emitter 12b to enter the non-emissive state.

When the controller 5 receives a L signal being an on-signal as the emission control signal, a L signal being an on-signal as the first selection setting signal SELA, and a H signal being an off-signal as the second selection setting signal SELB, the controller 5 outputs a H signal being an on-potential signal with the on-potential as the first switch control signal CTLA and a L signal being an off-potential signal with the first potential V1 as the second switch control signal CTLB. In this case, the H signal being the on-potential signal with the on-potential is input into the gate electrode of the second-A transistor 11ea, thus causing the first light emitter 12a to enter the emissive state (first emissive state). The L signal being the off-potential signal with the first potential V1 is input into the gate electrode of the second-B transistor 11eb, thus causing the second light emitter 12b to enter the non-emissive state (second non-emissive state).

When the controller 5 receives a L signal being an on-signal as the emission control signal, a H signal being an off-signal as the first selection setting signal SELA, and a L signal being an on-signal as the second selection setting signal SELB, the controller 5 outputs a L signal being an off-potential signal with the first potential V1 as the first switch control signal CTLA and a H signal being an on-potential signal with the on-potential as the second switch control signal CTLB. In this case, the L signal being the off-potential signal with the first potential V1 is input into the gate electrode of the second-A transistor 11ea, thus causing the first light emitter 12a to enter the non-emissive state (first non-emissive state). The H signal being the on-potential signal with the on-potential is input into the gate electrode of the second-B transistor 11eb, thus causing the second light emitter 12b to enter the emissive state (second emissive state).

When the controller 5 receives a L signal being an on-signal as the emission control signal, and a L signal being an on-signal as the first selection setting signal SELA and the second selection setting signal SELB, the controller 5 outputs a H signal being an on-potential signal with the on-potential as each of the first switch control signal CTLA and the second switch control signal CTLB. In this case, the H signal being the on-potential signal with the on-potential is input into the gate electrode of each of the second-A transistor 11ea and the second-B transistor 11eb, thus causing both the first light emitter 12a and the second light emitter 12b to enter the emissive state (both-emitter emissive state).

### 2-7. Eighth Embodiment

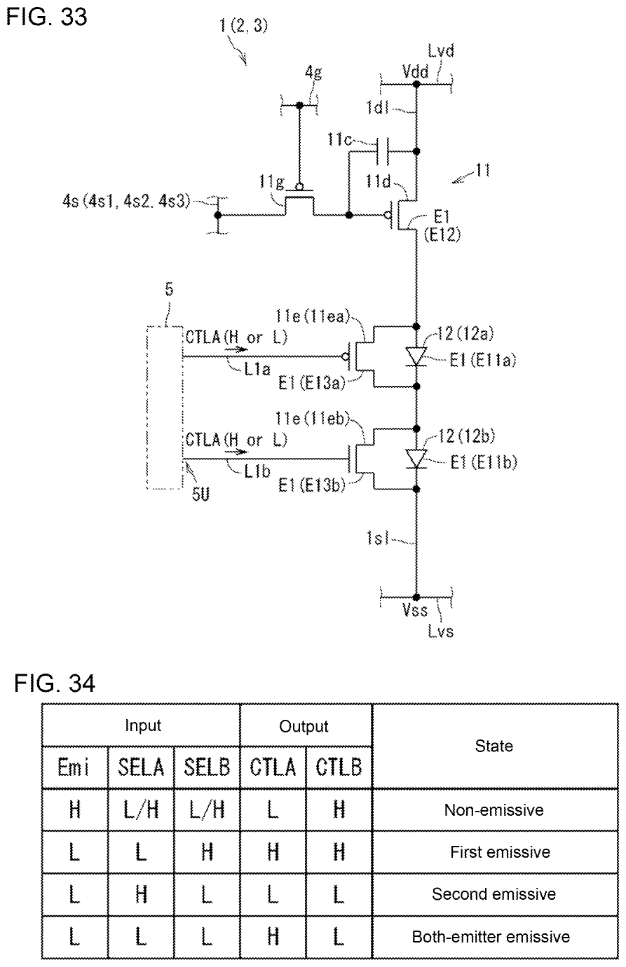

As illustrated in FIG. 33, the multiple light emitters 12 and the multiple second transistors 11e may be connected in a manner different from the manner in the seventh embodiment. In this case, the multiple light emitters 12 include a first light emitter 12a and a second light emitter 12b connected in series, instead of the first light emitter 12a and the second light emitter 12b connected in parallel. The multiple second transistors 11e include a second-A transistor 11ea connected in parallel to the first light emitter 12a and a second-B transistor 11eb connected in parallel to the second light emitter 12b, instead of the second-A transistor 11ea connected in series to the first light emitter 12a and the second-B transistor 11eb connected in series to the second light emitter 12b.

This structure also achieves the switch control over the multiple switches using the single second transistor 11e that switches one of the redundantly located two light emitters 12 between the emissive state and the non-emissive state, without increasing the number of transistors connected in cascade to the first transistor 11d. The multiple switches can set the light emitter 12 selectively to the in-use state or the non-use state and can set the light emitter 12 selectively to the emissive state or the non-emissive state. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

### Structure of Subpixel Circuit

FIG. 33 is a circuit diagram of an example first subpixel circuit 1 in an eighth embodiment. Each pixel circuit 10 includes the first subpixel circuit 1 with the same or similar structure. Each of the second subpixel circuit 2 and the third subpixel circuit 3 has the same or similar structure as the first subpixel circuit 1.

The first subpixel circuit 1 in the eighth embodiment is altered from the first subpixel circuit 1 in the seventh embodiment illustrated in FIG. 28, with the connection between the multiple light emitters 12 and the multiple second transistors 11e being changed. In this case, the first subpixel circuit 1 includes a first light emitter 12a and a second light emitter 12b connected in series as the light emitters 12, instead of the first light emitter 12a and the second light emitter 12b connected in parallel. The first subpixel circuit 1 includes a second-A transistor 11ea connected in parallel to the first light emitter 12a and a second-B transistor 11eb connected in parallel to the second light emitter 12b as the second transistors 11e, instead of the second-A transistor 11ea connected in series to the first light emitter 12a and the second-B transistor 11eb connected in series to the second light emitter 12b.

As illustrated in FIG. 33, the first transistor 11d as the second element E12, the first light emitter 12a as the first-A element E11a, and the second light emitter 12b as the first-B element E11b are connected in series between the first power potential input section 1d1 and the second power potential input section 1s1. In the example in FIG. 33, the first transistor 11d as the second element E12, the first light emitter 12a as the first-A element E11a, and the second light emitter 12b as the first-B element E11b are connected in series in this order between the first power potential input section 1d1 and the second power potential input section 1s1. More specifically, the first transistor 11d is a p-channel transistor. The first transistor 11d includes the source electrode connected to the first power potential input section 1d1. The first transistor 11d includes the drain electrode connected to the positive electrode of the first light emitter 12a. The first light emitter 12a includes the negative electrode connected to the positive electrode of the second light emitter 12b. The second light emitter 12b includes the negative electrode connected to the second power potential input section 1s1.

The second-A transistor 11ea is located on the connection line connecting the positive electrode and the negative electrode of the first light emitter 12a. The second-B transistor 11eb is located on the connection line connecting the positive electrode and the negative electrode of the second light emitter 12b. The second-A transistor 11ea may be either a p-channel transistor or an n-channel transistor. The second-B transistor 11eb may be either a p-channel transistor or an n-channel transistor. In the example in FIG. 33, the second-A transistor 11ea is a p-channel transistor, and the second-B transistor 11eb is an n-channel transistor. More specifically, the second-A transistor 11ea includes the source electrode connected to the positive electrode of the first light emitter 12a and includes the drain electrode connected to the negative electrode of the first light emitter 12a. The second-B transistor 11eb includes the drain electrode connected to the positive electrode of the second light emitter 12b and includes the source electrode connected to the negative electrode of the second light emitter 12b.

The first transistor 11d, the multiple second transistors 11e, the third transistor 11g, and the capacitor 11c are included in the emission controller 11 to control the light emission of the multiple light emitters 12.

### Controller

The controller 5 in the eighth embodiment may have the same or similar structure as the controller 5 in the seventh embodiment. In the eighth embodiment, the controller 5 functions as multiple switches that perform switch control over the second transistor 11e, in the same or similar manner as in the seventh embodiment. In this case, the controller 5 functions as multiple switches that perform switch control over the second-A transistor 11ea as the third-A element E13a. The controller 5 also functions as multiple switches that perform switch control over the second-B transistor 11eb as the third-B element E13b. The multiple switches can set the light emitter 12 selectively to the in-use state or the non-use state and can set the light emitter 12 selectively to the emissive state or the non-emissive state. For the first light emitter 12a, the multiple switches can set the first light emitter 12a selectively to the in-use state or the non-use state and can set the light emitter 12 selectively to the emissive state or the non-emissive state. For the second light emitter 12b, the multiple switches can set the second light emitter 12b selectively to the in-use state or the non-use state and can set the light emitter 12 selectively to the emissive state or the non-emissive state.

In other words, the controller 5 functions as the first switch, the second switch, and the third switch, in the same or similar manner as in the seventh embodiment. The first switch can set the first light emitter 12a selectively to the in-use state or the non-use state. The second switch can set the second light emitter 12b selectively to the in-use state or the non-use state. The third switch can set the first light emitter 12a and the second light emitter 12b as the light emitters 12 selectively to the emissive state or the non-emissive state. This allows the single second transistor 11e to easily achieve the switch control for switching selectively between the in-use state and the non-use state and also achieve the switch control over the timing of light emission for each of the redundantly located light emitters 12.

In the eighth embodiment, the signal input section 5I in the controller 5 selectively receives an on-signal or an off-signal for each of the multiple switches for the corresponding light emitters 12, in the same or similar manner as in the seventh embodiment. In this case, the signal input section 5I in the controller 5 selectively receives an on-signal or an off-signal for each of the multiple switches for the first light emitter 12a as the first-A element E11a. The signal input section 5I in the controller 5 also selectively receives an on-signal or an off-signal for each of the multiple switches for the second light emitter 12b as the first-B element E11b. In the eighth embodiment, the signal input section 5I in the controller 5 selectively receives an on-signal or an off-signal for the first switch, selectively receives an on-signal or an off-signal for the second switch, and selectively receives an on-signal or an off-signal for the third switch, in the same or similar manner as in the seventh embodiment.

The controller 5 outputs, from the signal output section 5U, a potential to the gate electrode of the second transistor 11e to cause a light emitter 12 to be in the non-emissive state when the controller 5 receives, at the signal input section 5I, an off-signal for at least one of the multiple switches for the light emitter 12. The controller 5 also outputs, from the signal output section 5U, a potential to the gate electrode of the second transistor 11e to cause a light emitter 12 to be in the emissive state when the controller 5 receives, at the signal input section 5I, an on-signal for each of the multiple switches for the light emitter 12.

In this case, the controller 5 can output, from the signal output section 5U, a potential to the gate electrode of the second-A transistor 11ea as the third-A element E13a to cause the first light emitter 12a as the first-A element E11a to be in the non-emissive state when the controller 5 receives, at the signal input section 5I, an off-signal for at least one of the multiple switches for the first light emitter 12a. The controller 5 can also output, from the signal output section 5U, a potential to the gate electrode of the second-A transistor 11ea to cause the first light emitter 12a as the first-A element E11a to be in the emissive state when the controller 5 receives, at the signal input section 5I, an on-signal for each of the multiple switches for the first light emitter 12a.

The controller 5 can also output, from the signal output section 5U, a potential to the gate electrode of the second-B transistor 11eb as the third-B element E13b to cause the second light emitter 12b as the first-B element E11b to be in the non-emissive state when the controller 5 receives, at the signal input section 5I, an off-signal for at least one of the multiple switches for the second light emitter 12b. The controller 5 can also output, from the signal output section 5U, a potential to the gate electrode of the second-B transistor 11eb to cause the second light emitter 12b as the first-B element E11b to be in the emissive state when the controller 5 receives, at the signal input section 5I, an on-signal for each of the multiple switches for the second light emitter 12b.

In the eighth embodiment, the controller 5 outputs, from the signal output section 5U, a potential (on-potential) to the gate electrode of the second-A transistor 11ea to cause the second-A transistor 11ea to be in the conductive state when the controller 5 receives, at the signal input section 5I, at least one of an off-signal for the first switch or an off-signal for the third switch. The controller 5 outputs, from the signal output section 5U, a potential (off-potential) to the gate electrode of the second-A transistor 11ea to cause the second-A transistor 11ea to be in the nonconductive state when the controller 5 receives, at the signal input section 5I, an on-signal for the first switch and an on-signal for the third switch.

The controller 5 outputs, from the signal output section 5U, a L signal being an on-potential signal with the on-potential to the gate electrode of the second-A transistor 11ea through the first potential output signal line L1a when the controller 5 receives, at the signal input section 5I, at least one of a H signal being an off-signal to cause the first light emitter 12a to be in the non-use state or a H signal being an off-signal to cause the light emitter 12 to be in the non-emissive state. In this case, the controller 5 outputs, from the signal output section 5U, a L signal being an on-potential signal with the on-potential as the first switch control signal CTLA to the gate electrode of the second-A transistor 11ea through the first potential output signal line L1a when the controller 5 receives, at the signal input section 5I, at least one of a H signal being an off-signal as the first selection setting signal SELA or a H signal being an off-signal as the emission control signal. This causes the second-A transistor 11ea to enter the conductive state. The controller 5 also outputs, from the signal output section 5U, a H signal being an off-potential signal with the off-potential to the gate electrode of the second-A transistor 11ea through the first potential output signal line L1a when the controller 5 receives, at the signal input section 5I, a L signal being an on-signal to cause the first light emitter 12a to be in the in-use state and a L signal being an on-signal to cause the light emitter 12 to be in the emissive state. In this case, the controller 5 outputs, from the signal output section 5U, a H signal being an off-potential signal with the off-potential as the first switch control signal CTLA to the gate electrode of the second-A transistor 11ea through the first potential output signal line L1a when the controller 5 receives, at the signal input section 5I, a L signal being an on-signal as the first selection setting signal SELA and a L signal being an on-signal as the emission control signal. This causes the second-A transistor 11ea to enter the nonconductive state.

In this structure, the controller 5 can selectively output a L signal being an on-potential signal with the on-potential or a H signal being an off-potential signal with the off-potential as the first switch control signal CTLA to the gate electrode of the second-A transistor 11ea through the first potential output signal line L1a. This allows the single second-A transistor 11ea to easily achieve the switch control for switching selectively between the in-use state and the non-use state and also achieve the switch control over the timing of light emission for the first light emitter 12a of the redundantly located two light emitters 12.

The controller 5 also outputs, from the signal output section 5U, a potential (on-potential) to the gate electrode of the second-B transistor 11eb to cause the second-B transistor 11eb to be in the conductive state when the controller 5 receives, at the signal input section 5I, at least one of an off-signal for the second switch or an off-signal for the third switch. The controller 5 outputs, from the signal output section 5U, a potential (off-potential) to the gate electrode of the second-B transistor 11eb to cause the second-B transistor 11eb to be in the nonconductive state when the controller 5 receives, at the signal input section 5I, an on-signal for the second switch and an on-signal for the third switch.

The controller 5 outputs, from the signal output section 5U, a H signal being an on-potential signal with the on-potential to the gate electrode of the second-B transistor 11eb through the second potential output signal line L1b when the controller 5 receives, at the signal input section 5I, at least one of a H signal being an off-signal to cause the second light emitter 12b to be in the non-use state or a H signal being an off-signal to cause the light emitter 12 to be in the non-emissive state. In this case, the controller 5 outputs, from the signal output section 5U, a H signal being an on-potential signal with the on-potential as the second switch control signal CTLB to the gate electrode of the second-B transistor 11eb through the second potential output signal line Lib when the controller 5 receives, at the signal input section 5I, at least one of a H signal being an off-signal as the second selection setting signal SELB or a H signal being an off-signal as the emission control signal. This causes the second-B transistor 11eb to enter the conductive state. The controller 5 also outputs, from the signal output section 5U, a L signal being an off-potential signal with the off-potential to the gate electrode of the second-B transistor 11eb through the second potential output signal line L1b when the controller 5 receives, at the signal input section 5I, a L signal being an on-signal to cause the second light emitter 12b to be in the in-use state and a L signal being an on-signal to cause the light emitter 12 to be in the emissive state. In this case, the controller 5 outputs, from the signal output section 5U, a L signal being an off-potential signal with the off-potential as the second switch control signal CTLB to the gate electrode of the second-B transistor 11eb through the second potential output signal line L1b when the controller 5 receives, at the signal input section 5I, a L signal being an on-signal as the second selection setting signal SELB and a L signal being an on-signal as the emission control signal. This causes the second-B transistor 11eb to enter the nonconductive state.

In this structure, the controller 5 can selectively output a H signal being an on-potential signal with the on-potential or a L signal being an off-potential signal with the off-potential as the second switch control signal CTLB to the gate electrode of the second-B transistor 11eb through the second potential output signal line L1b. This allows the single second-B transistor 11eb to easily achieve the switch control for switching selectively between the in-use state and the non-use state and also achieve the switch control over the timing of light emission for the second light emitter 12b of the redundantly located two light emitters 12.

FIG. 34 is a truth table showing an example relationship between the input into the controller 5, the output from the controller 5, and the state of the first subpixel circuit 1. In this case, the controller 5 is designed to provide various logic outputs to satisfy the relationship shown in FIG. 34 between the emission control signal input from the emission control signal line 4e, the first selection setting signal SELA being input, the second selection setting signal SELB being input, the first switch control signal CTLA output to the first potential output signal line L1a, and the second switch control signal CTLB output to the second potential output signal line L1b. The truth table in FIG. 34 is altered from the truth table shown in FIG. 30, with the L signal and the H signal interchanged for the first switch control signal CTLA.

As illustrated in FIG. 34, when the controller 5 receives a H signal being an off-signal as the emission control signal, the controller 5 outputs a L signal being an on-potential signal as the first switch control signal CTLA and a H signal being an on-potential signal as the second switch control signal CTLB. In this case, the second-A transistor 11ea and the second-B transistor 11eb both enter the conductive state. This causes both the first light emitter 12a and the second light emitter 12b to enter the non-emissive state.

When the controller 5 receives a L signal being an on-signal as the emission control signal, a L signal being an on-signal as the first selection setting signal SELA, and a H signal being an off-signal as the second selection setting signal SELB, the controller 5 outputs a H signal being an off-potential signal as the first switch control signal CTLA and a H signal being an on-potential signal as the second switch control signal CTLB. In this case, the second-A transistor 11ea enters the nonconductive state, and the second-B transistor 11eb enters the conductive state. This causes the first light emitter 12a to enter the emissive state (first emissive state), and the second light emitter 12b to enter the non-emissive state (second non-emissive state).

When the controller 5 receives a L signal being an on-signal as the emission control signal, a H signal being an off-signal as the first selection setting signal SELA, and a L signal being an on-signal as the second selection setting signal SELB, the controller 5 outputs a L signal being an on-potential signal as the first switch control signal CTLA and a L signal being an off-potential signal as the second switch control signal CTLB. In this case, the second-A transistor 11ea enters the conductive state, and the second-B transistor 11eb enters the nonconductive state. This causes the first light emitter 12a to enter the non-emissive state (first non-emissive state), and the second light emitter 12b to enter the emissive state (second emissive state).

When the controller 5 receives a L signal being an on-signal as the emission control signal, a L signal being an on-signal as the first selection setting signal SELA, and a L signal being an on-signal as the second selection setting signal SELB, the controller 5 outputs a H signal being an off-potential signal as the first switch control signal CTLA and a L signal being an off-potential signal as the second switch control signal CTLB. In this case, the second-A transistor 11ea and the second-B transistor 11eb enter the nonconductive state. This causes both the first light emitter 12a and the second light emitter 12b to enter the emissive state (both-emitter emissive state).

In this structure, the first selection setting signal SELA and the second selection setting signal SELB may be output to the controller 5 from the signal output circuit 6 with the same or similar structure as in the second embodiment.

In the first subpixel circuit 1, the first transistor 11d may be connected in cascade to the second-A transistor 11ea and the second-B transistor 11eb as the second transistors 11e and may not be connected in cascade to another element between the first power potential input section 1d1 and the second power potential input section 1s1. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the first light emitter 12a and the second light emitter 12b. This reduces gradations (uneven luminance), or a gradual decrease in the luminance of the display device 100, thus improving the image quality of the display device 100.

### Variations of Eighth Embodiment

In the above structure, each pixel circuit 10 may include a single controller 5 and a single signal output circuit 6 for a set of the first subpixel circuit 1, the second subpixel circuit 2, and the third subpixel circuit 3. In other words, each pixel circuit 10 may include the controller 5 to selectively output, to each of the first subpixel circuit 1, the second subpixel circuit 2, and the third subpixel circuit 3, a potential to cause the light emitter 12 to be in the non-emissive state or a potential to cause the light emitter 12 to be in the emissive state. In this case, as illustrated in FIG. 16, each of the first potential output signal line L1a and the second potential output signal line Lib connected to the controller 5 may be connected to the subpixel circuits 1, 2, and 3. This structure includes fewer controllers 5 for each pixel circuit 10, avoiding size increase of the pixel circuit 10. The display device 100 and the display panel loop can thus include multiple pixel circuits 10 arranged with narrower pitches to improve resolution. The display device 100 can thus have higher image quality.

The display panel 100p may include a single controller 5 and a single signal output circuit 6 for multiple pixel circuits 10, in the same or similar manner as in the seventh embodiment. In other words, the display panel 100p may include the controller 5 for each set of multiple pixel circuits 10 to selectively output a potential to cause the light emitter 12 to be in the non-emissive state or a potential to cause the light emitter 12 to be in the emissive state. In this case, the controller 5 and the signal output circuit 6 may be located in an open area in the image display 300 or the frame portion on the first surface F1 of the substrate 20, or may be located on the second surface F2 of the substrate 20.

In this case, the controller 5 can output, from the signal output section 5U, a potential to the gate electrode of the second transistor 11e in each pixel circuit 10 to cause a light emitter 12 to be in the non-emissive state when the controller 5 receives, at the signal input section 5I, an off-signal for at least one of the multiple switches for the light emitter 12, in the same or similar manner as in the seventh embodiment. The controller 5 can also output, from the signal output section 5U, a potential to the gate electrode of the second transistor 11e in each pixel circuit 10 to cause a light emitter 12 to be in the emissive state when the controller 5 receives, at the signal input section 5I, an on-signal for each of the multiple switches for the light emitter 12.

The controller 5 and the signal output circuit 6 may be located for a set of pixel circuits 10 in each row. As illustrated in FIG. 17, each of the first potential output signal line L1a and the second potential output signal line L1b connected to the controller 5 may be connected to multiple pixel circuits 10. More specifically, the first potential output signal line L1a and the second potential output signal line L1b connected to the controller 5 may each be connected to the subpixel circuits 1, 2, and 3 in each pixel circuit 10. This structure includes a single controller 5 and a single signal output circuit 6 for each set of multiple pixel circuits 10, avoiding size increase of the pixel circuits 10. The display device 100 and the display panel 100p can thus include multiple pixel circuits 10 arranged with narrower pitches to improve resolution. The display device 100 can thus have higher image quality.

In this case, the controller 5 can output, from the signal output section 5U, a potential to the gate electrode of the second-A transistor 11ea as the third-A element E13a in each pixel circuit 10 to cause the first light emitter 12a as the first-A element E11a to be in the non-emissive state when the controller 5 receives, at the signal input section 5I, an off-signal for at least one of the multiple switches for the first light emitter 12a, in the same or similar manner as in the seventh embodiment. The controller 5 can also output, from the signal output section 5U, a potential to the gate electrode of the second-A transistor 11ea in each pixel circuit 10 to cause the first light emitter 12a as the first-A element E11a to be in the emissive state when the controller 5 receives, at the signal input section 5I, an on-signal for each of the multiple switches for the first light emitter 12a.

The controller 5 can also output, from the signal output section 5U, a potential to the gate electrode of the second-B transistor 11eb as the third-B element E13b in each pixel circuit 10 to cause the second light emitter 12b as the first-B element E11b to be in the non-emissive state when the controller 5 receives, at the signal input section 5I, an off-signal for at least one of the multiple switches for the second light emitter 12b. The controller 5 can also output, from the signal output section 5U, a potential to the gate electrode of the second-B transistor 11eb in each pixel circuit 10 to cause the second light emitter 12b as the first-B element E11b to be in the emissive state when the controller 5 receives, at the signal input section 5I, an on-signal for each of the multiple switches for the second light emitter 12b.

More specifically, the controller 5 can output, from the signal output section 5U, a potential (on-potential) to the gate electrode of the second-A transistor 11ea in each pixel circuit 10 to cause the second-A transistor 11ea to be in the conductive state when the controller 5 receives, at the signal input section 5I, at least one of an off-signal for the first switch or an off-signal for the third switch. The controller 5 can output, from the signal output section 5U, a potential (off-potential) to the gate electrode of the second-A transistor 11ea in each pixel circuit 10 to cause the second-A transistor 11ea to be in the nonconductive state when the controller 5 receives, at the signal input section 5I, an on-signal for the first switch and an on-signal for the third switch.

The controller 5 outputs, from the signal output section 5U, a L signal being an on-potential signal with the on-potential to the gate electrode of the second-A transistor 11ea in each pixel circuit 10 through the first potential output signal line L1a when the controller 5 receives, at the signal input section 5I, at least one of a H signal being an off-signal to cause the first light emitter 12a to be in the non-use state or a H signal being an off-signal to cause the light emitter 12 to be in the non-emissive state. In this case, the controller 5 outputs, from the signal output section 5U, a L signal being an on-potential signal with the on-potential as the first switch control signal CTLA to the gate electrode of the second-A transistor 11ea in each pixel circuit 10 through the first potential output signal line L1a when the controller 5 receives, at the signal input section 5I, at least one of a H signal being an off-signal as the first selection setting signal SELA or a H signal being an off-signal as the emission control signal. This causes the second-A transistor 11ea to enter the conductive state. The controller 5 also outputs, from the signal output section 5U, a H signal being an off-potential signal with the off-potential to the gate electrode of the second-A transistor 11ea in each pixel circuit 10 through the first potential output signal line L1a when the controller 5 receives, at the signal input section 5I, a L signal being an on-signal to cause the first light emitter 12a to be in the in-use state and a L signal being an on-signal to cause the light emitter 12 to be in the emissive state. In this case, the controller 5 outputs, from the signal output section 5U, a H signal being an off-potential signal with the off-potential as the first switch control signal CTLA to the gate electrode of the second-A transistor 11ea in each pixel circuit 10 through the first potential output signal line L1a when the controller 5 receives, at the signal input section 5I, a L signal being an on-signal as the first selection setting signal SELA and a L signal being an on-signal as the emission control signal. This causes the second-A transistor 11ea to enter the nonconductive state.

In this structure, the controller 5 can selectively output a H signal being an off-potential signal with the off-potential or a L signal being an on-potential signal with the on-potential as the first switch control signal CTLA to the gate electrode of the second-A transistor 11ea in each pixel circuit 10 through the first potential output signal line L1a.

The controller 5 can output, from the signal output section 5U, a potential (on-potential) to the gate electrode of the second-B transistor 11eb in each pixel circuit 10 to cause the second-B transistor 11eb to be in the conductive state when the controller 5 receives, at the signal input section 5I, at least one of an off-signal for the second switch or an off-signal for the third switch. The controller 5 can output, from the signal output section 5U, a potential (off-potential) to the gate electrode of the second-B transistor 11eb in each pixel circuit 10 to cause the second-B transistor 11eb to be in the nonconductive state when the controller 5 receives, at the signal input section 5I, an on-signal for the second switch and an on-signal for the third switch.

The controller 5 outputs, from the signal output section 5U, a H signal being an on-potential signal with the on-potential to the gate electrode of the second-B transistor 11eb in each pixel circuit 10 through the second potential output signal line L1b when the controller 5 receives, at the signal input section 5I, at least one of a H signal being an off-signal to cause the second light emitter 12b to be in the non-use state or a H signal being an off-signal to cause the light emitter 12 to be in the non-emissive state. In this case, the controller 5 outputs, from the signal output section 5U, a H signal being an on-potential signal with the on-potential as the second switch control signal CTLB to the gate electrode of the second-B transistor 11eb in each pixel circuit 10 through the second potential output signal line L1b when the controller 5 receives, at the signal input section 5I, at least one of a H signal being an off-signal as the second selection setting signal SELB or a H signal being an off-signal as the emission control signal. This causes the second-B transistor 11eb to enter the conductive state. The controller 5 also outputs, from the signal output section 5U, a L signal being an off-potential signal with the off-potential to the gate electrode of the second-B transistor 11eb in each pixel circuit 10 through the second potential output signal line L1b when the controller 5 receives, at the signal input section 5I, a L signal being an on-signal to cause the second light emitter 12b to be in the in-use state and a L signal being an on-signal to cause the light emitter 12 to be in the emissive state. In this case, the controller 5 outputs, from the signal output section 5U, a L signal being an off-potential signal with the off-potential as the second switch control signal CTLB to the gate electrode of the second-B transistor 11eb in each pixel circuit 10 through the second potential output signal line L1b when the controller 5 receives, at the signal input section 5I, a L signal being an on-signal as the second selection setting signal SELB and a L signal being an on-signal as the emission control signal. This causes the second-B transistor 11eb to enter the nonconductive state.

In this structure, the controller 5 can selectively output a L signal being an off-potential signal with the off-potential or a H signal being an on-potential signal with the on-potential as the second switch control signal CTLB to the gate electrode of the second-B transistor 11eb in each pixel circuit 10 through the second potential output signal line L1b.

When the second-A transistor 11ea is an n-channel transistor, the on-potential is set to a potential higher than or equal to the first power potential Vdd, and the off-potential is set to a potential lower than or equal to the second power potential Vss. More specifically, the on-potential is the H potential Vgh of a H signal being an on-potential signal to cause the second-A transistor 11ea to be in the conductive state (on-state). The off-potential is the L potential Vgl of a L signal being an off-potential signal to cause the second-A transistor 11ea to be in the nonconductive state (off-state). In this case, in response to a H signal with the on-potential received at the gate electrode, the second-A transistor 11ea enters the conductive state, and the first light emitter 12a enters the non-emissive state. In response to a L signal with the off-potential received at the gate electrode, the second-A transistor 11ea enters the nonconductive state and the first light emitter 12a enters the emissive state.

When the second-B transistor 11eb is a p-channel transistor, the on-potential is set to a potential lower than or equal to the second power potential Vss, and the off-potential is set to a potential higher than or equal to the first power potential Vdd. More specifically, the on-potential is the L potential Vgl of a L signal being an on-potential signal to cause the second-B transistor 11eb to be in the conductive state (on-state). The off-potential is the H potential Vgh of a H signal being an off-potential signal to cause the second-B transistor 11eb to be in the nonconductive state (off-state). In this case, in response to a L signal with the on-potential received at the gate electrode, the second-B transistor 11eb enters the conductive state, and the second light emitter 12b enters the non-emissive state. In response to a H signal with the off-potential received at the gate electrode, the second-B transistor 11eb enters the nonconductive state, and the second light emitter 12b enters the emissive state.

### 2-8. Ninth Embodiment

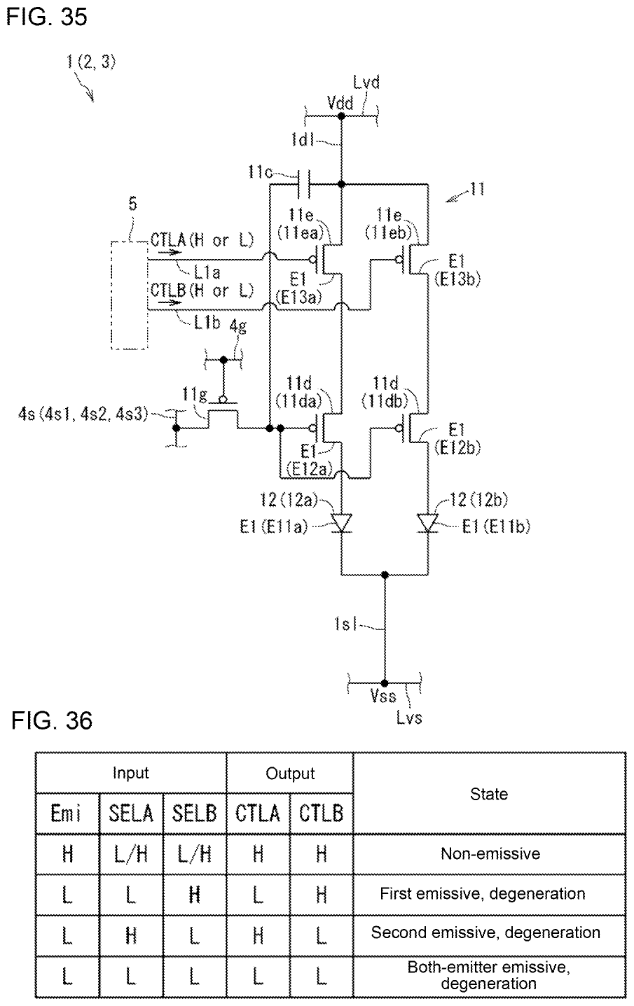

As illustrated in FIG. 35, the second transistor 11e may be connected in cascade to the first transistor 11d with the source electrode of the first transistor 11d in the seventh embodiment. The second transistor 11e, which is connected in cascade to the first transistor 11d with the source electrode of the first transistor 11d, has a resistance when the second transistor 11e is in the conductive state in which the light emitter 12 is in the emissive state. The second transistor 11e can thus function as a degeneration resistance as an analog device, as well as achieving the switch control over the multiple switches. This allows an approximately linear relationship between the gate voltage Vgs and the drain current Ids in the first transistor 11d. The drain current Ids of the first transistor 11d can thus be finely adjusted easily by changing the gate voltage Vgs. The display device 100 can thus have higher image quality. The structure also allows the second transistor 11e to effectively serve as a degeneration resistance for the first transistor 11d without increasing the number of transistors connected in cascade to the first transistor 11d. This avoids a lower drain-source voltage Vds of the first transistor 11d with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the light emitter 12. This reduces gradations (uneven luminance), or a gradual decrease in the luminance of the display device 100, thus improving the image quality of the display device 100.

### Structure of Subpixel Circuit

FIG. 35 is a circuit diagram of an example first subpixel circuit 1 in a ninth embodiment. Each pixel circuit 10 includes the first subpixel circuit 1 with the same or similar structure. Each of the second subpixel circuit 2 and the third subpixel circuit 3 has the same or similar structure as the first subpixel circuit 1.

The first subpixel circuit 1 in the ninth embodiment is altered from the first subpixel circuit 1 in the seventh embodiment illustrated in FIG. 28. In the ninth embodiment, the first subpixel circuit 1 includes multiple first transistors 11d instead of the single first transistor 11d. In the ninth embodiment, the first subpixel circuit 1 includes the second transistors 11e each connected in cascade to the corresponding first transistor 11d with the source electrode, not with the drain electrode, of the first transistor 11d. Further, in the ninth embodiment, the first subpixel circuit 1 includes the capacitor 11c located on the connection line connecting the gate electrode of the first transistor 11d and one of the source electrode or the drain electrode of the second transistor 11e not connected to the first transistor 11d.

In the ninth embodiment, the first subpixel circuit 1 includes a first set of elements E1 and a second set of elements E1 connected in series or in cascade between the first power potential input section 1d1 and the second power potential input section 1s1.

The first set of elements E1 includes the first light emitter 12a as the first-A element E11a, the first-A transistor 11da as the second-A element E12a, and the second-A transistor 11ea as the third-A element E13a. In the example in FIG. 35, the second-A transistor 11ea as the third-A element E13a, the first-A transistor 11da as the second-A element E12a, and the first light emitter 12a as the first-A element E11a are connected in series or in cascade in this order between the first power potential input section 1d1 and the second power potential input section 1s1.

The second set of elements E1 includes the second light emitter 12b as the first-B element E11b, the first-B transistor 11db as the second-B element E12b, and the second-B transistor 11eb as the third-B element E13b. In the example in FIG. 35, the second-B transistor 11eb as the third-B element E13b, the first-B transistor 11db as the second-B element E12b, and the second light emitter 12b as the first-B element E11b are connected in series or in cascade in this order between the first power potential input section 1d1 and the second power potential input section 1s1.

In other words, in the example in FIG. 35, the first set of elements E1 connected in series or in cascade and the second set of elements E1 connected in series or in cascade are connected in parallel between the first power potential input section 1d1 and the second power potential input section 1s1.

In the ninth embodiment, as illustrated in FIG. 35, the first subpixel circuit 1 includes multiple light emitters 12, multiple first transistors 11d, and multiple second transistors 11e. The multiple light emitters 12 include a first light emitter 12a and a second light emitter 12b connected in parallel. The multiple first transistors 11d include a first-A transistor 11da and a first-B transistor 11db. The first-A transistor 11da is connected in series to the first light emitter 12a. The first-B transistor 11db is connected in series to the second light emitter 12b. The multiple second transistors 11e include a second-A transistor 11ea and a second-B transistor 11eb. The second-A transistor 11ea is connected in cascade to the first-A transistor 11da. The second-B transistor 11eb is connected in cascade to the first-B transistor 11db. The second-A transistor 11ea is connected in cascade to the first-A transistor 11da with the source electrode of the first-A transistor 11da. The second-B transistor 11eb is connected in cascade to the first-B transistor 11db with the source electrode of the first-B transistor 11db.

In this structure, the second-A transistor 11ea connected in series to the first light emitter 12a can function as a degeneration resistance, and the second-B transistor 11eb connected in series to the second light emitter 12b can function as a degeneration resistance. This allows an approximately linear relationship between the gate voltage and the drain current in each of the first-A transistor 11da and the first-B transistor 11db. The drain current Ids of each of the first-A transistor 11da and the first-B transistor 11db can thus be finely adjusted easily by changing the gate voltage Vgs. The display device 100 can thus have higher image quality.

The structure includes two sets of elements E1 connected in series or in cascade between the first power potential input section 1d1 and the second power potential input section 1s1. A first set of elements E1 will now be described. The first subpixel circuit 1 includes the first light emitter 12a as the first-A element E11a, the first-A transistor 11da as the second-A element E12a, and the second-A transistor 11ea as the third-A element E13a. The first-A transistor 11da connected in series to the first light emitter 12a can control a current flowing through the first light emitter 12a in response to a potential corresponding to an image signal received at the gate electrode. The second-A transistor 11ea is connected in cascade to the first-A transistor 11da to switch the first light emitter 12a between the emissive state and the non-emissive state. The second-A transistor 11ea is connected in cascade to the first-A transistor 11da with the source electrode of the first-A transistor 11da.

The two sets of elements E1 connected in series or in cascade between the first power potential input section 1d1 and the second power potential input section 1s1 include the second set of elements E1. In this case, the first subpixel circuit 1 includes the second light emitter 12b as the first-B element E11b, the first-B transistor 11db as the second-B element E12b, and the second-B transistor 11eb as the third-B element E13b. The first-B transistor 11db connected in series to the first light emitter 12a can control a current flowing through the second light emitter 12b in response to a potential corresponding to an image signal received at the gate electrode. The second-B transistor 11eb is connected in cascade to the first-B transistor 11db to switch the second light emitter 12b between the emissive state and the non-emissive state. The second-B transistor 11eb is connected in cascade to the first-B transistor 11db with the source electrode of the first-B transistor 11db.

In this example, the first-A transistor 11da, the first-B transistor 11db, the second-A transistor 11ea, and the second-B transistor 11eb are p-channel transistors. In this case, the second-A transistor 11ea includes the source electrode connected to the first power potential input section 1d1. The second-A transistor 11ea includes the drain electrode connected to the source electrode of the first-A transistor 11da. The first-A transistor 11da includes the drain electrode connected to the positive electrode of the first light emitter 12a. The first light emitter 12a includes the negative electrode connected to the second power potential input section 1s1. The second-B transistor 11eb includes the source electrode connected to the first power potential input section 1d1. The second-B transistor 11eb includes the drain electrode connected to the source electrode of the first-B transistor 11db. The first-B transistor 11db includes the drain electrode connected to the positive electrode of the second light emitter 12b. The second light emitter 12b includes the negative electrode connected to the second power potential input section 1s1.

The third transistor 11g includes the drain electrode (source electrode) connected to the gate electrode of each of the first-A transistor 11da and the first-B transistor 11db. In response to an on-potential signal as a scanning signal from the scanning signal line 4g received at the gate electrode, the third transistor 11g enters the conductive state in which a current flows between the source electrode and the drain electrode. This allows an image signal from the first image signal line 4s1 to be input into the gate electrode of each of the first-A transistor 11da and the first-B transistor 11db through the third transistor 11g. When the third transistor 11g is a p-channel transistor, an on-potential signal is a L signal with the L potential Vgl. In the second subpixel circuit 2, an image signal is input from the second image signal line 4s2 instead of the first image signal line 4s1. In the third subpixel circuit 3, an image signal is input from the third image signal line 4s3 instead of the first image signal line 4s1.

The capacitor 11c is located on the connection line connecting the gate electrode of the first-A transistor 11da and the source electrode of the second-A transistor 11ea and connecting the gate electrode of the first-B transistor 11db and the source electrode of the second-B transistor 11eb. The capacitor 11e retains the potential Vsig of the image signal input into the gate electrodes of the first-A transistor 11da and the first-B transistor 11db for a period (period of one frame) until the next image signal is input (or until refreshing occurs).

The multiple first transistors 11d, the multiple second transistors 11e, the third transistor 11g, and the capacitor 11c are included in the emission controller 11 to control the light emission of the multiple light emitters 12.

In the first subpixel circuit 1, the first-A transistor 11da (one of the first transistors 11d) may be connected in cascade to the second-A transistor 11ea (one of the second transistors 11e) and may not be connected in cascade to another element between the first power potential input section 1d1 and the second power potential input section 1s1. The first-B transistor 11db (the other first transistor 11d) may be connected in cascade to the second-B transistor 11eb (the other second transistor 11e) and may not be connected in cascade to another element between the first power potential input section 1d1 and the second power potential input section 1s1. This avoids a lower drain-source voltage Vds of each of the first-A transistor 11da and the first-B transistor 11db with the potential difference (Vdd−Vss) between the first power potential Vdd and the second power potential Vss. Thus, the conditions for the first transistor 11d to operate in the saturation region are less likely to be stricter in response to a decrease in the potential difference (Vdd−Vss) resulting from, for example, a decrease in the first power potential Vdd or in response to an increase in the forward voltage applied to the first light emitter 12a and the second light emitter 12b. This reduces gradations (uneven luminance), or a gradual decrease in the luminance of the display device 100, thus improving the image quality of the display device 100.

### Controller

The controller 5 in the ninth embodiment may have the same or similar structure as the controller 5 in the seventh embodiment.

FIG. 36 is a truth table showing an example relationship between the input into the controller 5, the output from the controller 5, and the state of the first subpixel circuit 1. In this case, the controller 5 is designed to provide various logic outputs to satisfy the relationship shown in FIG. 36 between the emission control signal input from the emission control signal line 4e, the first selection setting signal SELA being input, the second selection setting signal SELB being input, the first switch control signal CTLA output to the first potential output signal line L1a, and the second switch control signal CTLB output to the second potential output signal line L1b. The truth table in FIG. 36 is altered from the truth table in FIG. 30, with the state of the first subpixel circuit 1 additionally including a state in which the second transistor 11e serves as a degeneration resistance for the first transistor 11d. The controller 5 may include a combination of multiple logic circuits.

As shown in FIG. 36, when the controller 5 receives a H signal being an off-signal as the emission control signal, the controller 5 outputs a H signal being an off-potential signal with the first potential V1 as each of the first switch control signal CTLA and the second switch control signal CTLB. In this case, the H signal being the off-potential signal with the first potential V1 is input into the gate electrode of each of the second-A transistor 11ea and the second-B transistor 11eb, thus causing these transistors to enter the nonconductive state. This causes both the first light emitter 12a and the second light emitter 12b to enter the non-emissive state.

When the controller 5 receives a L signal being an on-signal as the emission control signal, a L signal being an on-signal as the first selection setting signal SELA, and a H signal being an off-signal as the second selection setting signal SELB, the controller 5 outputs a L signal being an on-potential signal with the on-potential as the first switch control signal CTLA and a H signal being an off-potential signal with the first potential V1 as the second switch control signal CTLB. In this case, the L signal being the on-potential signal with the on-potential is input into the gate electrode of the second-A transistor 11ea, thus causing the second-A transistor 11ea to enter the conductive state. This causes the first light emitter 12a to enter the emissive state (first emissive state). The H signal being the off-potential signal with the first potential V1 is input into the gate electrode of the second-B transistor 11eb, thus causing the second-B transistor 11eb to enter the nonconductive state. This causes the second light emitter 12b to enter the non-emissive state (second non-emissive state). In this state, the second-A transistor lea serves as a degeneration resistance for the first-A transistor 11da.

When the controller 5 receives a L signal being an on-signal as the emission control signal, a H signal being an off-signal as the first selection setting signal SELA, and a L signal being an on-signal as the second selection setting signal SELB, the controller 5 outputs a H signal being an off-potential signal with the first potential V1 as the first switch control signal CTLA and a L signal being an on-potential signal with the on-potential as the second switch control signal CTLB. In this case, the H signal being the off-potential signal with the first potential V1 is input into the gate electrode of the second-A transistor 11ea, thus causing the second-A transistor 11ea to enter the nonconductive state. This causes the first light emitter 12a to enter the non-emissive state (first non-emissive state). The L signal being the on-potential signal with the on-potential is input into the gate electrode of the second-B transistor 11eb, thus causing the second-B transistor 11eb to enter the conductive state. This causes the second light emitter 12b to enter the emissive state (second emissive state). In this state, the second-B transistor 11eb serves as a degeneration resistance for the first-B transistor 11db.

When the controller 5 receives a L signal being an on-signal as the emission control signal, a L signal being an on-signal as the first selection setting signal SELA, and a L signal being an on-signal as the second selection setting signal SELB, the controller 5 outputs a L signal being an on-potential signal with the on-potential as each of the first switch control signal CTLA and the second switch control signal CTLB. In this case, the L signal being the on-potential signal with the on-potential is input into the gate electrode of each of the second-A transistor 11ea and the second-B transistor 11eb, thus causing these transistors to enter the conductive state. This causes both the first light emitter 12a and the second light emitter 12b to enter the emissive state (both-emitter emissive state). In this state, the second-A transistor 11ea serves as a degeneration resistance for the first-A transistor 11da, and the second-B transistor 11eb serves as a degeneration resistance for the first-B transistor 11db.

The first selection setting signal SELA and the second selection setting signal SELB may be output to the controller 5 from the signal output circuit 6 with the same or similar structure as in the second embodiment.

### Variations of Ninth Embodiment

In the above structure, the second-A transistor 11ea may be an n-channel transistor, and the second-B transistor 11eb may be an n-channel transistor. When the second-A transistor 11ea is an n-channel transistor, the off-potential is set to a potential lower than or equal to the second power potential Vss and the on-potential is set to a potential higher than or equal to the first power potential Vdd for the second-A transistor 11ea. When the second-B transistor 11eb is an n-channel transistor, the off-potential is set to a potential lower than or equal to the second power potential Vss and the on-potential is set to a potential higher than or equal to the first power potential Vdd for the second-B transistor 11eb. In this case, the off-potential is the L potential Vgl of a L signal being an off-potential signal to cause the second transistor 11e to be in the nonconductive state (off-state). When the second power potential Vss is 0 V, the off-potential is set to about −2 to 0 V. The on-potential is the H potential Vgh of a H signal being an on-potential signal to cause the second transistor 11e to be in the conductive state (on-state). When the second power potential Vdd is 8 V, the on-potential is set to 8 to about 10 V.

### 3. Others

In each of the above embodiments, the emission controller 11 may be replaced with any of various other circuits as appropriate.

### First Variation of Emission Controller

In each of the above embodiments, the first transistor 11d in any of the first subpixel circuit 1, the second subpixel circuit 2, or the third subpixel circuit 3 may be an n-channel transistor. In this case, the multiple elements E1 connected in series or in cascade may be arranged between the first power line Lvd and the second power line Lvs in the order opposite to the order in each of the above embodiments. In this case, the first subpixel circuit 1, the second subpixel circuit 2, and the third subpixel circuit 3 may have the same or similar circuit structure. In the example described below, the first transistor 11d in the first subpixel circuit 1 is an n-channel transistor.

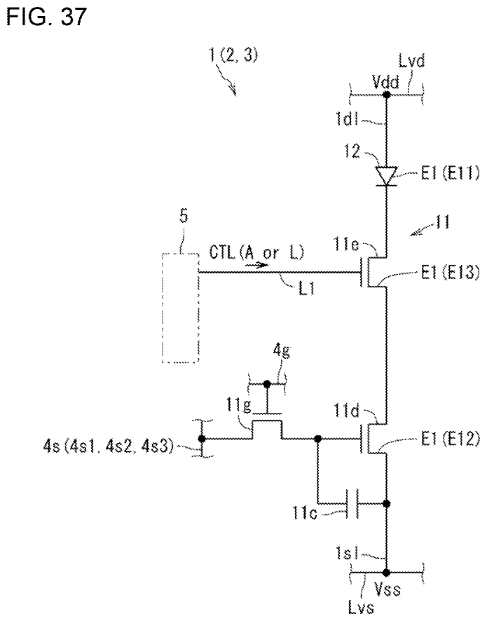

FIG. 37 is a circuit diagram of an example first subpixel circuit 1 including an n-channel transistor as the first transistor 11d. The first subpixel circuit 1 illustrated in FIG. 37 may be used in the first embodiment. In the example in FIG. 37, each of the first transistor 11d, the second transistor 11e, and the third transistor 11g is an n-channel transistor.

In this case, the light emitter 12 as the first element E11, the second transistor 11e as the third element E13, and the first transistor 11d as the second element E12 are connected in series or in cascade in this order between the first power potential input section 1d1 and the second power potential input section 1s1. The light emitter 12 is connected to the first power potential input section 1d1. More specifically, the light emitter 12 includes the positive electrode connected to the first power potential input section 1d1. The light emitter 12 is connected to the second power potential input section 1s1 through the second transistor 11e and the first transistor 11d. More specifically, the light emitter 12 includes the negative electrode connected to the drain electrode of the second transistor 11e. The second transistor 11e includes the source electrode connected to the drain electrode of the first transistor 11d. The first transistor 11d includes the source electrode connected to the second power potential input section 1s1. In other words, the second transistor 11e is connected in cascade to the first transistor 11d.

The third transistor 11g includes the gate electrode connected to the scanning signal line 4g. The third transistor 11g includes the drain electrode (source electrode) connected to the first image signal line 4s1. The third transistor 11g includes the source electrode (drain electrode) connected to the gate electrode of the first transistor 11d. In response to an on-potential signal (an H signal in this example) as a scanning signal from the scanning signal line 4g received at the gate electrode, the third transistor 11g enters the conductive state in which a current flows between the drain electrode and the source electrode. This allows an image signal from the first image signal line 4s1 to be input into the gate electrode of the first transistor 11d through the third transistor 11g. This causes the first transistor 11d to enter the conductive state in which a current flows between the drain electrode and the source electrode. The capacitor 11c is located on the connection line connecting the gate electrode and the source electrode of the first transistor 11d. The second transistor 11e includes the gate electrode connected to the potential output signal line L1.

The second transistor 11e includes the gate electrode to selectively receive the first potential V1 as an off-potential or the second potential V2 as an analog potential from the controller 5 through the potential output signal line L1. In response to a L signal with the first potential V1 as the switch control signal CTL received at the gate electrode, the second transistor 11e enters the nonconductive state in which no current flows between the source electrode and the drain electrode. In response to an A signal with the second potential V2 as the switch control signal CTL received at the gate electrode, the second transistor 11e enters a state in which a current flows between the source electrode and the drain electrode. This allows a drive current to flow from the first power potential input section 1d1 to the light emitter 12, thus causing the light emitter 12 to emit light. The light intensity (luminance) of the light emitter 12 can be controlled based on the level (potential) of the image signal. In this state, the second transistor 11e forms a cascode connection with the first transistor 11d.

### Second Variation of Emission Controller

In each of the above embodiments, the emission controller 11 in any of the first subpixel circuit 1, the second subpixel circuit 2, or the third subpixel circuit 3 may incorporate at least one circuit having various functions, such as a circuit that corrects the level (or potential) of an image signal based on a threshold voltage of a drive element (or a threshold voltage correction circuit). In this case, each of the first subpixel circuit 1, the second subpixel circuit 2, and the third subpixel circuit 3 may incorporate the same or similar circuit. In the example described below, the first subpixel circuit 1 incorporates a threshold voltage correction circuit.

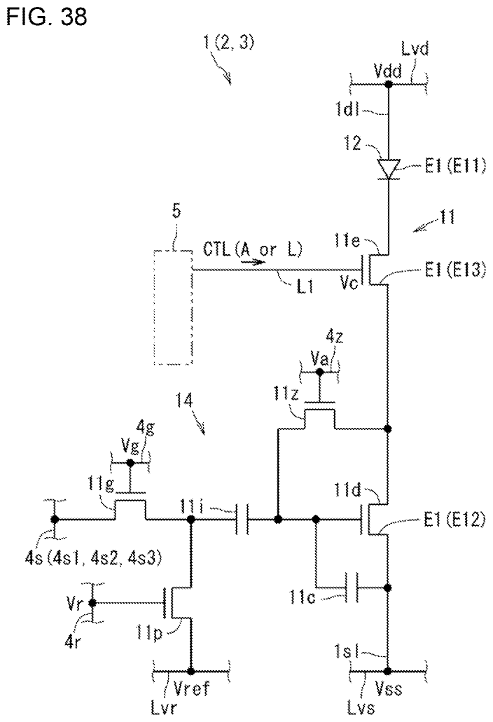

FIG. 38 is a circuit diagram of an example first subpixel circuit 1 incorporating a threshold voltage correction circuit 14. Each of the second subpixel circuit 2 and the third subpixel circuit 3 may incorporate the threshold voltage correction circuit 14 illustrated in FIG. 38. The first subpixel circuit 1 illustrated in FIG. 38 corresponds to the first subpixel circuit 1 illustrated in FIG. 37, but with the threshold voltage correction circuit 14 being added.

As illustrated in FIG. 38, the threshold voltage correction circuit 14 includes a first correction transistor 11p, a second correction transistor 11z, and a correction capacitor Ili.

The correction capacitor 11i is located on the connection line connecting the third transistor 11g and the gate electrode of the first transistor 11d.

The first correction transistor 11p applies a reference potential Vref to the gate electrode of the first transistor 11d through the correction capacitor 11i. The first correction transistor 11p is an n-channel transistor. In this case, the first correction transistor 11p includes the gate electrode connected to a signal line (or a first on-off switch signal line) 4r that provides a signal (or a first on-off switch signal) for switching the first correction transistor 11p between the conductive state and the nonconductive state. The first on-off switch signal line 4r receives a signal from the drive 30 through a predetermined wire. The first correction transistor 11p includes the drain electrode connected to a power line (or a third power line) Lvr that provides the reference potential Vref. The third power line Lvr is connected to a power supply that provides the reference potential Vref to the third power line Lvr. The reference potential Vref is a predetermined positive potential. The first correction transistor 11p includes the source electrode connected to the connection line connecting the source electrode (drain electrode) of the third transistor 11g and the correction capacitor 11i.

The second correction transistor 11z can connect the gate electrode and the drain electrode of the first transistor 11d (in a diode connection). The second correction transistor 11z is located on the connection line connecting the gate electrode and the drain electrode of the first transistor 11d. The second correction transistor 11z is an n-channel transistor. In this case, the second correction transistor 11z includes the gate electrode connected to a signal line (or a second on-off switch signal line) 4z that provides a signal (or a second on-off switch signal) for switching the second correction transistor 11z between the conductive state and the nonconductive state. The second on-off switch signal line 4z receives a signal from the drive 30 through a predetermined wire. The second correction transistor 11z includes the drain electrode connected to the gate electrode of the first transistor 11d. The second correction transistor 11z includes the source electrode connected to the drain electrode of the first transistor 11d.

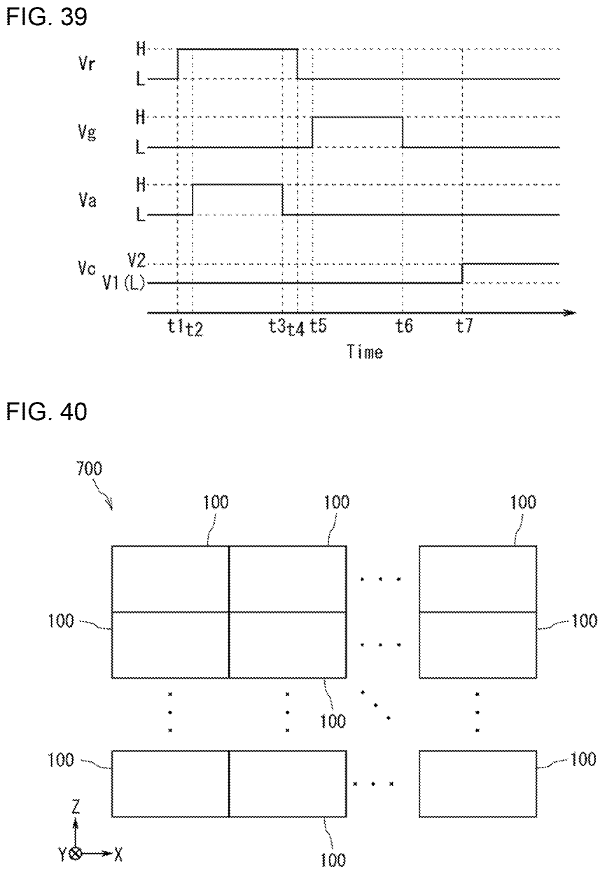

FIG. 39 is a timing chart showing an example operation of the first subpixel circuit 1 incorporating the threshold voltage correction circuit 14. In this chart, a potential Vr refers to the potential of the first on-off switch signal received at the gate electrode of the first correction transistor 11p from the first on-off switch signal line 4r. A potential Vg refers to the potential received at the gate electrode of the third transistor 11g from the scanning signal line 4g. A potential Va refers to the potential of the second on-off switch signal received at the gate electrode of the second correction transistor 11z from the second on-off switch signal line 4z. A potential Vc refers to the potential of the switch control signal CTL received at the gate electrode of the second transistor 11e from the controller 5 through the potential output signal line L1. FIG. 39 shows changes over time of the potential Vr, the potential Vg, the potential Va, and the potential Vc when the first subpixel circuit 1 emits light once in response to an image signal. As shown in FIG. 39, the operations in (i) to (vii) described below are performed in sequence.
(i) At time t1, the first correction transistor 11p receives a H signal at the gate electrode and enters the conductive state. In this state, the gate electrode of the first transistor 11d receives a positive potential corresponding to the reference potential Vref through the correction capacitor 11i.
(ii) At time t2, the second correction transistor 11z receives a H signal at the gate electrode and enters the conductive state. In this state, the first transistor 11d is in a diode connection in which the gate electrode and the drain electrode are connected. This causes a current to flow through the first transistor 11d from the gate electrode to the source electrode through the drain electrode until the voltage (gate voltage) Vgs between the gate electrode and the source electrode of the first transistor 11d reaches a threshold voltage Vth of the first transistor 11d.
(iii) At time t3, the second correction transistor 11z receives a L signal at the gate electrode and enters the nonconductive state. In this state, the gate voltage Vgs of the first transistor 11d is maintained at the threshold voltage Vth.
(iv) At time t4, the first correction transistor 11p receives a L signal at the gate electrode and enters the nonconductive state. In this state, the gate voltage Vgs of the first transistor 11d is maintained at the threshold voltage Vth with the capacitor 11c.
(v) At time t5, the third transistor 11g receives a H signal at the gate electrode and causes the scanning signal line 4g to enter the conductive state. In this state, the gate electrode of the first transistor 11d receives a potential corresponding to the potential Vsig of the image signal from the image signal line 4s through the third transistor 11g and the correction capacitor 11i. Thus, the potential of the image signal is input (refreshed) to cause the gate voltage Vgs of the first transistor 11d to satisfy Vgs=Vth+(Vsig−Vref). This causes the first transistor 11d to have the gate voltage Vgs corresponding to the potential of the image signal and compensated for based on the threshold voltage Vth of the first transistor 11d that differs for each first subpixel circuit 1. In this case, the voltage (Vsig−Vref) of the gate voltage Vgs of the first transistor 11d is used to control the level of the current (drain current) Ids flowing between the drain electrode and the source electrode of the first transistor 11d.
(vi) At time t6, the third transistor 11g receives a L signal at the gate electrode and enters the nonconductive state. This ends the input (refresh) of the potential of the image signal into the first transistor 11d.
(vii) At time t7, the second transistor 11e receives an A signal with the second potential V2 at the gate electrode and enters a state in which a current flows between the source electrode and the drain electrode. This allows a current (drive current) corresponding to the gate voltage Vgs (substantially, the voltage (Vsig−Vref)) of the first transistor 11d to flow from the first power potential input section 1d1 to the second power potential input section 1s1, thus causing the light emitter 12 to emit light. In this state, the second transistor 11e forms a cascode connection with the first transistor 11d.

### Other Examples of Emission Controller

In the second embodiment, the third embodiment, the fifth embodiment, the sixth embodiment, the seventh embodiment, and the ninth embodiment, the emission controller 11 in any of the first subpixel circuit 1, the second subpixel circuit 2, or the third subpixel circuit 3 may have a circuit structure in which each component is replaced with redundant two components as appropriate to correspond to the first light emitter 12a and the second light emitter 12b that are located redundantly and connected in parallel to each other.

In the second embodiment, the third embodiment, and the seventh embodiment, the first transistor 11d may be replaced with two first transistors 11d located redundantly and connected in parallel to each other.

More specifically, in the examples in FIGS. 11, 18, and 28, one of the two first transistors 11d may include the source electrode connected to the first power potential input section 1d1 and the drain electrode connected to the source electrode of the second-A transistor 11ea. The other first transistor 11d may include the source electrode connected to the first power potential input section 1d1 and the drain electrode connected to the source electrode of the second-B transistor 11eb. The capacitor 11c may be replaced with two capacitors 11c located redundantly and connected in parallel to each other. One of the two capacitors 11c may be located on the connection line connecting the gate electrode and the source electrode of one of the two first transistors 11d. The other capacitor 11c may be located on the connection line connecting the gate electrode and the source electrode of the other first transistor 11d.

In the example in FIG. 31, one of the two first transistors 11d may include the source electrode connected to the first power potential input section 1d1 and the drain electrode connected to the positive electrode of the first light emitter 12a. The other first transistor 11d may include the source electrode connected to the first power potential input section 1d1 and the drain electrode connected to the positive electrode of the second light emitter 12b. The capacitor 11c may be replaced with two capacitors 11c located redundantly and connected in parallel to each other. One of the two capacitors 11c may be located on the connection line connecting the gate electrode and the source electrode of one of the two first transistors 11d. The other capacitor 11c may be located on the connection line connecting the gate electrode and the source electrode of the other first transistor 11d.

In the fifth embodiment, the sixth embodiment, and the ninth embodiment, the capacitor 11c may be replaced with two capacitors 11c located redundantly and connected in parallel to each other.

More specifically, in the examples in FIGS. 24, 26, and 35, one of the two capacitors 11c may be located on the connection line connecting the gate electrode of the first-A transistor 11da and the source electrode of the second-A transistor 11ea. The other capacitor 11c may be located on the connection line connecting the gate electrode of the first-B transistor 11db and the source electrode of the second-B transistor 11eb.

### Other Examples

In the first to third embodiments, the structure may include a degeneration resistance connected to the source electrode of the first transistor 11d.

In the fourth to ninth embodiments, the structure may include a transistor connected to the drain electrode of the first transistor 11d to form a cascode connection with the first transistor 11d.

In each of the above embodiments, as illustrated in FIG. 40, multiple display devices 100 may be tiled together into a single display (or a tiled display or a multi-display) 700. FIG. 40 is a schematic front view of an example of the tiled display 700. In the example in FIG. 40, the tiled display 700 includes a matrix of multiple display devices 100 in the XZ plane. Each of the display devices 100 is a flat plate.

In each of the above embodiments, the first subpixel circuit 1 and the second subpixel circuit 2 may have different structures. The first subpixel circuit 1 and the third subpixel circuit 3 may have different structures. The second subpixel circuit 2 and the third subpixel circuit 3 may have different structures. The first subpixel circuit 1, the second subpixel circuit 2, and the third subpixel circuit 3 may have different structures.

In each of the above embodiments, each pixel circuit 10 may include at least the first subpixel circuit 1. Each pixel circuit 10 may include the first subpixel circuit 1 and the second subpixel circuit 2. Each pixel circuit 10 may include one or more subpixel circuits that emit light with a color different from the first color, the second color, and the third color, in addition to the first subpixel circuit 1, the second subpixel circuit 2, and the third subpixel circuit 3. In this case, the second transistor 11e in each of the first subpixel circuit 1 and one or more other subpixel circuits may include the gate electrode connected to a common potential output signal line L1.

In the second embodiment, the third embodiment, and the fifth to ninth embodiments, the signal output circuit 6 may be a part of the drive 30. In this case, the drive 30 may output the first selection setting signal SELA and the second selection setting signal SELB to each controller 5. In this structure, the drive 30 can select one of the redundant light emitters 12 to be used collectively for each pixel circuit 10.

The components described in the above embodiments and the variations may be entirely or partially combined as appropriate unless any contradiction arises.

### REFERENCE SIGNS

1 first subpixel circuit
10 pixel circuit
100 display device
100p display panel
11d first transistor
11da first-A transistor
11db first-B transistor
11e second transistor
11ea second-A transistor
11eb second-B transistor
12 light emitter
12a first light emitter
12b second light emitter
1d1 first power potential input section
1s1 second power potential input section
2 second subpixel circuit
3 third subpixel circuit
30 drive
5 controller
5I signal input section
5U signal output section
E1 element
Sf1 display surface
Sf2 non-display surface
V1 first potential (off-potential)
V2 second potential
V3 third potential (on-potential)

1. A pixel circuit, comprising:
a first power potential input section to provide a first power potential;
a second power potential input section to provide a second power potential, the second power potential being lower than the first power potential; and
a plurality of elements connected in series or in cascade between the first power potential input section and the second power potential input section, the plurality of elements including
a light emitter,
a first transistor connected in series to the light emitter, the first transistor being configured to control a current flowing through the light emitter in response to a potential corresponding to an image signal received at a gate electrode, and
a second transistor connected in cascade to the first transistor, the second transistor being configured to switch the light emitter between an emissive state and a non-emissive state, the second transistor including a gate electrode to selectively receive a first potential or a second potential, the first potential being higher than or equal to the first power potential or being lower than or equal to the second power potential to set the second transistor to a nonconductive state in which no current flows between a source electrode and a drain electrode, the second potential being between the first power potential and the second power potential to allow a current to flow between the source electrode and the drain electrode of the second transistor.

2. The pixel circuit according to claim 1, wherein
the second transistor is a p-channel transistor, and the first potential is higher than or equal to the first power potential, or
the second transistor is an n-channel transistor, and the first potential is lower than or equal to the second power potential.

3. The pixel circuit according to claim 1, wherein
the second transistor is of the same conductivity type as the first transistor, and the second transistor is connected in cascade to the first transistor with a drain electrode of the first transistor, and
the drain electrode of the second transistor is connected to the light emitter.

4. The pixel circuit according to claim 3, wherein
the pixel circuit includes a plurality of the light emitters and a plurality of the second transistors,
the plurality of the light emitters includes a first light emitter and a second light emitter connected in parallel,
the plurality of the second transistors includes a second-A transistor connected in series to the first light emitter and a second-B transistor connected in series to the second light emitter,
the second-A transistor includes a gate electrode to selectively receive the first potential or the second potential, and
the second-B transistor includes a gate electrode to selectively receive the first potential or the second potential.

5. The pixel circuit according to claim 1, wherein
the second transistor is connected in cascade to the first transistor with a source electrode of the first transistor.

6. The pixel circuit according to claim 5, wherein
the pixel circuit includes a plurality of the light emitters, a plurality of the first transistors, and a plurality of the second transistors,
the plurality of the light emitters includes a first light emitter and a second light emitter connected in parallel,
the plurality of the first transistors includes a first-A transistor connected in series to the first light emitter and a first-B transistor connected in series to the second light emitter,
the plurality of the second transistors includes a second-A transistor connected in cascade to the first-A transistor with a source electrode of the first-A transistor, and a second-B transistor connected in cascade to the first-B transistor with a source electrode of the first-B transistor,
the second-A transistor includes a gate electrode to selectively receive the first potential or the second potential, and
the second-B transistor includes a gate electrode to selectively receive the first potential or the second potential.

7. The pixel circuit according to claim 1, wherein
the first transistor is connected in cascade to the second transistor and is not connected in cascade to an element other than the second transistor between the first power potential input section and the second power potential input section.

8. The pixel circuit according to claim 1, further comprising:
a controller configured to selectively output the first potential or the second potential to the gate electrode of the second transistor.

9. The pixel circuit according to claim 8, wherein
the controller includes a switch configured to perform switch control over the second transistor,
the controller receives an on-signal or an off-signal selectively and receives the second potential,
the controller outputs the first potential to the gate electrode of the second transistor in response to receiving the off-signal, and
the controller outputs the second potential to the gate electrode of the second transistor in response to receiving the on-signal and the second potential.

10. The pixel circuit according to claim 9, wherein
the controller includes the switch configured to control timing of light emission of the light emitter.

11. The pixel circuit according to claim 8, wherein
the controller includes a plurality of switches configured to perform switch control over the second transistor,
the controller selectively receives an on-signal or an off-signal for each of the plurality of switches and receives the second potential,
the controller outputs the first potential to the gate electrode of the second transistor in response to receiving an off-signal for at least one of the plurality of switches, and
the controller outputs the second potential to the gate electrode of the second transistor in response to receiving an on-signal for each of the plurality of switches and the second potential.

12. The pixel circuit according to claim 4, further comprising:
a controller configured to selectively output the first potential or the second potential to the gate electrode of the second-A transistor and selectively output the first potential or the second potential to the gate electrode of the second-B transistor,
wherein the controller includes a first switch configured to set the first light emitter selectively to an in-use state or a non-use state and includes a second switch configured to set the second light emitter selectively to an in-use state or a non-use state,
the controller selectively receives an on-signal or an off-signal for the first switch, selectively receives an on-signal or an off-signal for the second switch, and receives the second potential,
the controller outputs the first potential to the gate electrode of the second-A transistor in response to receiving an off-signal for the first switch,
the controller outputs the second potential to the gate electrode of the second-A transistor in response to receiving an on-signal for the first switch and the second potential,
the controller outputs the first potential to the gate electrode of the second-B transistor in response to receiving an off-signal for the second switch, and
the controller outputs the second potential to the gate electrode of the second-B transistor in response to receiving an on-signal for the second switch and the second potential.

13. The pixel circuit according to claim 12, wherein
the controller further includes a third switch configured to set each of the first light emitter and the second light emitter selectively to the emissive state or the non-emissive state,
the controller selectively receives an on-signal or an off-signal for the third switch,
the controller outputs the first potential to the gate electrode of the second-A transistor in response to receiving at least one of an off-signal for the first switch or an off-signal for the third switch,
the controller outputs the second potential to the gate electrode of the second-A transistor in response to receiving an on-signal for the first switch, an on-signal for the third switch, and the second potential,
the controller outputs the first potential to the gate electrode of the second-B transistor in response to receiving at least one of an off-signal for the second switch or an off-signal for the third switch, and
the controller outputs the second potential to the gate electrode of the second-B transistor in response to receiving an on-signal for the second switch, an on-signal for the third switch, and
the second potential.

14. A display panel, comprising:
a plurality of the pixel circuits according to claim 1; and
a controller configured to selectively output the first potential or the second potential to the gate electrode of the second transistor in each of the plurality of the pixel circuits.

15. A pixel circuit, comprising:
a light emitter;
a first transistor connected in series to the light emitter, the first transistor being configured to control a current flowing through the light emitter in response to a potential corresponding to an image signal received at a gate electrode;
a second transistor connected in cascade to the first transistor, the second transistor being configured to switch the light emitter between an emissive state and a non-emissive state; and
a controller including a plurality of switches configured to perform switch control over the second transistor, the controller being configured to selectively receive an on-signal or an off-signal for each of the plurality of switches, the controller being configured to output, in response to receiving an off-signal for at least one of the plurality of switches, a potential to a gate electrode of the second transistor to cause the light emitter to be in the non-emissive state, the controller being configured to output, in response to receiving an on-signal for each of the plurality of switches, a potential to the gate electrode of the second transistor to cause the light emitter to be in the emissive state.

16. The pixel circuit according to claim 15, wherein
the second transistor is connected in cascade to the first transistor with a source electrode of the first transistor.

17. The pixel circuit according to claim 15, wherein
the pixel circuit includes a plurality of the light emitters and a plurality of the second transistors,
the plurality of the light emitters includes a first light emitter and a second light emitter connected in parallel,
the plurality of the second transistors includes a second-A transistor connected in series to the first light emitter and a second-B transistor connected in series to the second light emitter,
the controller includes a first switch, a second switch, and a third switch,
the controller selectively receives an on-signal or an off-signal for the first switch, selectively receives an on-signal or an off-signal for the second switch, and selectively receives an on-signal or an off-signal for the third switch,
the controller outputs, in response to receiving at least one of an off-signal for the first switch or an off-signal for the third switch, a potential to a gate electrode of the second-A transistor to set the second-A transistor to a nonconductive state in which no current flows between a source electrode and a drain electrode,
the controller outputs, in response to receiving an on-signal for the first switch and an on-signal for the third switch, a potential to the gate electrode of the second-A transistor to set the second-A transistor to a conductive state in which a current flows between the source electrode and the drain electrode,
the controller outputs, in response to receiving at least one of an off-signal for the second switch or an off-signal for the third switch, a potential to a gate electrode of the second-B transistor to set the second-B transistor to the nonconductive state in which no current flows between a source electrode and a drain electrode, and
the controller outputs, in response to receiving an on-signal for the second switch and an on-signal for the third switch, a potential to the gate electrode of the second-B transistor to set the second-B transistor to the conductive state in which a current flows between the source electrode and the drain electrode.

18. The pixel circuit according to claim 17, wherein
the pixel circuit includes a plurality of the first transistors,
the plurality of the first transistors includes a first-A transistor connected in series to the first light emitter and a first-B transistor connected in series to the second light emitter,
the second-A transistor is connected in cascade to the first-A transistor with a source electrode of the first-A transistor, and
the second-B transistor is connected in cascade to the first-B transistor with a source electrode of the first-B transistor.

19. The pixel circuit according to claim 15, wherein
the pixel circuit includes a plurality of the light emitters and a plurality of the second transistors,
the plurality of the light emitters includes a first light emitter and a second light emitter connected in series,
the plurality of the second transistors includes a second-A transistor connected in parallel to the first light emitter and a second-B transistor connected in parallel to the second light emitter,
the controller includes a first switch, a second switch, and a third switch,
the controller selectively receives an on-signal or an off-signal for the first switch, selectively receives an on-signal or an off-signal for the second switch, and selectively receives an on-signal or an off-signal for the third switch,
the controller outputs, in response to receiving at least one of an off-signal for the first switch or an off-signal for the third switch, a potential to a gate electrode of the second-A transistor to set the second-A transistor to a conductive state in which current flows between a source electrode and a drain electrode,
the controller outputs, in response to receiving an on-signal for the first switch and an on-signal for the third switch, a potential to the gate electrode of the second-A transistor to set the second-A transistor to a nonconductive state in which no current flows between the source electrode and the drain electrode,
the controller outputs, in response to receiving at least one of an off-signal for the second switch or an off-signal for the third switch, a potential to a gate electrode of the second-B transistor to set the second-B transistor to the conductive state in which a current flows between a source electrode and a drain electrode, and
the controller outputs, in response to receiving an on-signal for the second switch and an on-signal for the third switch, a potential to the gate electrode of the second-B transistor to set the second-B transistor to the nonconductive state in which no current flows between the source electrode and the drain electrode.

20. The pixel circuit according to claim 17, wherein
the first switch is configured to set the first light emitter selectively to an in-use state or a non-use state,
the second switch is configured to set the second light emitter selectively to the in-use state or the non-use state, and
the third switch is configured to set each of the plurality of the light emitters selectively to the emissive state or the non-emissive state.

21. The pixel circuit according to claim 15, further comprising:
a first power potential input section to provide a first power potential; and
a second power potential input section to provide a second power potential, the second power potential being lower than the first power potential,
wherein the first transistor is connected in cascade to the second transistor and is not connected in cascade to an element other than the second transistor between the first power potential input section and the second power potential input section.

22. A display panel, comprising:
a plurality of pixel circuits; and
a controller including a plurality of switches,
each of the plurality of pixel circuits including
a light emitter,
a first transistor connected in series to the light emitter, the first transistor being configured to control a current flowing through the light emitter in response to a potential corresponding to an image signal received at a gate electrode, and
a second transistor connected in cascade to the first transistor, the second transistor being configured to switch the light emitter between an emissive state and a non-emissive state,
the controller being configured to selectively receive an on-signal or an off-signal for each of the plurality of switches,
the controller being configured to output, in response to receiving an off-signal for at least one of the plurality of switches, a potential to a gate electrode of the second transistor in each of the plurality of pixel circuits to cause the light emitter to be in the non-emissive state,
the controller being configured to output, in response to receiving an on-signal for each of the plurality of switches, a potential to the gate electrode of the second transistor in each of the plurality of pixel circuits to cause the light emitter to be in the emissive state.

23. A display device, comprising:
the display panel according to claim 14; and
a drive on a non-display surface of the display panel opposite to a display surface, the drive being electrically connected to the plurality of pixel circuits.
